(19) United States
(12) Patent Application Publication
(10) Pub. No.: US 2012/0322680 A1
(43) Pub. Date: Dec. 20, 2012

(54) USE OF MIRNAS AS BIOMARKERS IN GLIOMA DIAGNOSIS

(75) Inventors: Francois Berger, Meylan (FR); Jean-Paul Issartel, Saint Egreve (FR); Michele El Atifi-Borel, Froges (FR); Elodie Lages, Grenoble (FR); Audrey Guttin, Chassignieu (FR)

(73) Assignee: UNIVERSITE JOSEPH FOURIER, Grenoble Cedex 09 (FR)

(21) Appl. No.: 13/514,723

(22) PCT Filed: Dec. 8, 2010
(86) PCT No.: PCT/FR2010/052650

§ 371 Date: Aug. 14, 2012

(30) Foreign Application Priority Data
Dec. 8, 2009 (FR) 09/58737
Apr. 23, 2010 (FR) 10/53142

(51) Int. Cl. C40B 30/04

(52) U.S. Cl. 506/9

(57) ABSTRACT

The present application relates to the use of miRNAs as biomarkers in glioma diagnosis. It also relates to the use of miRNAs as biomarkers in glioblastoma and oligodendroglioma diagnosis.

The present invention relates to the use of miRNAs as biomarkers in glioma diagnosis. It further relates to use of miRNAs as biomarkers in glioblastoma and oligodendroglioma diagnosis.

Most tumours of the central nervous system (CNS) are gliomas (50%) including astrocytomas and the oligodendrogliomas. These tumours constitute a significant cause of morbidity and mortality and represent a significant public health problem. In fact, CNS tumours constitute the second most common cause of cancer deaths in children and the third most common cause in adults (15-34 years). The overall incidence of CNS tumours is close to 7000 new cases identified each year in France. Finally, worldwide, out of 6 million deaths annually resulting from some form of cancer, 1 to 2% are due to CNS tumours (WHO data).

Excision of the tumour constitutes one means, a priori radical, of eradicating a tumour. But in clinical practice, the effectiveness of this treatment is often compromised, as tumour ablation often cannot be complete. In fact, due to the imprecision of the current methods of diagnosis, the limits of the tumour are sometimes poorly assessed during diagnosis.

The radiotherapy widely used as a complement to surgery does not make it possible to definitively suppress tumours. Chemotherapy, using various anti-cancer pharmaceutical compounds, such as cisplatin, or Temodal, is another treatment often used to combat tumours. However, chemotherapy is not effective against all gliomas, either because certain gliomas, for example glioblastomas, are not very chemo-sensitive, or because certain pharmaceutical compounds are incapable of passing through the blood-brain barrier.

At present, apart from the histological analysis carried out by pathologists, there are only a few rare diagnostic tests based on molecular approaches. Microscopic observations of the morphology of the cells are carried out in a few laboratories by looking for certain protein markers using specific antibodies. These immunohistochemical tests however have numerous drawbacks at present. They have only a low level of productivity (allowing the detection of only one antigen at a time), do not make it possible to unambiguously distinguish between the different types of tumour cells and offer only mediocre possibilities of quantitative detection of the markers. Diagnoses involving the detection of genetic markers (such as 1p and 19q loss of heterozygosity in the oligodendrogliomas) are not in common use at present.

The microRNAs (miRNAs) represent a class of small, non-coding, single-stranded endogenous RNAs (21 to 25 nt), of relatively recent identification. The genes responsible for the expression of these miRNAs are previously transcribed in the form of long precursors, themselves cleaved by the RNAse III Drosha to produce pre-miRNAs. The maturation of these pre-miRNAs is carried out by another RNAse, Dicer, which produces an RNA duplex denoted [miRNA: miRNA*]. Only one of the 2 strands, the mature strand, participates in the ribonucleoprotein complex RISC (RNA-induced silencing complex), functioning as post-transcriptional regulator (Bartel et al., Cell, 2004. 116(2): 281-97).

The miRNAs can regulate the expression of genes either by degradation of target messenger RNAs, or by repression of their translation depending on the degree of complementarity between the miRNA and its target mRNA. As these RNAs play an important role in translational regulation, they are therefore deeply involved in numerous cell processes such as development, differentiation, proliferation, apoptosis and response to stress; processes often deregulated in tumours.

Numerous scientific works have been devoted to the role of miRNAs in oncogenesis processes (Benard, J. and S. Douc-Rasy, Bull Cancer, 2005. 92(9): p. 757-62; Hammond Curr Opin Genet Dev, 2006. 16(1): p. 4-9). It is now recognized that miRNAs are actively involved in the development of cancers.

In humans, the number of genes encoding miRNA precursors currently identified is 721 (Sanger miRBase version 14, September 2009). Certain of these miRNAs have been detected as tumour markers in the context of breast and prostate cancers and are therefore considered to be miRNA oncogenes or tumour suppressors due to their expression in tumours and their post-transcriptional role.

In the last few years, the possible alteration in expression levels of the miRNAs in glial tumours has already been the subject of several scientific publications.

A publication by Ciafre et al. in 2005 (Biochem Biophys Res Commun. 2005. Sep. 9; 334(4): 1351-8) compares the expression levels of 245 miRNAs in glioblastomas and normal tissues, and reveals a distinct expression profile of these miRNAs in glioblastomas compared with the expression profile in normal tissues. This publication describes that miR-221 is overexpressed in glioblastomas, whereas miR-128, miR-181a, miR181b and miR181c are underexpressed in glioblastomas.

At the same time, Chen (N Engl J Med, 2005. 353 (17): 1768-71) describes that miR-21 is strongly overexpressed in glioblastomas compared with normal tissues.

Another scan of the expression levels of 192 miRNAs, in the tissues of glial tumours and normal tissues, was carried out by Silber et al. in 2008 (BMC Med. 2008. Jun. 24; 6:14). This purpose of this study is to analyze any change in the expression profile of the miRNAs in anaplastic astrocytomas (Grade III) or glioblastomas (Grade IV), tumours with different grades of the same type of tumour. This study shows a modified expression profile of the miRNAs in anaplastic astrocytomas and glioblastomas, compared with normal tissues. The miRNAs mentioned in this publication, the expression of which is modified, are not identical to those already mentioned in earlier publications.

However, thus far, no previous study has carried out an exhaustive scan, as no exploration of all of the microRNAs expressed in human cells has ever been carried out.

In order to combat glial tumours effectively, the introduction of reliable glioma diagnosis method, making it possible to accurately distinguish a glial tumoral tissue from normal tissue, is therefore of decisive importance.

Gliomas or glial tumours are classified by the World Health Organization (WHO) in 4 histological grades, the grade mainly indicating the degree of malignancy (see Table 1).

TABLE 1

| | |
|---|---|
| Grade I | Pilocytic astrocytoma curable by surgery |
| Grade II | Oligoastrocytomas, two types of cells: astrocytic and |
| | oligodendroglial |
| | Oligodendrogliomas |
| | Diffuse astrocytomas |
| Grade III | Anaplastic oligodendrogliomas |
| | Anaplastic oligoastrocytomas |
| | Anaplastic astrocytomas |
| Grade IV | Glioblastoma multiforme |

The oligodendrogliomas, classified by WHO as Grade II, are low-grade gliomas, developed from the oligodendrocytes. Until now, this glioma has very often been under-diagnosed, due to a lack of effective methods of diagnosis. Nevertheless, unlike other glial tumours, oligodendrogliomas are remarkably chemo-sensitive. In the case of oligodendrogliomas, the median survival time, is approximately 7 years.

By contrast, glioblastomas, classified as Grade IV according to the WHO classification, are developed from astrocytes, which provide a bridge between the blood and neurons, ensure the nutrition of neurons, manage interneuronal connections, and regulate neurotransmitters. The glioblastomas are malignant astrocytic tumours. In the absence of satisfactory surgical excision and chemo-sensitivity with respect to most of the anti-cancer drugs currently on the market, the prognosis for these tumours is very pessimistic. In the case of glioblastomas the average survival time is only approximately 1 year after treatment.

Consequently, a diagnostic method capable of rapidly and correctly distinguishing an oligodendroglioma from a glioblastoma allows a patient to receive treatment corresponding to his physical state and increase his chances of survival.

However, in the earlier publications mentioned above, the starting biological material is constituted by glioblastomas compared with peritumoral tissue or healthy tissue; or glioblastoma cells in culture compared with healthy cerebral tissue; or glioblastomas, corresponding to high-grade astrocytomas, compared with low-grade astrocytic tumours, such as anaplastic astrocytomas. By contrast, comparisons between glioblastomas and oligodendrogliomas have never been dealt with in the prior art.

Therefore, another aspect of the invention aims to introduce a diagnostic method making it possible to accurately distinguish a glioblastoma from an oligodendroglioma.

The invention is based on an unexpected finding by the Inventors during a scan of the expression levels of 282 microRNAs in normal tissues, and tissues originating from two types of tumours of different type and origin, including glioblastomas (GBM) and oligodendrogliomas (ODG).

In fact, the Inventors found that the expression profile of these miRNAs is distinctly different in the glial tumoral tissues compared with that present in the normal tissues.

Based on the comparison made between the expression profile of 282 miRNAs in glial tumours (glioblastomas or oligodendrogliomas) and healthy cerebral tissues, the present invention has identified 19 miRNAs the expression of which is either systematically overexpressed, or systematically underexpressed in glial tumours compared with healthy cerebral tissues.

Thus, a subject of the first aspect of the invention is the use of at least one miRNA chosen from hsa-miR-126, hsa-miR-15b, hsa-miR-16, hsa-miR-17, hsa-miR-20a, hsa-let7a, hsa-let7f, hsa-let7d, hsa-miR-374, hsa-miR-409, hsa-miR-134, hsa-miR-339, hsa-miR-127, hsa-miR-151, hsa-miR-26b, hsa-miR-34b*, hsa-miR-155, hsa-miR-210 or hsa-miR-10a for the implementation of a method for the in vitro diagnosis of glioma.

The nucleotide sequence and the accession number for each miRNA mentioned in the present invention are presented below in Table 2.

TABLE 2

| miRNAs expressed | | | |
|---|---|---|---|
| differently in glial | | | |
| tumours compared | | | |
| with healthy | | MIMAT | |
| cerebral tissue | Sequence number | accession number | Sequence |
| hsa-miR-126 | SEQ ID NO: 1 | MIMAT0000445 | ucguaccgugaguaauaaugcg |
| hsa-miR-16 | SEQ ID NO: 2 | MIMAT0000069 | uagcagcacguaaauauuggcg |
| hsa-miR-20a | SEQ ID NO: 3 | MIMAT0000075 | uaaagugcuuauagugcagguag |
| hsa-let 7a | SEQ ID NO: 4 | MIMAT0000062 | ugagguaguagguuguauaguu |
| hsa-let 7f | SEQ ID NO: 5 | MIMAT0000067 | ugagguaguagauuguauaguu |
| hsa-let 7d | SEQ ID NO: 6 | MIMAT0000065 | agagguaguagguugcauaguu |
| hsa-miR-374a | SEQ ID NO: 7 | MIMAT0000727 | uuauaauacaaccugauaagug |
| hsa-miR-15b | SEQ ID NO: 8 | MIMAT0000417 | uagcagcacaucaugguuuaca |
| hsa-miR-127-3p | SEQ ID NO: 9 | MIMAT0000446 | ucggauccgucugagcuuggcu |
| hsa-miR-339-5p | SEQ ID NO: 10 | MIMAT0000764 | ucccuguccuccaggagcucacg |
| hsa-miR-409-5p | SEQ ID NO: 11 | MIMAT0001638 | agguuacccgagcaacuuugca |
| hsa-miR-134 | SEQ ID NO: 12 | MIMAT0000447 | ugugacugguugaccagagggg |
| hsa-miR-155 | SEQ ID NO: 13 | MIMAT0000646 | uuaaugcuaaucgugauaggggu |
| hsa-miR-210 | SEQ ID NO: 14 | MIMAT0000267 | cugugcgugugacagcggcuga |
| hsa-miR-10a | SEQ ID NO: 15 | MIMAT0000253 | uacccuguagauccgaauuugug |
| hsa-miR-26b | SEQ ID NO: 16 | MIMAT0000083 | uucaaguaauucaggauaggu |
| hsa-miR-34b* | SEQ ID NO: 17 | MIMAT0000685 | uaggcagugucauuagcugauug |
| hsa-miR-17 | SEQ ID NO: 18 | MIMAT0000070 | caaagugcuuacagugcagguag |
| hsa-miR-151-3p | SEQ ID NO: 19 | MIMAT0000757 | cuagacugaagcuccuugagg |

In the present invention, it is understood that hsa-miR-20 and hsa-miR-20a correspond to the same nucleotide sequence.

The miRNAs mentioned above are referenced in the miRBase database (http://www.mirbase.org/) (miRBase: tools for microRNA genomics, Griffiths-Jones et al., NAR 2008 36(Database Issue):D154-D158) where the nucleotide sequence of an miRNA can be found using a MIMAT accession number or uniform annotation. An annotation system has been set up for naming the different miRNAs (A uniform system for microRNAn annotation, Ambros et al., RNA 2003 9(3):277-279). In this system, the microRNAs are designated by a number. This identification number is preceded by the abbreviation “miR” or “mir”, which makes it possible to distinguish between the mature microRNA (miR) and the precursor loop (hairpin) of the microRNA (mir), corresponding respectively to a MIMAT accession number and MI. A three- or four-letter prefix is used to distinguish the genomic origins of this miRNA. For example “hsa-miR-126” means that this mature miRNA originates from the human genome. Sometimes, the mature microRNAs can be very similar (differing by only one base). In this case, the microRNAs bearing the same number are distinguished from each other by a lower case letter such as a, b, c . . . for example hsa-miR-26b. Sometimes a precursor loop can generate, at its 5′ end and its 3′ end, two mature microRNAs which are distinguished from each other by the annotation “5p” or “3p”. For example “hsa-miR-151-3p” means a mature miRNA originating from the 3′ end of its precursor.

The miRNAs used in the present invention are mature miRNAs originating from the human genome, which can be produced naturally by cells, or synthesized by conventional chemical methods, or biological methods, such as a recombinant vector.

In the present invention, the expressions “miRNA” and “microRNA” can be replaced by each other. The expressions glial tumours or gliomas are equivalent. Glioblastomas and oligodendrogliomas are two types of gliomas. Healthy tissue or healthy sample means non-tumoral tissue or non-tumoral sample. These expressions in the singular can be understood as plural and vice versa.

In an advantageous embodiment, the invention relates to the use of at least one miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b or hsa-miR-34b*, for the implementation of a method for the in vitro diagnosis of glioma.

The aberrant expression of these 16 miRNAs in a glial tumour has never been mentioned by earlier publications, either because the miRNA scanning carried out in previous work is not exhaustive, (for example the study by Silber et al. in 2008 relates to only 192 miRNAs), or because the technique used previously does not make it possible to give a higher resolution compared with the technique adopted in the invention. In fact, the study by Ciafre et al. in 2005, using the “DNA chip” technique to quantify the expression of the miRNAs, shows no significant difference between the expression level of miR-16 in the tissues of glioblastomas and the expression level of the abovementioned miRNA in the normal tissues, whereas the present invention shows that miR-16 is overexpressed in glioblastomas, thanks to the quantitative PCR technique, which makes it possible to distinguish more accurately a difference in the quantity of RNA between two samples.

Among all of the 19 miRNAs identified in the invention, there are 5 miRNAs, namely hsa-miR-155, hsa-miR-210 or hsa-miR-10a, hsa-miR-409 and hsa-miR-134, the expression profile of which is very specific. The expression profile of these 5 miRNAs, which is different in tumours compared with that in the normal tissues, is also differentiated between glioblastomas and oligodendrogliomas. The expression levels of these 5 miRNAs are systematically higher in glioblastomas compared with those in oligodendrogliomas (see Table 3 in Example 2).

In an advantageous embodiment, the invention relates to the use of at least one miRNA chosen from hsa-miR-155, hsa-miR-210 or hsa-miR-10a, hsa-miR-409 or hsa-miR-134 for the implementation of a specific in vitro glioma diagnosis method, said method making it possible to distinguish glioblastoma from oligodendroglioma.

In a particularly advantageous embodiment, the invention relates to the use of at least two miRNAs for the implementation of a specific in vitro method for diagnosis of a brain tumour belonging to the group constituted by 2 types of tumours: ODG, GBM, and identification of the type of the tumour, in which:
a first miRNA is chosen from hsa-miR-155, hsa-miR-210, hsa-miR-10a, hsa-miR-409 or hsa-miR-134;
a second miRNA is chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b*, hsa-miR-155, hsa-miR-210 or hsa-miR-10a,
the first and the second miRNA are different.

Another aspect of the invention relates to a method for the in vitro diagnosis of glioma. This method makes it possible to diagnose whether a patient has a glioma.

This method comprises the following stages:
measurement of the expression level of at least one miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b*, hsa-miR-155, hsa-miR-210 or hsa-miR-10a, in a biological sample originating from a patient with a suspected glioma,
the comparison:
   between the expression level of at least one abovementioned miRNA in the abovementioned sample and the expression level of the abovementioned miRNA in a healthy reference sample, or
   between the expression level of at least one first abovementioned miRNA in the sample originating from a patient with a suspected glioma and the expression level of at least one second abovementioned miRNA in the sample originating from said patient with a suspected glioma.

The comparison of the expression levels of the miRNAs can be carried out between a sample originating from a patient with a suspected glioma and a healthy reference sample, or a reference sample originating from a patient with a glioblastoma or a patient with an oligodendroglioma.

By “biological sample”, is meant a tissue sample, in particular a brain tissue obtained by excision, or a body fluid sample, in particular a blood sample.

A brain tissue sample can be a central nervous system tissue originating from the cerebral cortex, cerebellar cortex, basal ganglia or brain stem nuclei.

A body fluid sample can be a blood serum or a blood plasma.

When it is a brain tissue sample, “a healthy reference sample” is brain tissue devoid of any tumoral character according to a histological analysis carried out by the pathologists. The reference healthy tissue can be a tissue of the central nervous system originating from the cerebral cortex, cerebellar cortex, basal ganglia or brain stem nuclei. The reference healthy tissue is preferably taken from the same patient (healthy tissue from the area surrounding the tumour). Alternatively, it can be constituted by encephalic fragments obtained after surgery known as corticectomy carried out on individuals without brain tumours but in the context of intervention to treat epilepsy or following head injuries.

When it is a body fluid sample, “a healthy reference sample” is taken from a healthy individual, and in particular an individual without cancer.

When “a biological sample originating from a patient with a suspected glioma” is a brain tissue sample, it is a tissue taken by biopsy or by excision in the operating theatre or any other suitable method of intratumoral sampling, of the seat of the suspected tumour in a patient. The seat of the suspected tumour is identified beforehand by a standard method, such as an MRI or PET Scan (gamma-ray imaging scanner), or a standard scanner.

When “a biological sample originating from a patient with a suspected glioma” is a blood sample, this sample is obtained from a patient by taking blood by conventional methods,

“A reference sample originating from a patient with a glioblastoma or from a patient with an oligodendroglioma” is a sample originating from a patient in whom the presence of one of the two tumours has been certified by pathological analysis. Ideally, diagnosis can also be confirmed by molecular analyses such as for example analysis of the gene expression profiles of these tumoral tissues. The tumours are then characterized using the classification method of Li et al. (Li A, Walling J, Ahn S, Kotliarov Y, Su Q, Quezado M, Oberholtzer J C, Park J, Zenklusen J C, Fine H A. Cancer Res. 2009 Mar. 1; 69(5):2091-9) which is based on the use of the expression levels of a set of 54 genes. Glioblastomas and oligodendrogliomas are classified in Groups G and O respectively in the publication cited above.

“A reference sample originating from a patient with a glioblastoma or from a patient with an oligodendroglioma” is a brain tissue sample; the abovementioned tissue can be a fragment of glial tumour obtained by excision from a patient in whom the type of tumour has been certified by pathological analysis.

The miRNAs measured in this method are contained in purification fractions of RNAs obtained either from extracts or lysates originating from brain tissues obtained by biopsy or by excision in the operating theatre or any other suitable method of intratumoral sampling, when a tissue sample is involved; or from extracts or lysates from the different fractions of body fluids using suitable methods, when a body fluid sample is involved.

The tissue extracts used for the assays correspond to fractions obtained after lysis of the tissues and more or less advanced purification of the RNAs by conventional methods (for example the mirVana method marketed by Ambion, or RNeasy by Qiagen, or methods of purification by electrophoresis). Depending on the methods, the fractions contain total RNAs, or RNAs smaller than 200 bases, or microRNA-enriched fractions.

The miRNAs measured in a blood sample can be all of the miRNAs circulating in the plasma or serum, or the miRNAs localized in the microvesicles present in the serum.

The total quantity of the miRNAs circulating in the blood is purified directly from blood samples using conventional methods, such as that described by Mitchell P S et al. (Mitchell P S et al., Proc Natl Acad Sci USA. 2008 Jul. 29; 105(30):10513-8) or by Lodes M J (Lodes M J et al., PLoS One. 2009 Jul. 14; 4(7):e6229).

The miRNAs localized in the microvesicles present in the serum are purified by an approach described for example by Skog et al. (Skog et al., Nat Cell Biol. 2008 December; 10(12): 1470-6).

The term “expression level” of an miRNA in a sample corresponds to a measurement value specific to an miRNA, but expressed either as an arbitrary unit, or a mass unit, of molecules or concentration, or as a normalized value compared with another measurement, in particular as a normalized value compared with the quantities of the same miRNA in a reference tissue (healthy or tumoral tissue).

The expression level of the miRNAs can be measured by any conventional method, such as
“DNA chip” hybridization,
high-throughput methods for sequencing a large number of individualized miRNAs,
real-time PCR,
Northern blot,
   or also by any other method specific to miRNAs.

The expression level of the miRNAs can be measured by the “DNA chip” technique. The “DNA chip” technique is well known to a person skilled in the art. It involves the hybridization of extracted miRNAs on a solid support constituted by a nylon membrane, a silicon or glass surface, optionally nano-beads or particles, comprising oligonucleotides of known sequences fixed to or adhering to the support. The complementarity of the fixed oligonucleotides to the sequences of the microRNAs or their conversion products (amplification products, cDNA, RNA or cRNA) makes it possible to generate a signal (fluorescence, luminescence, radioactivity, electrical signal etc.) depending on the marking techniques used, at the level of the oligonucleotides immobilized on the supports (DNA chips). This signal is detected by dedicated equipment and an intensity value of this signal specific to each miRNA is thus recorded. Several types of chips intended for detecting miRNAs are already available on the market, such as for example GeneChip® miRNA marketed by Affymetrix, miRcury arrays by Exiqon, miRXplore microarrays by Miltenyi.

In the case of high-throughput sequencing analysis, the miRNAs are extracted from a sample and purified, isolated from each other by methods proposed by the suppliers of sequencing equipment such as Roche, Invitrogen. This type of analysis consists of separate identification of the molecules of the different microRNAs, followed by an amplification stage and sequencing the products (“nucleic acid clones”) thus generated. The production of a large number of sequences for identifying each of these “clones” (several thousand) makes it possible to generate a listing of the microRNAs present in a sample and to quantify each of these miRNAs quite simply by counting how many times each sequence is found in the detailed listing.

In a preferred embodiment of the invention, miRNA assays are carried out by quantitative PCR (real-time PCR). Real-time PCR makes it possible to obtain so-called Ct values, corresponding to the number of cycles beyond which the fluorescence emitted exceeds a certain threshold, the threshold being fixed by the user at the start of the exponential phase. This Ct value is proportional to the quantity of cDNA (originating from the reverse transcription of the miRNA to cDNA by Reverse Transcriptase) initially present in the sample. In the absence of a set of reference standards specific to each cDNA, only a relative quantification between samples is possible. Initially, in order to be able to compare individually the quota of each miRNA present in the glioblastomas, oligodendrogliomas and healthy tissues, the assay values for each miRNA are normalized with respect to the data obtained for a non-coding RNA (of the snoRNA category) called RNU24 (SEQ ID NO: 20). The choice of RNU24 is dictated by analysis of the measurements of several snoRNAs carried out on numerous samples using Normfinder software. This analysis has made it possible to conclude that RNU24 is the most reliable normalizer in the present study (its expression level in fact varies very little between all the tissue samples used in the invention). The relative quantification of an miRNA between 2 types of samples is then obtained for example by means of the REST software which takes into account the parameter of PCR effectiveness and the Ct values of the miRNA of interest and RNU24 for all the samples analyzed. However, the present invention can be implemented with other normalizers known to a person skilled in the art.

When the expression levels of the miRNAs are analyzed by “DNA chips” hybridization, or by Northern blot, or by sequencing, they can be expressed by Formula I:

Quantity of miRNAx=intensity of the detection signal for miRNAx

Wherein “intensity of signal” means quantity of fluorescence, radioactivity or luminescence recorded on the “DNA chips” by the suitable detector, or number of identical sequences detected by the high-throughput sequencing analysis. The quantities are expressed in arbitrary units.

The quantities of miRNA can be normalized compared with another assay, in particular an RNA the concentration of which does not vary in the different types of samples analyzed. In particular, the tissue quantity of a non-coding RNA called RNU24 has been shown by the inventors to be very stable between the tumoral samples and the healthy tissue samples. This normalization makes it possible to ensure comparison of the expression levels of the miRNAs detectable in extracts having RNA concentrations that are similar between these different purified extracts. In this case, the normalized expression level for an miRNA in a tissue sample is expressed by Formula II:

Quantity of normalized miRNAx=intensity of the detection signal for miRNAx/intensity of the signal for RNU24.

When the expression levels of the miRNAs are analyzed by real-time PCR, they can be expressed by Formula III, which defines the quantity of miRNA present in the assay reaction medium when the number of amplification cycles is equal to Ct (Quantity of miRNAx at Ct):

Quantity of miRNAx at Ct=Quantity of miRNA at tₒ×Effectiveness^{-Ct}.

where “Quantity of miRNA at tₒ” designates the quantity of miRNA, or its equivalent in cDNA, at the point in time when the assay reaction by PCR amplification is initiated. The expression “effectiveness” in the formula (III) means the value of the effectiveness of PCR (value comprised between 1 and 2). This value depends on various experimental parameters, and in particular on the device carrying out the real-time PCR utilized. Once this value is measured for a particular protocol and a configured PCR machine, it is no longer necessary to measure this value each time before the calculation, unless the experimental protocol and/or operating condition of the machine have been modified for the given experiment.

In a particular embodiment of the invention, the biological sample originating from a patient with a suspected glioma is brain tissue obtained by excision, or by biopsy.

This method comprises:
measurement of the expression level of at least one miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b*, hsa-miR-155, hsa-miR-210 or hsa-miR-10a, in a biological tissue originating from a tissue suspected of having a tumoral character,
comparison:
   between the expression level of at least one abovementioned miRNA in the suspect tissue and the expression level of the abovementioned miRNA in a reference healthy tissue, or
   between the expression level of at least one first abovementioned miRNA in the suspect tissue and the expression level of at least one second above-mentioned miRNA in the suspect tissue.

Comparisons of the expression levels of the miRNAs can be carried out between a suspect sample and a healthy reference sample. This involves an inter-sample comparison.

In a first embodiment, the method for the in vitro diagnosis of glioma comprises:
measurement of the expression level of at least one miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b*, hsa-miR-155, hsa-miR-210 or hsa-miR-10a, in a biological sample originating from a patient with a suspected glioma,
comparison between the expression level of at least one above-mentioned miRNA in the abovementioned sample and the expression level of the abovementioned miRNA in a healthy reference sample, and
deduction that the suspected patient has a glioma when the expression level of the abovementioned miRNA in the sample originating from a patient with a suspected glioma is different from the expression level of the abovementioned miRNA in a healthy reference sample.

In an advantageous embodiment of the invention, this method comprises measurement of the expression level of at least one miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b or hsa-miR-34b*.

Among the 16 miRNAs identified in the invention, there are 10 miRNAs the expression level of which is systematically higher in the samples originating from a patient with a glioma compared with that in the healthy reference samples, whereas the expression level of 6 other miRNAs is lower in the samples originating from a patient with a glioma compared with that in the healthy reference samples.

Thus, a particular embodiment of the method for the in vitro diagnosis of glioma comprises:
measurement of the expression level is carried out for at least one of the following miRNAs: hsa-miR-126, hsa-miR-15b, hsa-miR-16, hsa-miR-17, hsa-miR-20a, hsa-let7a, hsa-let 7f, hsa-let 7d, hsa-miR-374 or hsa-miR-26b, and
deduction that the suspected patient has a glioma is made when the expression level of the abovementioned miRNA in the sample originating from a patient with a suspected glioma is greater than the expression level of the abovementioned miRNA in a healthy reference sample.

Another particular embodiment of the method for the in vitro diagnosis of glioma comprises:
measurement of the expression level is carried out for at least one of the following miRNAs: hsa-miR-409, hsa-miR-134, hsa-miR-339, hsa-miR-127, hsa-miR-151 or hsa-miR-34b*, and
deduction that the suspected patient has a glioma is made when the expression level of the abovementioned miRNA in the sample originating from a patient with a suspected glioma is less than the expression level of the abovementioned miRNA in the healthy reference sample.

When the expression levels of the miRNAs are obtained by “DNA chips” hybridization or by sequencing, the comparison of the expression levels of the same miRNA in two different samples intended to demonstrate the modifications of expression of an miRNA between these samples (overexpression or underexpression) is evaluated by means of Formula IV:

Quantity of normalized miRNAx (sample A)/Quantity of normalized miRNAx (sample B),

where A represents the suspect sample and B represents the healthy reference sample.

When the expression levels of the miRNAs are obtained by real-time PCR, comparison of the expression levels of the same miRNA in two different samples can be expressed by a ratio obtained by Formula (V) below:

Ratio (sample A/sample B)=Effectiveness^{-Ct has-miRNA X-Ct RNU24)sample A-(Ct has-miRNAX-Ct RNU24)sample B)}.

In the case in point, sample A is the suspect sample; sample B is the healthy reference sample. miRNA X represents the miRNA the expression level of which is measured in the healthy reference sample and the suspect sample respectively. The Ct values for hsa-miRNA X and for RNU24, for the suspect sample and the healthy reference sample respectively, are obtained directly by real-time PCR.

The variations in the expression levels between the expression level of an miRNA in a sample originating from a patient with a suspected glioma and that of the above-mentioned miRNA in a healthy reference sample can be deduced from Formula IV or V, depending on the method of analysis used.

In a particular embodiment of the invention, the deduction that the suspected patient has a glioma is made when the expression level of the abovementioned miRNA in the sample originating from a patient with a suspected glioma and the expression level of the abovementioned miRNA in the healthy reference sample are different, the expression level of the abovementioned miRNA in the sample originating from a patient with a suspected glioma being at least 3 times greater than or less than the expression level of the above-mentioned miRNA in the healthy reference sample.

Respectively, the result of Formulae IV or V is greater than 3 or less than 0.33.

According to an advantageous embodiment, the expression level of the abovementioned miRNA in the sample originating from a patient with a suspected glioma is at least 3 times greater than the expression level of the abovementioned miRNA in the healthy reference sample.

By the expression<<expression level of the abovementioned miRNA in the sample originating from a patient with a suspected glioma is at least 3 times greater than the expression level of the abovementioned miRNA in the healthy reference sample”, is meant that the ratio obtained according to Formulae (IV or V) is greater than a value of 3. This value means an overexpression of said miRNA in the sample originating from a patient with a suspected glioma compared with the healthy reference sample. In the case in point, in these formulae, sample A is the sample originating from a suspected patient; sample B is the healthy reference sample.

According to another advantageous embodiment, the expression level of the abovementioned miRNA in the sample originating from a patient with a suspected glioma is at least 3 times less than the expression level of the abovementioned miRNA in the healthy reference sample.

By the expression “expression level of the abovementioned miRNA in the sample originating from a patient with a suspected glioma is at least 3 times less than the expression level of the abovementioned miRNA in the healthy reference sample”, is meant that the ratio calculated according to Formulae (IV or V) is less than a value 0.33. This value means an underexpression of said miRNA in the sample originating from a patient with a suspected glioma with respect to the healthy reference sample. In the case in point, in these formulae, sample A is the sample originating from a suspected patient; sample B is the healthy reference sample.

According to a particularly advantageous embodiment, the method for the in vitro diagnosis of glioma comprises:
measurement of the expression level of at least one miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b*, in a biological sample originating from a patient with a suspected glioma,
comparison between the expression level of the abovementioned miRNA in the abovementioned sample, and the expression level of the abovementioned miRNA in a healthy reference sample, and,
deduction that the suspected patient has a glioma when the expression level of the abovementioned miRNA in the sample originating from a patient with a suspected glioma and the expression level of the abovementioned miRNA in the healthy reference sample are different, the expression level of the abovementioned miRNA in the sample originating from a patient with a suspected glioma being 3 times, in particular 4 times, more particularly 5 times, greater than or less than the expression level of the abovementioned miRNA in the healthy reference sample.

Comparisons can also be made between the expression levels of two miRNAs originating from the same sample originating from a patient suspected of having a glioma. This involves an intra-sample comparison, which is based on the identification of signatures specific to each tumour type.

Thus, a second embodiment of a method for the in vitro diagnosis of glioma comprises:

(i) measurement of the expression level of at least one miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b*, hsa-miR-155, hsa-miR-210 or hsa-miR-10a, in a biological sample originating from a patient with a suspected glioma,

(ii) comparison between the expression level of at least one first above-mentioned miRNA in the sample originating from a patient with a suspected glioma and the expression level of at least one second abovementioned miRNA in the abovementioned sample, and

(iii) deduction that the suspected patient has a glioma when the ratio between the expression level of the abovementioned first miRNA and the expression level of the abovementioned second miRNA is different from that in a pre-established chart for a healthy reference sample, said first miRNA and second miRNA forming an miRNA pair.

“The ratio between the expression level of the abovementioned first miRNA and the expression level of the abovementioned second miRNA” is a ratio obtained according to Formula (VI) below in the case of the real-time PCR assay:

Ratio_{(hsa-miRNA X/hsa-miRNA Y)}=Effectiveness^{-(Ct hsa-miRNA X-Ct hsa-miRNA Y)}.

In the case in point, the first miRNA and the second miRNA, the expression levels of which are compared, are represented respectively by miRNA X and miRNA Y. The Ct values for hsa-miRNA X and Ct for hsa-miRNA Y, for the sample originating from a suspected patient and for the healthy reference sample, are obtained directly by real-time PCR. The effectiveness value is established beforehand.

In the case of an assay carried out by a method other than real-time PCR, the ratio between the expression level of the abovementioned first miRNA and the expression level of the abovementioned second miRNA” is a ratio obtained according to Formula VII:

Ratio_{(hsa-miRNA X/hsa-miRNA Y)}=intensity of detection signal of miRNA X/intensity of detection signal of miRNA Y

In the case in point, the first miRNA and the second miRNA, the expression levels of which are compared, are represented by miRNA X and miRNA Y respectively.

By the expression “chart”, is meant a pre-established table or graph, constituted by a series of reference values.

By “a pre-established chart for a healthy reference sample”, is meant a table or graph constituted by a series of reference values obtained in a healthy reference sample. More particularly, such a reference value, which is used to establish a chart, is a ratio_{(hsa-miRNA X/hsa-miRNA Y)} obtained in a healthy reference sample.

The expression “the abovementioned first miRNA and second miRNA forming an miRNA pair” means that the comparison of the expression levels of the miRNAs is carried out between these two miRNAs. As a function of the number of miRNA pairs, a chart in the form of a graph can be a two-dimensional graph, in the case of two miRNA pairs, or a three-dimensional graph, in the case of three miRNA pairs. In fact, a chart in the form of a two-dimensional or three-dimensional graph produces a double or triple separation based on two or three ratios for a sample to be tested, which makes it possible to avoid confusion in the interpretation optionally given to a suspect sample, when this interpretation is based on a single ratio_{(hsa-miRNA X/hsa-miRNA Y)} obtained from a suspect sample.

However, it is possible to adopt any other manner of establishing a chart for interpreting a ratio_{(hsa-miRNA X/hsa-miRNA Y)} obtained for a sample originating from a suspected patient.

After the establishment of a chart, the use of healthy samples is no longer required and any new sample can be typed by the assay of a minimum of 2 miRNAs only.

In an advantageous embodiment of the invention, the miRNA pairs used are the following: hsa-let 7a/hsa-miR127, hsa-let 7a/hsa-miR15b, hsa-let 7a/hsa-miR-34b*, hsa-miR126/hsa-let 7a, hsa-miR126/hsa-miR-34b*, hsa-miR127/hsa-let 7d, hsa-miR127/hsa-miR15b, hsa-miR134/hsa-let 7a, hsa-miR134/hsa-miR10a, hsa-miR151/hsa-let 7a, hsa-miR151/hsa-let 7d, hsa-miR151/hsa-let 7f, hsa-miR151/hsa-miR15b, hsa-miR15b/hsa-miR409, hsa-miR16/hsa-miR151, hsa-miR16/hsa-miR339, hsa-miR16/hsa-miR-34b*, hsa-miR17/hsa-miR339, hsa-miR17/hsa-miR-34b*, hsa-miR17/hsa-miR409, hsa-miR20a/hsa-miR339, hsa-miR26b/hsa-miR134, hsa-miR26b/hsa-miR-34b*, hsa-miR26b/hsa-miR409, hsa-miR339/hsa-let 7f, hsa-miR-34b*/hsa-let 7f, hsa-miR374/hsa-let 7f, hsa-miR374/hsa-miR127, hsa-miR374/hsa-miR134, hsa-miR374/hsa-miR339, hsa-miR374/hsa-miR-34b*, hsa-miR374/hsa-miR409, hsa-miR409/hsa-miR10a, hsa-miR155/hsa-miR134, hsa-miR155/hsa-miR127, hsa-miR126/hsa-miR409, hsa-miR127/hsa-let 7f, hsa-miR151/hsa-miR20a, hsa-miR16/hsa-miR134, hsa-miR126/hsa-miR339, hsa-miR151/hsa-miR10a, hsa-miR16/hsa-miR127, hsa-miR20a/hsa-let 7f, hsa-miR20a/hsa-miR409, hsa-miR155/hsa-miR409, hsa-miR339/hsa-let 7d, hsa-miR151/hsa-miR374, hsa-miR127/hsa-miR10a, hsa-miR15b/hsa-let 7f, hsa-miR20a/hsa-let 7a, hsa-miR210/hsa-miR155, hsa-miR210/hsa-let 7a, hsa-miR26b/hsa-miR-339, hsa-miR26b/hsa-miR-127, hsa-miR16/hsa-miR-409, hsa-miR127/hsa-miR-17, hsa-miR151/hsa-miR126, hsa-miR26b/hsa-miR151, hsa-miR20a/hsa-miR127, hsa-miR339/hsa-let 7a, hsa-miR26b/hsa-let 7f, hsa-miR126/hsa-miR134, hsa-miR20a/hsa-miR-34b*, hsa-let 7d/hsa-miR-34b*, hsa-miR15b/hsa-miR339, hsa-let 7d/hsa let 7f, hsa-miR10a/hsa let 7d, hsa-miR126/hsa let 7f, hsa-miR126/hsa-miR10a, hsa-miR126/hsa-miR155, hsa-miR127/hsa-miR126, hsa-miR134/hsa-miR17, hsa-miR134/hsa-miR409, hsa-miR151/hsa-miR17, hsa-miR155/hsa-miR339, hsa-miR15b/hsa-miR10a, hsa-miR15b/hsa-miR155, hsa-miR15b/hsa-miR-34b*, hsa-miR16/hsa-miR10a, hsa-miR16/hsa-miR126, hsa-miR16/hsa-miR155, hsa-miR16/hsa-miR15b, hsa-miR16/hsa-miR20a, hsa-miR17/hsa let 7d, hsa-miR20a/hsa-miR10a, hsa-miR210/hsa-miR127, hsa-miR210/hsa-miR134, hsa-miR210/hsa-miR339, hsa-miR210/hsa-miR409, hsa-miR26b/hsa let 7a, hsa-miR26b/hsa-miR10a, hsa-miR26b/hsa-miR155, hsa-miR26b/hsa-miR15b, hsa-miR374/hsa-miR10a, hsa-miR10a/hsa-miR210, hsa-miR10a/hsa-miR339, hsa-miR10a/hsa-miR-34b*, hsa-miR155/hsa let 7f, hsa-miR16/hsa let 7a, hsa-miR16/hsa-miR210, hsa-miR210/hsa let 7d, hsa-miR210/hsa-miR126, hsa-miR210/hsa-miR15b, hsa-miR210/hsa-miR17, hsa-miR210/hsa-miR20a, hsa-miR210/hsa-miR374, hsa-miR26b/hsa-miR210, hsa-miR16/hsa let 7f, hsa-miR16/hsa-miR374.

The inverse ratios of those mentioned in the above list keep the same meaning for diagnosis, i.e. it is possible to use these ratios or their inverse.

A deduction that the patient has at least one glial tumour is made when the ratio of the expression level of two miRNAs in a pair is different from the abovementioned ratio established in a healthy reference sample.

By way of example, column 2 of Table 4 illustrates a pre-established chart in the form of a table, in a reference healthy tissue, for each miRNA pair. According to the invention, it is also possible to establish a two-dimensional or three-dimensional graph, using two or more miRNA pairs chosen from the miRNA pairs mentioned in the section above.

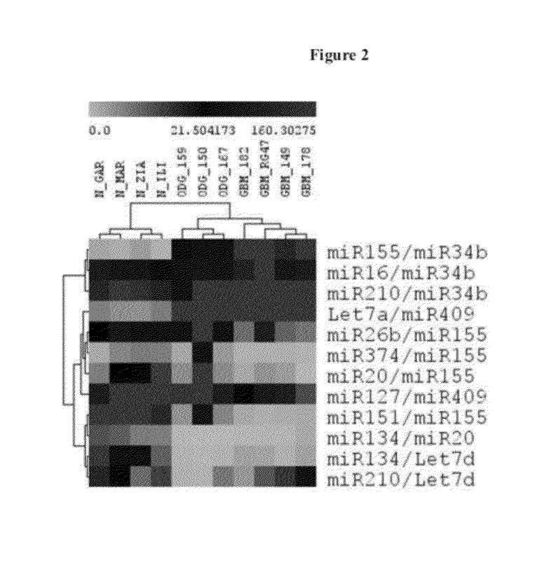

By way of example, FIGS. 2-6 are charts in the form of two-dimensional graphs, in which the diamond symbols representing normal tissues constitute an area framed by the rectangle drawn with dashed-dotted lines. After the assay of miRNAs concerned and calculation of the ratios such as those which are used for the establishment of the chart, the nature of the suspect tissue can be easily identified on this chart, and it can be deduced that the suspect tissue is a tumoral tissue when the symbol representing the suspect tissue does not come within the area framed by the rectangle drawn with dashed-dotted lines.

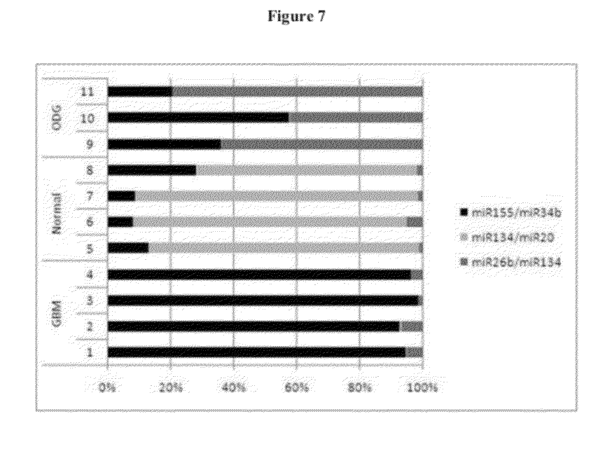

Also by way of example, FIG. 7, based on the use of 3 different miRNA pairs the respective values of which are expressed as a percentage of the sum of the values of these 3 pairs, makes it possible to easily identify healthy tissues compared with tumoral tissues since they are characterized—unlike tumoral tissues—by high values of the hsa-miR134/hsa-miR20a pair (pale grey bars) compared with the values of the two other pairs in a given tissue.

In an advantageous embodiment of the invention, the deduction that the suspected patient has a glioma is made when the ratio between the expression level of the abovementioned first miRNA and the expression level of the abovementioned second miRNA is twice, in particular 3 times, more particularly 4 times, greater than the value of said ratio in a pre-established chart for a healthy reference sample.

In another advantageous embodiment of the invention, the deduction that the suspected patient has a glioma is made when the ratio between the expression level of the abovementioned first miRNA and the expression level of the abovementioned second miRNA is twice, in particular 3 times, more particularly 4 times, less than the value of said ratio in a pre-established chart for a healthy reference sample.

An advantageous embodiment of a method for the in vitro diagnosis of glioma according to the invention comprises:
(i) measurement of the ratio of the expression level of at least one miRNA pair chosen from hsa-let 7a/hsa-miR127, hsa-let 7a/hsa-miR15b, hsa-let 7a/hsa-miR-34b*, hsa-miR126/hsa-let 7a, hsa-miR126/hsa-miR-34b*, hsa-miR127/hsa-let 7d, hsa-miR127/hsa-miR15b, hsa-miR134/hsa-let 7a, hsa-miR134/hsa-miR10a, hsa-miR151/hsa-let 7a, hsa-miR151/hsa-let 7d, hsa-miR151/hsa-let 7f, hsa-miR151/hsa-miR15b, hsa-miR15b/hsa-miR409, hsa-miR16/hsa-miR151, hsa-miR16/hsa-miR339, hsa-miR16/hsa-miR-34b*, hsa-miR17/hsa-miR339, hsa-miR17/hsa-miR-34b*, hsa-miR17/hsa-miR409, hsa-miR20a/hsa-miR339, hsa-miR26b/hsa-miR134, hsa-miR26b/hsa-miR-34b*, hsa-miR26b/hsa-miR409, hsa-miR339/hsa-let 7f, hsa-miR-34b*/hsa-let 7f, hsa-miR374/hsa-let 7f, hsa-miR374/hsa-miR127, hsa-miR374/hsa-miR134, hsa-miR374/hsa-miR339, hsa-miR374/hsa-miR-34b*, hsa-miR374/hsa-miR409, hsa-miR409/hsa-miR10a, hsa-miR155/hsa-miR134, hsa-miR155/hsa-miR127, hsa-miR126/hsa-miR409, hsa-miR127/hsa-let 7f, hsa-miR151/hsa-miR20a, hsa-miR16/hsa-miR134, hsa-miR126/hsa-miR339, hsa-miR151/hsa-miR10a, hsa-miR16/hsa-miR127, hsa-miR20a/hsa-let 7f, hsa-miR20a/hsa-miR409, hsa-miR155/hsa-miR409, hsa-miR339/hsa-let 7d, hsa-miR151/hsa-miR374, hsa-miR127/hsa-miR10a, hsa-miR15b/hsa-let 7f, hsa-miR20a/hsa-let 7a, hsa-miR210/hsa-miR155, hsa-miR210/hsa-let 7a, hsa-miR26b/hsa-miR-339, hsa-miR26b/hsa-miR-127, hsa-miR16/hsa-miR-409, hsa-miR127/hsa-miR-17, hsa-miR151/hsa-miR126, hsa-miR26b/hsa-miR151, hsa-miR20a/hsa-miR127, hsa-miR339/hsa-let 7a, hsa-miR26b/hsa-let 7f, hsa-miR126/hsa-miR134, hsa-miR20a/hsa-miR-34b*, hsa-let 7d/hsa-miR-34b*, hsa-miR15b/hsa-miR339, hsa-let 7d/hsa let 7f, hsa-miR10a/hsa let 7d, hsa-miR126/hsa let 7f, hsa-miR126/hsa-miR10a, hsa-miR126/hsa-miR155, hsa-miR127/hsa-miR126, hsa-miR134/hsa-miR17, hsa-miR134/hsa-miR409, hsa-miR151/hsa-miR17, hsa-miR155/hsa-miR339, hsa-miR15b/hsa-miR10a, hsa-miR15b/hsa-miR155, hsa-miR15b/hsa-miR-34b*, hsa-miR16/hsa-miR10a, hsa-miR16/hsa-miR126, hsa-miR16/hsa-miR155, hsa-miR16/hsa-miR15b, hsa-miR16/hsa-miR20a, hsa-miR17/hsa let 7d, hsa-miR20a/hsa-miR10a, hsa-miR210/hsa-miR127, hsa-miR210/hsa-miR134, hsa-miR210/hsa-miR339, hsa-miR210/hsa-miR409, hsa-miR26b/hsa let 7a, hsa-miR26b/hsa-miR10a, hsa-miR26b/hsa-miR155, hsa-miR26b/hsa-miR15b, hsa-miR374/hsa-miR10a, hsa-miR10a/hsa-miR210, hsa-miR10a/hsa-miR339, hsa-miR10a/hsa-miR-34b*, hsa-miR155/hsa let 7f, hsa-miR16/hsa let 7a, hsa-miR16/hsa-miR210, hsa-miR210/hsa let 7d, hsa-miR210/hsa-miR126, hsa-miR210/hsa-miR15b, hsa-miR210/hsa-miR17, hsa-miR210/hsa-miR20a, hsa-miR210/hsa-miR374, hsa-miR26b/hsa-miR210, hsa-miR16/hsa let 7f, hsa-miR16/hsa-miR374, in a biological sample originating from a patient with a suspected glioma,
(ii) deduction that the suspected patient has a glioma when the above-mentioned ratio between the expression level of the abovementioned first miRNA and the expression level of the abovementioned second miRNA is twice, in particular 3 times, more particularly 4 times, greater or less than the value of said ratio in a pre-established chart in a healthy reference sample.

In a particular embodiment of the invention, the biological sample originating from a patient with a suspected glioma is brain tissue obtained by excision, or by biopsy. Said method comprises:

(i) measurement of the ratio of the expression level of at least one miRNA pair chosen from hsa-let 7a/hsa-miR127, hsa-let 7a/hsa-miR15b, hsa-let 7a/hsa-miR-34b*, hsa-miR126/hsa-let 7a, hsa-miR126/hsa-miR-34b*, hsa-miR127/hsa-let 7d, hsa-miR127/hsa-miR15b, hsa-miR134/hsa-let 7a, hsa-miR134/hsa-miR10a, hsa-miR151/hsa-let 7a, hsa-miR151/hsa-let 7d, hsa-miR151/hsa-let 7f, hsa-miR151/hsa-miR15b, hsa-miR15b/hsa-miR409, hsa-miR16/hsa-miR151, hsa-miR16/hsa-miR339, hsa-miR16/hsa-miR-34b*, hsa-miR17/hsa-miR339, hsa-miR17/hsa-miR-34b*, hsa-miR17/hsa-miR409, hsa-miR20a/hsa-miR339, hsa-miR26b/hsa-miR134, hsa-miR26b/hsa-miR-34b*, hsa-miR26b/hsa-miR409, hsa-miR339/hsa-let 7f, hsa-miR-34b*/hsa-let 7f, hsa-miR374/hsa-let 7f, hsa-miR374/hsa-miR127, hsa-miR374/hsa-miR134, hsa-miR374/hsa-miR339, hsa-miR374/hsa-miR-34b*, hsa-miR374/hsa-miR409, hsa-miR409/hsa-miR10a, hsa-miR155/hsa-miR134, hsa-miR155/hsa-miR127, hsa-miR126/hsa-miR409, hsa-miR127/hsa-let 7f, hsa-miR151/hsa-miR20a, hsa-miR16/hsa-miR134, hsa-miR126/hsa-miR339, hsa-miR151/hsa-miR10a, hsa-miR16/hsa-miR127, hsa-miR20a/hsa-let 7f, hsa-miR20a/hsa-miR409, hsa-miR155/hsa-miR409, hsa-miR339/hsa-let 7d, hsa-miR151/hsa-miR374, hsa-miR127/hsa-miR10a, hsa-miR15b/hsa-let 7f, hsa-miR20a/hsa-let 7a, hsa-miR210/hsa-miR155, hsa-miR210/hsa-let 7a, hsa-miR26b/hsa-miR-339, hsa-miR26b/hsa-miR-127, hsa-miR16/hsa-miR-409, hsa-miR127/hsa-miR-17, hsa-miR151/hsa-miR126, hsa-miR26b/hsa-miR151, hsa-miR20a/hsa-miR127, hsa-miR339/hsa-let 7a, hsa-miR26b/hsa-let 7f, hsa-miR126/hsa-miR134, hsa-miR20a/hsa-miR-34b*, hsa-let 7d/hsa-miR-34b*, hsa-miR15b/hsa-miR339, hsa-let 7d/hsa let 7f, hsa-miR10a/hsa let 7d, hsa-miR126/hsa let 7f, hsa-miR126/hsa-miR10a, hsa-miR126/hsa-miR155, hsa-miR127/hsa-miR126, hsa-miR134/hsa-miR17, hsa-miR134/hsa-miR409, hsa-miR151/hsa-miR17, hsa-miR155/hsa-miR339, hsa-miR15b/hsa-miR10a, hsa-miR15b/hsa-miR155, hsa-miR15b/hsa-miR-34b*, hsa-miR16/hsa-miR10a, hsa-miR16/hsa-miR126, hsa-miR16/hsa-miR155, hsa-miR16/hsa-miR15b, hsa-miR16/hsa-miR20a, hsa-miR17/hsa let 7d, hsa-miR20a/hsa-miR10a, hsa-miR210/hsa-miR127, hsa-miR210/hsa-miR134, hsa-miR210/hsa-miR339, hsa-miR210/hsa-miR409, hsa-miR26b/hsa let 7a, hsa-miR26b/hsa-miR10a, hsa-miR26b/hsa-miR155, hsa-miR26b/hsa-miR15b, hsa-miR374/hsa-miR10a, hsa-miR10a/hsa-miR210, hsa-miR10a/hsa-miR339, hsa-miR10a/hsa-miR-34b*, hsa-miR155/hsa let 7f, hsa-miR16/hsa let 7a, hsa-miR16/hsa-miR210, hsa-miR210/hsa let 7d, hsa-miR210/hsa-miR126, hsa-miR210/hsa-miR15b, hsa-miR210/hsa-miR17, hsa-miR210/hsa-miR20a, hsa-miR210/hsa-miR374, hsa-miR26b/hsa-miR210, hsa-miR16/hsa let 7f, hsa-miR16/hsa-miR374, in a biological tissue originating from a tissue suspected of having a tumoral character,

(ii) deduction of the tumoral character of the suspect tissue, when the above-mentioned ratio between the expression level of the abovementioned first miRNA and the expression level of the abovementioned second miRNA is twice, in particular 3 times, more particularly 4 times, greater or less than the value of said ratio in a pre-established chart in a reference healthy tissue.

A subject of the invention is also a method for the in vitro diagnosis of glioma, making it possible to distinguish a glioblastoma from an oligodendroglioma.

In a first embodiment, this method is based only on the utilization of 5 miRNAs identified by the Inventors, namely hsa-miR-155, hsa-miR-210 or hsa-miR-10a, hsa-miR-409 or hsa-miR-134, the expression levels of which are systematically higher in glioblastomas compared with those in oligodendrogliomas.

This analysis method involves carrying out inter-sample comparisons.

This method comprises:
measurement of the expression level of at least one miRNA chosen from hsa-miR-155, hsa-miR-210, hsa-miR-10a, hsa-miR-409 or hsa-miR-134, in a biological sample originating from a patient suspected of having a glioblastoma or an oligodendroglioma,
comparison between:
   the expression level of the abovementioned miRNA in said biological sample and
      respectively the expression level of the abovementioned miRNA in a biological reference sample originating from a patient with a glioblastoma, and
      respectively the expression level of the abovementioned miRNA in a biological reference sample originating from a patient with an oligodendroglioma, and
deduction:
   either that the suspected patient has a glioblastoma when the expression level of the abovementioned miRNA in the sample originating from a patient suspected of having a glioblastoma or an oligodendroglioma is equal within a limit of 20% more or 20% less, to the expression level of the above-mentioned miRNA in the reference sample originating from a patient with a glioblastoma,
   or that the suspected patient has an oligodendroglioma when the expression level of the abovementioned miRNA in the sample originating from a patient suspected of having a glioblastoma or an oligodendroglioma is equal, within a limit of 20% more or 20% less, to the expression level of the above-mentioned miRNA in the reference sample originating from a patient with an oligodendroglioma.

“A biological reference sample originating from a patient suspected of having a glioblastoma or an oligodendroglioma” is a sample taken from a patient in whom the presence of a glial tumour is already confirmed by a method described in the abovementioned part or by any other conventional method known to a person skilled in the art, such as histological analysis, or a scanner. Nevertheless, the precise nature or the classification of the glial tumour is still unknown.

A reference sample originating from a patient with a glioblastoma or an oligodendroglioma can be a glioblastoma or an oligodendroglioma tissue obtained by excision from a patient, in whom the type of tumour has been certified by pathological analysis, or a blood sample taken from a patient in whom the presence of a glioblastoma or an oligodendroglioma is confirmed. Ideally, diagnosis can also be confirmed by molecular analyses such as for example analysis of the gene expression profiles of these tumoral tissues. The tumours are then characterized using the classification method of Li et al. (Li A, Walling J, Ahn S, Kotliarov Y, Su Q, Quezado M, Oberholtzer J C, Park J, Zenklusen J C, Fine HA. Cancer Res. 2009 Mar. 1; 69(5):2091-9) which is based on the use of the expression levels of a set of 54 genes. The glioblastomas or oligodendrogliomas are classified in Groups G and O of the abovementioned publication respectively.

Given that the expression levels of 5 miRNAs utilized in this method for determining the nature of a glial tumour are systematically higher in glioblastomas compared with oligodendrogliomas, when the suspect sample originates from a patient with a glioblastoma, the expression level of an abovementioned miRNA in the suspect sample is greater than the expression level of said miRNA in the reference sample originating from a patient with an oligodendroglioma, and close to the expression level of said miRNA in the reference sample originating from a patient with a glioblastoma.

On the other hand, when the suspect sample originates from a patient with an oligodendroglioma, the expression level of an abovementioned miRNA in the suspect sample is less than the expression level of said miRNA in the reference sample originating from a patient with a glioblastoma, and close to the expression level of said miRNA in the reference sample originating from a patient with an oligodendroglioma.

The expression levels of the miRNAs can be measured by “DNA chip” hybridization, by sequencing, or by real-time PCR.

When the assay of the expression levels of the miRNAs is carried out using “DNA chip” hybridization or by sequencing, the comparison between the expression level of an miRNA in the suspect sample and that in a reference sample (glioblastomas or oligodendrogliomas) is evaluated according to Formula IV:

Quantity of normalized miRNAx (sample A)/Quantity of normalized miRNAx (sample B)

In the case in point, A represents the suspect sample and B represents a reference sample originating from a patient with a glioblastoma or an oligodendroglioma.

When the assay of the expression levels is obtained by real-time PCR, the comparison between the expression level of an miRNA in the suspect sample and that in a reference sample originating from a patient with a glioblastoma or an oligodendroglioma is evaluated according to Formula V below

Ratio (sample A/sample B)=Effectiveness^{-((Ct hsa-miRNA X-Ct RNU24)sample A-(Ct hsa-maNAX-Ct RNU24)sample B)},

where sample A is the suspect sample and sample B is the reference sample originating from a patient with a glioblastoma or an oligodendroglioma.

Thus, the deduction that the patient has a glioblastoma is made when:
the expression level of the abovementioned miRNA in the sample originating from a patient suspected of having a glioblastoma or an oligodendroglioma is at least 3 times greater than the expression level of the abovementioned miRNA in the reference sample originating from a patient with an oligodendroglioma, and
the expression level of the abovementioned miRNA in the sample originating from a patient suspected of having a glioblastoma or an oligodendroglioma is equal, within a limit of 20% more or 20% less, to the expression level of the abovementioned miRNA in the reference sample originating from a patient with a glioblastoma.

The expression “the expression level of the abovementioned miRNA in the sample originating from a patient suspected of having a glioblastoma or an oligodendroglioma is at least 3 times greater than the expression level of the abovementioned miRNA in the reference sample originating from a patient with an oligodendroglioma” means that the ratio between the expression level of an miRNA in the sample originating from a suspected patient and the expression level of the abovementioned miRNA in a reference sample originating from a patient with an oligodendroglioma, obtained according to Formula IV or V, has a value equal to or greater than 3.

In the case in point, in these formulae, sample A is the suspect sample; sample B is the reference sample originating from a patient with an oligodendroglioma.

The expression “the expression level of the abovementioned miRNA in the sample originating from a patient suspected of having a glioblastoma or an oligodendroglioma is equal, within a limit of 20% more or 20% less, to the expression level of the above-mentioned miRNA in the reference sample originating from a patient with a glioblastoma” means that the ratio between the expression level of an miRNA in the suspect sample and the expression level of the abovementioned miRNA in a reference sample originating from a patient with a glioblastoma, obtained according to Formula IV or V, has a value equal to 1 or comprised between 0.8 and 1.2.

In the case in point, in these formulae, sample A is the suspect sample; sample B is the reference sample originating from a patient with a glioblastoma.

The deduction that the patient has an oligodendroglioma is made when:
the expression level of the abovementioned miRNA in the sample originating from a patient suspected of having a glioblastoma or an oligodendroglioma is at least 3 times less than the expression level of the abovementioned miRNA in the reference sample originating from a patient with a glioblastoma, and
the expression level of the abovementioned miRNA in the sample originating from a patient suspected of having a glioblastoma or an oligodendroglioma is equal, within a limit of 20% more or 20% less, to the expression level of the abovementioned miRNA in the reference sample originating from a patient with an oligodendroglioma.

The expression “the expression level of the abovementioned miRNA in the sample originating from a patient suspected of having a glioblastoma or an oligodendroglioma is at least 3 times less than the expression level of the abovementioned miRNA in the reference sample originating from a patient with a glioblastoma” means that the ratio between the expression level of an miRNA in the suspect sample and the expression level of the abovementioned miRNA in a reference sample originating from a patient with a glioblastoma, obtained according to Formula IV or V, has a value equal to or less than 0.33.

In the case in point, in these formulae, sample A is the suspect sample; sample B is the reference sample originating from a patient with a glioblastoma.

The expression “the expression level of the abovementioned miRNA in the sample originating from a patient suspected of having a glioblastoma or an oligodendroglioma is equal, within a limit of 20% more or 20% less, to the expression level of the above-mentioned miRNA in the reference sample originating from a patient with an oligodendroglioma” means that the ratio between the expression level of an miRNA in the suspect sample and the expression level of the abovementioned miRNA in a reference sample originating from a patient with an oligodendroglioma, obtained according to Formula IV or V, has a value equal to 1 or comprised between 0.8 and 1.2.

In the case in point, in these formulae, sample A is the suspect sample; sample B is the reference sample originating from a patient with an oligodendroglioma.

In summary, when the suspect sample originates from a patient with a glioblastoma, the ratio between the expression level of an miRNA in the suspect sample and the expression level of the abovementioned miRNA in the reference sample originating from a patient with a glioblastoma is close to the value of 1, and the ratio between the expression level of an miRNA in the suspect sample and the expression level of the abovementioned miRNA in the reference sample originating from a patient with an oligodendroglioma is greater than 3.

By contrast, when the suspect sample originates from a patient with an oligodendroglioma, the ratio between the expression level of an miRNA in the suspect tissue and the expression level of the abovementioned miRNA in the reference sample originating from a patient with an oligodendroglioma is close to a value of 1, and the ratio between the expression level of an miRNA in the suspect sample and the expression level of the abovementioned miRNA in the reference sample originating from a patient with a glioblastoma is less than 0.33.

More particularly, this method therefore comprises the following stages:

(i) measurement of the expression level of at least one miRNA chosen from hsa-miR-155, hsa-miR-210 or hsa-miR-10a, hsa-miR-409 or hsa-miR-134, in a biological sample originating from a patient suspected of having a glioblastoma or an oligodendroglioma,

(ii) comparison between:
the expression level of the abovementioned miRNA in the sample originating from a patient suspected of having a glioblastoma or an oligodendroglioma and
   respectively the expression level of the abovementioned miRNA in the reference sample originating from a patient with a glioblastoma, and
   respectively the expression level of the abovementioned miRNA in the reference sample originating from a patient with an oligodendroglioma,

(iii) deduction:
either that the abovementioned patient has a glioblastoma,
   when the expression level of the abovementioned miRNA in the sample originating from a patient suspected of having a glioblastoma or an oligodendroglioma is equal, within a limit of 20% more or 20% less, to the expression level of the abovementioned miRNA in the reference sample originating from a patient with a glioblastoma, and
   when the expression level of the abovementioned miRNA in the sample originating from a patient suspected of having a glioblastoma or an oligodendroglioma is at least 3 times greater than the expression level of the abovementioned miRNA in the sample originating from a patient with an oligodendroglioma,
or that the patient has an oligodendroglioma,
   when the expression level of the abovementioned miRNA in the sample originating from a patient suspected of having a glioblastoma or an oligodendroglioma is equal, within a limit of 20% more or 20% less, to the expression level of the abovementioned miRNA in the reference sample originating from a patient with an oligodendroglioma, and
   when the expression level of the abovementioned miRNA in the sample originating from a patient suspected of having a glioblastoma or an oligodendroglioma is at least 3 times less than the expression level of the abovementioned miRNA in the sample originating from a patient with a glioblastoma.

In a particular embodiment of the invention, the biological sample originating from a patient with a suspected glioma is brain tissue obtained by excision, or by biopsy. Said method comprises:

(i) measurement of the expression level of at least one miRNA chosen from hsa-miR-155, hsa-miR-210 or hsa-miR-10a, hsa-miR-409 or hsa-miR-134, in a biological tissue originating from a tumoral tissue suspected of being a glioblastoma tissue or an oligodendroglioma tissue,

(ii) comparison between:
the expression level of the abovementioned miRNA in the suspect tissue and
   respectively the expression level of the abovementioned miRNA in a reference glioblastoma tissue, and
   respectively the expression level of the abovementioned miRNA in a reference oligodendroglioma tissue, and

(iii) the deduction:
either that the suspect tissue is a glioblastoma,
   when the expression level of the abovementioned miRNA in the suspect tissue is equal, within a limit of 20% more or less, in particular 15%, more particularly 10%, to the expression level of the abovementioned miRNA in the reference glioblastoma tissue, and
   when the expression level of the abovementioned miRNA in the suspect tissue is at least 3 times greater than the expression level of the above-mentioned miRNA in the reference oligodendroglioma tissue,
or that the suspect tissue is an oligodendroglioma,
   when the expression level of the abovementioned miRNA in the suspect tissue is equal, within a limit of 20% more or less, in particular 15%, more particularly 10%, to the expression level of the abovementioned miRNA in the reference oligodendroglioma tissue, and
   when the expression level of the abovementioned miRNA in the suspect tissue is at least 3 times less than the expression level of the abovementioned miRNA in the reference glioblastoma tissue.

A second embodiment of a method for the in vitro diagnosis of glioma, making it possible to distinguish a glioblastoma from an oligodendroglioma, consists of intra-sample comparisons. This method is based on an intra-sample comparison of the expression level of two miRNAs, one of which is one of the 5 specific miRNAs the expression levels of which are higher in the glioblastomas compared with those in the oligodendrogliomas, the other is chosen from the other 14 miRNAs remaining from all of the 19 miRNAs defined previously.

This method comprises:

(i) measurement of the expression level of the miRNAs in at least one miRNA pair constituted by:
an miRNA chosen from hsa-miR-155, hsa-miR-210, hsa-miR-10a, hsa-miR-409 or hsa-miR-134, and
an miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-339, hsa-miR-127, hsa-miR-151, hsa-miR-26b, hsa-miR-34b*,

for a biological sample originating from a patient suspected of having a glioblastoma or an oligodendroglioma,

said measurement making it possible to establish the ratio of the expression level for an abovementioned miRNA pair,

(ii) comparison between:
the abovementioned ratio of the expression level for an miRNA pair and,
that represented in a pre-established chart for a healthy reference sample, a reference sample originating from a patient with a glioblastoma, and a reference sample originating from a patient with an oligodendroglioma,

(iii) the deduction:
either that the patient has a glioblastoma when the difference between the ratio obtained in stage (i) and the ratio in a pre-established chart in a reference sample originating from a patient with a glioblastoma is less than 20%, in particular 15%, more particularly 10%, with respect to the ratio in a pre-established chart,
or that the patient has an oligodendroglioma when the difference between the ratio obtained in stage (i) and the ratio in a pre-established chart in a reference sample originating from a patient with an oligodendroglioma is less than 20%, in particular 15%, more particularly 10%, with respect to the ratio in a pre-established chart.

In this method, the intra-sample comparison of the expression level of two miRNAs is expressed by a ratio_{(hsa-miRNA X/hsa-miRNA Y)}, calculated according to Formulae (VI or VII).

miRNA X is chosen from hsa-miR-155, hsa-miR-210, hsa-miR-10a, hsa-miR-409 or hsa-miR-134, and miRNA Y is chosen from the set of the 14 miRNAs defined previously. In this method the use of the inverse of the abovementioned ratios keeps all of its value for identification of the samples.

The difference between this ratio and a pre-established chart is expressed by a value given as a percentage, calculated according to Formula (VIII):

|Ratio_{(hsa-miRNA X/hsa-miRNA Y)}−Ratio_{chart}|×100/Ratio_{chart}.

Ratio_{chart}, which is to be found in a pre-established chart, is a ratio_{(hsa-miRNA X/hsa-miRNA Y)} obtained in a reference sample originating from a patient with a glioblastoma or an oligodendroglioma.

This method using a pre-established chart makes it possible to avoid using reference healthy or tumoral samples. Any new sample can be analyzed by the assay of only a few miRNAs.

By way of example, columns 3 and 4 of Table 4 give a pre-established chart in the reference sample originating from a patient with a glioblastoma or an oligodendroglioma respectively, for each miRNA pair.

A chart can also be presented in the form of a two-dimensional or three-dimensional graph.

In a chart in the form of a two-dimensional graph, such as the chart illustrated in FIGS. 2-6, by way of example, two series of ratios obtained in the reference glioblastoma tissue give an area framed by a rectangle drawn with a dotted line; two series of ratios obtained in the reference oligodendroglioma tissue give an area framed by a rectangle drawn with dashed lines.

It can be deduced that a suspect tissue is a glioblastoma tissue when the position fixed by two ratios obtained respectively from this suspect tissue is enclosed in the dotted-line rectangle covering the squares representing the reference glioblastomas.

By contrast, a suspect tissue is an oligodendroglioma tissue, when the position fixed by two ratios obtained respectively from this suspect tissue enters the rectangle drawn with dotted lines, covering the triangles representing the reference oligodendrogliomas.

In an advantageous embodiment, the miRNA pairs used are the following: hsa-miR127/hsa-miR409, hsa-miR210/hsa-miR-34b*, hsa-let 7f/hsa-miR10a, hsa-miR155/hsa-miR17, hsa-miR155/hsa-miR374, hsa-let 7a/hsa-miR 409, hsa-let 7d/hsa-miR409, hsa-miR134/hsa-let 7f, hsa-let 7f/hsa-miR409, hsa-miR134/hsa-let 7d, hsa-miR151/hsa-miR155, hsa-miR155/hsa-miR-34b*, hsa-miR15b/hsa-miR134, hsa-miR134/hsa-miR20a, hsa-miR210/hsa-let 7f, hsa-miR20/hsa-miR155.

In a particular embodiment of the invention, the biological sample originating from a patient with a suspected glioma is brain tissue obtained by excision, or by biopsy. Said method comprises:

(i) measurement of the expression level of the miRNAs of a pair chosen from hsa-miR127/hsa-miR409, hsa-miR210/hsa-miR-34b*, hsa-let 7f/hsa-miR10a, hsa-miR155/hsa-miR17, hsa-miR155/hsa-miR374, hsa-let 7a/hsa-miR 409, hsa-let 7d/hsa-miR409, hsa-miR134/hsa-let 7f, hsa-let 7f/hsa-miR409, hsa-miR134/hsa-let 7d, hsa-miR151/hsa-miR155, hsa-miR155/hsa-miR-34b*, hsa-miR15b/hsa-miR134, hsa-miR134/hsa-miR20a, hsa-miR210/hsa-let 7f, hsa-miR20/hsa-miR155, for a biological tissue originating from a tumoral tissue suspected of being a glioblastoma tissue or an oligodendroglioma tissue,

(ii) comparison between:
the abovementioned ratio of the expression level for an miRNA pair and,
that represented in a pre-established chart for a reference healthy tissue, a reference glioblastoma tissue, and a reference oligodendroglioma tissue,

(iii) the deduction:
either that the suspect tissue is a glioblastoma, when the difference between the ratio obtained in stage (i) and the ratio in a pre-established chart in a reference glioblastoma tissue is less than 20%, in particular 15%, more particularly 10%, with respect to the ratio in a pre-established chart,
or that the suspect tissue is an oligodendroglioma, when the difference between the ratio obtained in stage (i) and the ratio in a pre-established chart in a reference oligodendroglioma tissue is less than 20%, in particular 15%, more particularly 10%, with respect to the ratio in a pre-established chart.

A particular subject of the invention is a method for the in vitro diagnosis of glioma, making it possible to specify whether a patient with a suspected glioma has a glioblastoma or an oligodendroglioma.

This method comprises:
i) determination, according to one of the methods described above, of the presence of glioma in a patient with a suspected glioma,
ii) the deduction, according to one of the methods described above, that said patient has a glioblastoma or the suspected patient has an oligodendroglioma.

The first embodiment of this method consists of comparisons of the expression levels of the miRNAs between the suspect sample and the reference samples.

More precisely, this method comprises:
i) measurement of the expression level of at least one miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b or hsa-miR-34b*, in a biological sample originating from a patient with a suspected glioma,
ii) comparison of the expression levels of the abovementioned miRNA in the abovementioned sample and in a healthy reference sample,
iii) the deduction that the patient has a glioma when the expression level of the abovementioned miRNA in the sample originating from the abovementioned patient and the expression level of the abovementioned miRNA in the healthy reference sample are different, the expression level of the abovementioned miRNA in the sample originating from the abovementioned patient being 3 times, in particular 4 times, more particularly 5 times, greater than or less than the expression level of the abovementioned miRNA in the healthy reference sample,
iv) measurement of the expression level of at least one miRNA chosen from hsa-miR-155, hsa-miR-210 or hsa-miR-10a, hsa-miR-409 or hsa-miR-134, in said biological sample originating from a patient with a glioma,
v) comparison between:
the expression level of the abovementioned miRNA in the abovementioned sample and
respectively the expression level of the abovementioned miRNA in a reference sample originating from a patient with a glioblastoma, and
respectively the expression level of the abovementioned miRNA in a reference sample originating from a patient with an oligodendroglioma, and
vi) the deduction:
either that the patient has a glioblastoma when the expression level of the abovementioned miRNA in the sample originating from the abovementioned patient is equal, within a limit of 20% more or 20% less, to the expression level of the above-mentioned miRNA in the reference sample originating from a patient with a glioblastoma,
or that the patient has an oligodendroglioma when the expression level of the abovementioned miRNA in the sample originating from the abovementioned patient is equal, within a limit of 20% more or 20% less, to the expression level of the above-mentioned miRNA in the reference sample originating from a patient with an oligodendroglioma.

In a particular embodiment of the invention, the biological sample originating from a patient with a suspected glioma is brain tissue obtained by excision, or by biopsy. Said method comprises:
(i) measurement of the expression level of at least one miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b or hsa-miR-34b*,
ii) comparison of the expression levels of the abovementioned miRNA in the suspect tissue and in a reference healthy tissue,
iii) deduction of the tumoral character of the suspect tissue when the expression level of the abovementioned miRNA in the suspect tissue and the expression level of the abovementioned miRNA in the reference healthy tissue are different, the expression level of the abovementioned miRNA in the suspect tissue being 3 times, in particular 4 times, more particularly 5 times, greater than or less than the expression level of the above-mentioned miRNA in the reference healthy tissue,
iv) measurement of the expression level of at least one miRNA chosen from hsa-miR-155, hsa-miR-210 or hsa-miR-10a, hsa-miR-409 or hsa-miR-134, in said biological tissue determined in the previous stage as having a tumoral character,
v) comparison between:
the expression level of the abovementioned miRNA in the abovementioned tissue and
respectively the expression level of the abovementioned miRNA in a reference glioblastoma tissue, and
respectively the expression level of the abovementioned miRNA in a reference oligodendroglioma tissue, and
vi) the deduction:
either that the abovementioned tissue is a glioblastoma when the expression level of the abovementioned miRNA in the suspect tissue is equal, within a limit of 20% more or 20% less, to the expression level of the abovementioned miRNA in the reference glioblastoma tissue,
or that the abovementioned tissue is an oligodendroglioma when the expression level of the abovementioned miRNA in the suspect tissue is equal, within a limit of 20% more or 20% less, to the expression level of the abovementioned miRNA in the reference oligodendroglioma tissue.

In an advantageous embodiment, this method makes it possible to directly determine whether a glioblastoma or an oligodendroglioma is present in a patient suspected of having a glioma. It is no longer necessary to carry out a first stage relating to the determination of the presence of gliomas in the abovementioned patient. The implementation of this method requires 5 specific miRNAs identified in the invention, namely hsa-miR-155, hsa-miR-210, hsa-miR-10a, hsa-miR-409, and hsa-miR-134, the expression levels of which both differ widely between the samples originating from the patients having a glioma and the samples originating from a healthy individual, and are systematically higher in the samples originating from patients having a glioblastoma compared with those originating from patients having an oligodendroglioma.

This method is carried out in the following stages:

(i) measurement of the expression level of at least one miRNA chosen from hsa-miR-155, hsa-miR-210, hsa-miR-10a, hsa-miR-409 or hsa-miR-134, in a biological sample originating from a patient with a suspected glioma,

(ii) comparison between the expression level of the abovementioned miRNA in the abovementioned sample and
respectively the expression level of the abovementioned miRNA in a healthy reference sample, and
respectively the expression level of the abovementioned miRNA in a reference sample originating from a patient with a glioblastoma, and
respectively the expression level of the abovementioned miRNA in a reference sample originating from a patient with an oligodendroglioma,

(iii) the deduction:
either that the patient does not have a glioma when the expression level of the abovementioned miRNA in the sample originating from a patient with a suspected glioma is equal, within a limit of 20% more or 20% less, to the expression level of the above-mentioned miRNA in the healthy reference sample,
or that the patient has a glioblastoma,
   when the expression level of the abovementioned miRNA in the sample originating from a patient with a suspected glioma is equal, within a limit of 20% more or 20% less, to the expression level of the above-mentioned miRNA in the reference sample originating from a patient with a glioblastoma, and
   when the expression level of the abovementioned miRNA in the sample originating from a patient with a suspected glioma is at least 3 times greater than the expression level of the abovementioned miRNA in the reference sample originating from a patient with an oligodendroglioma,
or that the patient has an oligodendroglioma,
   when the expression level of the abovementioned miRNA in the sample originating from a patient with a suspected glioma is equal, within a limit of 20% more or 20% less, to the expression level of the above-mentioned miRNA in the reference sample originating from a patient with an oligodendroglioma, and
   when the expression level of the abovementioned miRNA in the sample originating from a patient with a suspected glioma is at least 3 times less than the expression level of the abovementioned miRNA in the reference sample originating from a patient with a glioblastoma.

In a particular embodiment of the invention, the biological sample originating from a patient with a suspected glioma is brain tissue obtained by excision, or by biopsy. Said method comprises:

(i) measurement of the expression level of at least one miRNA chosen from hsa-miR-155, hsa-miR-210, hsa-miR-10a, hsa-miR-409 or hsa-miR-134, in a biological tissue originating from a tissue suspected of having a tumoral character,

(ii) comparison between the expression level of the abovementioned miRNA in the abovementioned suspect tissue and
respectively the expression level of the abovementioned miRNA in a reference healthy tissue, and
respectively the expression level of the abovementioned miRNA in a reference glioblastoma tissue, and
respectively the expression level of the abovementioned miRNA in a reference oligodendroglioma tissue,

(iii) the deduction:
either that the abovementioned tissue is a healthy tissue when the expression level of the abovementioned miRNA in the suspect tissue is equal, within a limit of 20% more or 20% less, to the expression level of the abovementioned miRNA in the reference healthy tissue,
or that the abovementioned tissue is a glioblastoma,
   when the expression level of the abovementioned miRNA in the suspect tissue is equal, within a limit of 20% more or 20% less, to the expression level of the abovementioned miRNA in the reference glioblastoma tissue, and
   when the expression level of the abovementioned miRNA in the suspect tissue is at least 3 times greater than the expression level of the abovementioned miRNA in the reference oligodendroglioma tissue,
or that the abovementioned tissue is an oligodendroglioma,
   when the expression level of the abovementioned miRNA in the suspect tissue is equal, within a limit of 20% more or 20% less, to the expression level of the abovementioned miRNA in the reference oligodendroglioma tissue, and
   when the expression level of the abovementioned miRNA in the suspect tissue is at least 3 times less than the expression level of the abovementioned miRNA in the reference glioblastoma tissue.

Advantageously, the determination of the precise nature of a glial tumour suspected of being present in a patient is carried out in the following stages:

(i) measurement of the expression level of at least one miRNA chosen from hsa-miR-409 or hsa-miR-134, in a biological sample originating from a patient with a suspected glioma,

(ii) comparison between the expression level of the abovementioned miRNA in the abovementioned sample and
respectively the expression level of the abovementioned miRNA in a healthy reference sample, and
respectively the expression level of the abovementioned miRNA in a reference sample originating from a patient with a glioblastoma, and
respectively the expression level of the abovementioned miRNA in a reference sample originating from a patient with an oligodendroglioma,

(iii) the deduction:
either that the patient does not have a glioma when the expression level of the abovementioned miRNA in the sample originating from the abovementioned patient is equal, within a limit of 20% more or 20% less, to the expression level of the above-mentioned miRNA in the healthy reference sample,
or that the patient has a glioblastoma,
   when the expression level of the abovementioned miRNA in the sample originating from a patient with a suspected glioma is equal, within a limit of 20% more or 20% less, to the expression level of the above-mentioned miRNA in the reference sample originating from a patient with a glioblastoma, and
   when the expression level of the abovementioned miRNA in the sample originating from a patient with a suspected glioma is at least 3 times greater than the expression level of the abovementioned miRNA in the reference sample originating from a patient with an oligodendroglioma,
or that the patient has an oligodendroglioma,
   when the expression level of the abovementioned miRNA in the sample originating from a patient with a suspected glioma is equal, within a limit of 20% more or 20% less, to the expression level of the above-mentioned miRNA in the reference sample originating from a patient with an oligodendroglioma, and
   when the expression level of the abovementioned miRNA in the sample originating from a patient with a suspected glioma is at least 3 times less than the expression level of the abovementioned miRNA in the reference sample originating from a patient with a glioblastoma.

The second embodiment of the method for the in vitro diagnosis of glioma, making it possible to determine that a patient has a glioma and to determine the precise nature of the glioma, consists of intra-sample comparisons of expression levels of the miRNAs.

This method comprises
(i) measurement of at least one miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b*, hsa-miR-155, hsa-miR-210 or hsa-miR-10a, in a biological sample originating from a patient with a suspected glioma,
(ii) comparison between the expression level of at least one first abovementioned miRNA in the biological sample of the patient with a suspected glioma and the expression level of at least one second abovementioned miRNA in the biological sample of the suspected patient, the abovementioned first miRNA and second miRNA forming an miRNA pair, and
(iii) the deduction that the patient has a glioma when the ratio between the expression level of the abovementioned first miRNA and the expression level of the abovementioned second miRNA is twice, in particular 3 times, more particularly 4 times, greater or less than that of a pre-established chart in a healthy reference sample,
(iv) measurement of the ratio of the expression level of at least one miRNA pair constituted by:
   an miRNA chosen from hsa-miR-155, hsa-miR-210, hsa-miR-10a, hsa-miR-409 or hsa-miR-134, and
   an miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-339, hsa-miR-127, hsa-miR-151, hsa-miR-26b, hsa-miR-34b*
for a sample originating from the abovementioned patient,
said measurement making it possible to establish the ratio of the expression level for an abovementioned miRNA pair,
(v) comparison between:
   the abovementioned ratio of the expression level for an miRNA pair and,
   the ratio in a pre-established chart in a healthy reference sample, the reference sample originating from a patient with a glioblastoma, and the reference sample originating from a patient with an oligodendroglioma,
(vi) the deduction:
   either that the patient has a glioblastoma when the difference between the ratio obtained in stage (iv) and the ratio in a pre-established chart in a reference sample originating from a patient with a glioblastoma is less than 20%, in particular 15%, more particularly 10%, with respect to the ratio in a pre-established chart in a reference sample originating from a patient with a glioblastoma,
   or that the patient has an oligodendroglioma when the difference between the ratio obtained in stage (iv) and the ratio in a pre-established chart in a reference sample originating from a patient with an oligodendroglioma is less than 20%, in particular 15%, more particularly 10%, with respect to the ratio in a pre-established chart in a reference sample originating from a patient with an oligodendroglioma.

In a particular embodiment of the invention, the biological sample originating from a patient with a suspected glioma is brain tissue obtained by excision, or by biopsy. Said method comprises:
(i) measurement of at least one miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b*, hsa-miR-155, hsa-miR-210 or hsa-miR-10a, in a biological tissue originating from a tissue suspected of having a tumoral character,
(ii) comparison between the expression level of at least one first abovementioned miRNA in the suspect tissue and the expression level of at least one second abovementioned miRNA in the suspect tissue, the abovementioned first miRNA and second miRNA forming an miRNA pair, and
(iii) the deduction of the tumoral character of the suspect tissue when the ratio between the expression level of the abovementioned first miRNA and the expression level of the abovementioned second miRNA is twice, in particular 3 times, more particularly 4 times, greater or less than that of a pre-established chart in a reference healthy tissue,
(iv) measurement of the ratio of the expression level of at least one miRNA pair constituted by:
   an miRNA chosen from hsa-miR-155, hsa-miR-210, hsa-miR-10a, hsa-miR-409 or hsa-miR-134, and
   an miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-339, hsa-miR-127, hsa-miR-151, hsa-miR-26b, hsa-miR-34b*
for a biological tissue originating from a tumoral tissue suspected of being a glioblastoma tissue or an oligodendroglioma tissue,
said measurement making it possible to establish the ratio of the expression level for an abovementioned miRNA pair,
(v) comparison between:
   the abovementioned ratio of the expression level for an miRNA pair and,
   the ratio in a pre-established chart in a reference healthy tissue, a reference glioblastoma tissue, and a reference oligodendroglioma tissue,
(vi) the deduction:
   either that the suspect tissue is a glioblastoma when the difference between the ratio obtained in stage (iv) and the ratio in a pre-established chart in a reference glioblastoma tissue is less than 20%, in particular 15%, more particularly 10%, with respect to the ratio in a pre-established chart in a reference glioblastoma tissue.
   or that the suspect tissue is an oligodendroglioma when the difference between the ratio obtained in stage (iv) and the ratio in a pre-established chart in a reference oligodendroglioma tissue is less than 20%, in particular 15%, more particularly 10%, with respect to the ratio in a pre-established chart in a reference oligodendroglioma tissue.

In an advantageous embodiment, this method makes it possible to directly determine the precise nature of a tissue suspected of having a tumoral character, without the need to carry out a stage of determining the presence of gliomas in a suspect tissue. This method is carried out in the following stages:
(i) measurement of the ratio of the expression level of at least one miRNA pair chosen from hsa-let 7a/hsa-miR 409, hsa-let 7d/hsa-miR409, hsa-miR134/hsa-let 7f, hsa-let 7f/hsa-miR409, hsa-miR134/hsa-let 7d, hsa-miR151/hsa-miR155, hsa-miR155/hsa-miR-34b*, hsa-miR15b/hsa-miR134, hsa-miR134/hsa-miR20a, hsa-miR210/hsa-let 7f, (Table 7) in a biological sample originating from a patient with a suspected glioma,
(ii) comparison between:
   the abovementioned ratio of the expression level for an miRNA pair, and
   the ratio in a pre-established chart respectively in a healthy reference sample, the reference sample originating from a patient with a glioblastoma, and the reference sample originating from a patient with an oligodendroglioma,
(iii) the deduction:
   either that the patient does not have a glioma when the difference between the ratio obtained in stage (i) and the ratio in a pre-established chart in a healthy reference sample is less than 20%, in particular 15%, more particularly 10%, with respect to the ratio in a pre-established chart in a healthy reference sample.
   or that the patient has a glioblastoma when the difference between the ratio obtained in stage (i) and the ratio in a pre-established chart in a reference sample originating from a patient with a glioblastoma is less than 20%, in particular 15%, more particularly 10%, with respect to the ratio in a pre-established chart in a reference sample originating from a patient with a glioblastoma,
   or that the patient has an oligodendroglioma when the difference between the ratio obtained in stage (i) is the ratio in a pre-established chart in a reference sample originating from a patient with an oligodendroglioma is less than 20%, in particular 15%, more particularly 10%, with respect to the ratio in a pre-established chart in a reference sample originating from a patient with an oligodendroglioma.

In a particular embodiment of the invention, the biological sample originating from a patient with a suspected glioma is brain tissue obtained by excision, or by biopsy. Said method comprises:

(i) measurement of the ratio of the expression level of at least one miRNA pair chosen from hsa-let 7a/hsa-miR 409, hsa-let 7d/hsa-miR409, hsa-miR134/hsa-let 7f, hsa-let 7f/hsa-miR409, hsa-miR134/hsa-let 7d, hsa-miR151/hsa-miR155, hsa-miR155/hsa-miR-34b*, hsa-miR15b/hsa-miR134, hsa-miR134/hsa-miR20a, hsa-miR210/hsa-let 7f, (Table 7) in a biological tissue originating from a tissue suspected of having a tumoral character,

(ii) comparison between:
the abovementioned ratio of the expression level for an miRNA pair, and
the ratio in a pre-established chart in a reference healthy tissue, a reference glioblastoma tissue, and a reference oligodendroglioma tissue respectively

(iii) the deduction:
either that the abovementioned tissue is a healthy tissue when the difference between the ratio obtained in stage (i) and the ratio in a pre-established chart in a reference healthy tissue is less than 20%, in particular 15%, more particularly 10%, with respect to the ratio in a pre-established chart in a reference healthy tissue.
or that the abovementioned tissue is a glioblastoma tissue, when the difference between the ratio obtained in stage (i) and the ratio in a pre-established chart in a reference glioblastoma tissue is less than 20%, in particular 15%, more particularly 10%, with respect to the ratio in a pre-established chart in a reference glioblastoma tissue.
or that the abovementioned tissue is an oligodendroglioma tissue, when the difference between the ratio obtained in stage (i) is the ratio in a pre-established chart in a reference oligodendroglioma tissue is less than 20%, in particular 15%, more particularly 10%, with respect to the ratio in a pre-established chart in a reference oligodendroglioma tissue.

In an embodiment according to the invention, the expression level of the miRNAs is assayed by real-time PCR.

In another embodiment, the expression level of the miRNAs is assayed by “DNA chip” hybridization or by high-throughput sequencing, or by Northern blot.

In an embodiment according to the invention, a biological sample is chosen from a tissue sample, in particular brain tissue obtained by excision, or a sample of body fluid, in particular a blood sample.

The invention also relates to a kit for in vitro glioma diagnosis, this kit comprising means for assaying at least one miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b*, hsa-miR-155, hsa-miR-210 or hsa-miR-10a.

In a particular embodiment of the invention, this kit comprises means for assaying at least one miRNA chosen from hsa-miR-155, hsa-miR-210 or hsa-miR-10a, hsa-miR-134 or hsa-miR-409.

This kit for in vitro glioma diagnosis can comprise by way of example, Reverse Transcriptase, DNA polymerase, such as Hot Start, buffer, an RNase inhibitor, dNTPs, amplification primer oligonucleotides, specific probes, such as TaqMan° probe, or non-specific markers such as SYBR Green.

A subject of the invention is also a method for evaluating the effectiveness of a method for treating gliomas.

This method comprises:
measurement of the expression level of at least one miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b*, hsa-miR-155, hsa-miR-210 or hsa-miR-10a in a biological sample originating from a patient undergoing glioma treatment, and optionally
comparison between
   the expression level of the abovementioned miRNA in the biological sample originating from said patient, and
      respectively the expression level of the above-mentioned miRNA in a reference sample originating from a patient with a glioblastoma,
      and respectively the expression level of the above-mentioned miRNA in a reference sample originating from a patient with an oligodendroglioma.

In an advantageous embodiment, this method makes it possible to evaluate the effectiveness of a method for treating gliomas, for example, surgical intervention, chemotherapy or radiotherapy.

In a particularly advantageous embodiment, the invention relates to a method for the in vitro diagnosis of a brain tumour belonging to the group constituted by 2 types of tumours: ODG and GBM, and identification of the type of the tumour, comprising:

(i) measurement of the expression level of at least two miRNAs in a biological sample originating from a patient with a suspected glioma, in which:
a first miRNA is chosen from hsa-miR-155, hsa-miR-210, hsa-miR-10a, hsa-miR-409 or hsa-miR-134;
a second miRNA is chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b*, hsa-miR-155, hsa-miR-210 or hsa-miR-10a, said second chosen miRNA being different from the abovementioned first chosen miRNA;

(ii) comparison:
between the expression levels of the abovementioned miRNAs in the abovementioned sample and the expression levels of the abovementioned miRNAs in a healthy reference sample, a reference GBM sample and a reference ODG sample, or
between the expression level of at least one first abovementioned miRNA in the sample originating from a patient with a suspected glioma and the expression level of at least one second abovementioned miRNA in the same sample originating from the patient with a suspected glioma.

More particularly, this method comprises:

(i) measurement of the expression level in a biological sample originating from a patient with a suspected glioma,
of a first miRNA chosen from hsa-miR-155, hsa-miR-210, hsa-miR-10a, hsa-miR-409 or hsa-miR-134, and
of a second miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b*, hsa-miR-155, hsa-miR-210 or hsa-miR-10a, said second chosen miRNA being different from the abovementioned first chosen miRNA,

(ii) comparison between the expression levels of the abovementioned miRNAs in the abovementioned sample and the expression levels of the abovementioned miRNAs in a healthy reference sample, a reference GBM sample and a reference ODG sample.

In a particular embodiment, the deduction of the presence of GBM in the sample originating from the patient with a suspected glioma is made when:

(i) the expression level of the first miRNA measured in said sample is at least 3 times greater than or less than the expression level of the abovementioned miRNA measured in the healthy reference sample, and

(ii) the expression level of the first miRNA measured in said sample is at least 3 times greater than the expression level of the abovementioned miRNA measured in the reference ODG sample, and

(iii) the expression level of the second miRNA measured in said sample is at least 3 times greater than or less than the expression level of the abovementioned miRNA measured in the healthy reference sample, and

(iv) the expression level of the second miRNA measured in said sample is equal, within a limit of 20% more or 20% less, to the expression level of the above-mentioned miRNA in the reference GBM sample.

In another particular embodiment, the deduction of the presence of ODG in the sample originating from the patient with a suspected glioma is made when:

(i) the expression level of the first miRNA measured in said sample is at least 3 times greater than or less than the expression level of the abovementioned miRNA measured in the healthy reference sample, and

(ii) the expression level of the first miRNA measured in said sample is at least 3 times less than the expression level of the abovementioned miRNA measured in the reference GBM sample, and

(iii) the expression level of the second miRNA measured in said sample is at least 3 times greater than or less than the expression level of the abovementioned miRNA measured in the healthy reference sample, and

(iv) the expression level of the second miRNA measured in said sample is equal, within a limit of 20% more or 20% less, to the expression level of the above-mentioned miRNA in the reference ODG sample.

In an advantageous embodiment, the method for the in vitro diagnosis of a brain tumour belonging to the group constituted by 2 types of tumours: ODG and GBM, and identification of the type of the tumour according to the invention comprises the measurement:
of the first miRNA: hsa-miR-155, and
of the second miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b*, hsa-miR-210 or hsa-miR-10a.

In a particularly advantageous embodiment, the method for the in vitro diagnosis of a brain tumour belonging to the group constituted by 2 types of tumours: ODG and GBM, and identification of the type of the tumour according to the invention comprises the measurement:
of the first miRNA: hsa-miR-155, and
of the second miRNA chosen from hsa-miR-126, hsa-miR-15b, hsa-miR-16, hsa-miR-17, hsa-miR-20a, hsa-let 7f, hsa-miR-374, hsa-miR-409, hsa-miR-134, hsa-miR-339, hsa-miR-151, hsa-miR-26b, hsa-miR-34b* or hsa-miR-210.

More particularly, the method for the in vitro diagnosis according to the invention measures the first miRNA hsa-miR-155 and the second miRNA hsa-miR-126.

More particularly, the method for the in vitro diagnosis according to the invention measures the first miRNA hsa-miR-155 and the second miRNA hsa-miR-15b.

More particularly, the method for the in vitro diagnosis according to the invention measures the first miRNA hsa-miR-155 and the second miRNA hsa-miR-16.

More particularly, the method for the in vitro diagnosis according to the invention measures the first miRNA hsa-miR-155 and the second miRNA hsa-miR-17.

More particularly, the method for the in vitro diagnosis according to the invention measures the first miRNA hsa-miR-155 and the second miRNA hsa-miR-20a.

More particularly, the method for the in vitro diagnosis according to the invention measures the first miRNA hsa-miR-155 and the second miRNA hsa-let 7f.

More particularly, the method for the in vitro diagnosis according to the invention measures the first miRNA hsa-miR-155 and the second miRNA hsa-miR-374.

More particularly, the method for the in vitro diagnosis according to the invention measures the first miRNA hsa-miR-155 and the second miRNA hsa-miR-409.

More particularly, the method for the in vitro diagnosis according to the invention measures the first miRNA hsa-miR-155 and the second miRNA hsa-miR-134.

More particularly, the method for the in vitro diagnosis according to the invention measures the first miRNA hsa-miR-155 and the second miRNA hsa-miR-339.

More particularly, the method for the in vitro diagnosis according to the invention measures the first miRNA hsa-miR-155 and the second miRNA hsa-miR-151.

More particularly, the method for the in vitro diagnosis according to the invention measures the first miRNA hsa-miR-155 and the second miRNA hsa-miR-26b.

More particularly, the method for the in vitro diagnosis according to the invention measures the first miRNA hsa-miR-155 and the second miRNA hsa-miR-34b*.

More particularly, the method for the in vitro diagnosis according to the invention measures the first miRNA hsa-miR-155 and the second miRNA or hsa-miR-210.

In an advantageous embodiment, the method for the in vitro diagnosis of a brain tumour belonging to the group constituted by 2 types of tumours: ODG and GBM, and identification of the type of the tumour according to the invention comprises the measurement:
of the first miRNA: hsa-miR-210, and
of the second miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b*, hsa-miR-155 or hsa-miR-10a.

In a particularly advantageous embodiment, the method for the in vitro diagnosis according to the invention comprises the measurement:
of the first miRNA: hsa-miR-210, and
of the second miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-26b, hsa-miR-34b*, hsa-miR-155, or hsa-miR-10a.

More particularly, the method for the in vitro diagnosis according to the invention measures the first miRNA hsa-miR-210 and the second miRNA hsa-miR-126.

More particularly, the method for the in vitro diagnosis according to the invention measures the first miRNA hsa-miR-210 and the second miRNA hsa-miR-15b.

More particularly, the method for the in vitro diagnosis according to the invention measures the first miRNA hsa-miR-210 and the second miRNA hsa-miR-16.

More particularly, the method for the in vitro diagnosis according to the invention measures the first miRNA hsa-miR-210 and the second miRNA hsa-miR-17.

More particularly, the method for the in vitro diagnosis according to the invention measures the first miRNA hsa-miR-210 and the second miRNA hsa-miR-20a.

More particularly, the method for the in vitro diagnosis according to the invention measures the first miRNA hsa-miR-210 and the second miRNA hsa-let7a.

More particularly, the method for the in vitro diagnosis according to the invention measures the first miRNA hsa-miR-210 and the second miRNA hsa-let 7f.

More particularly, the method for the in vitro diagnosis according to the invention measures the first miRNA hsa-miR-210 and the second miRNA hsa-let 7d.

More particularly, the method for the in vitro diagnosis according to the invention measures the first miRNA hsa-miR-210 and the second miRNA hsa-miR-374.

More particularly, the method for the in vitro diagnosis according to the invention measures the first miRNA hsa-miR-210 and the second miRNA hsa-miR-409.

More particularly, the method for the in vitro diagnosis according to the invention measures the first miRNA hsa-miR-210 and the second miRNA hsa-miR-134.

More particularly, the method for the in vitro diagnosis according to the invention measures the first miRNA hsa-miR-210 and the second miRNA hsa-miR-339.

More particularly, the method for the in vitro diagnosis according to the invention measures the first miRNA hsa-miR-210 and the second hsa-miR-127.

More particularly, the method for the in vitro diagnosis according to the invention measures the first miRNA hsa-miR-210 and the second miRNA hsa-miR-26b.

More particularly, the method for the in vitro diagnosis according to the invention measures the first miRNA hsa-miR-210 and the second miRNA hsa-miR-34b*.

More particularly, the method for the in vitro diagnosis according to the invention measures the first miRNA hsa-miR-210 and the second miRNA hsa-miR-155.

More particularly, the method for the in vitro diagnosis according to the invention measures the first miRNA hsa-miR-210 and the second miRNA hsa-miR-10a.

In an advantageous embodiment, the method for the in vitro diagnosis of a brain tumour belonging to the group constituted by 2 types of tumours: ODG and GBM, and identification of the type of the tumour according to the invention comprises the measurement:
of the first miRNA: hsa-miR-10a; and
of the second miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b*, hsa-miR-210 or hsa-miR-155.

In a particularly advantageous embodiment, the method for the in vitro diagnosis according to the invention comprises the measurement:
of the first miRNA: hsa-miR-10a; and
the second miRNA chosen from hsa-miR-126, hsa-miR-15b, hsa-miR-16, hsa-miR-20a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b* or hsa-miR-210.

More particularly, the method for the in vitro diagnosis according to the invention measures the first hsa-miR-10a and the second miRNA hsa-miR-126.

More particularly, the method for the in vitro diagnosis according to the invention measures the first hsa-miR-10a and the second miRNA hsa-miR-15b.

More particularly, the method for the in vitro diagnosis according to the invention measures the first hsa-miR-10a and the second miRNA hsa-miR-16.

More particularly, the method for the in vitro diagnosis according to the invention measures the first hsa-miR-10a and the second miRNA hsa-miR-20a.

More particularly, the method for the in vitro diagnosis according to the invention measures the first hsa-miR-10a and the second hsa-let 7f.

More particularly, the method for the in vitro diagnosis according to the invention measures the first hsa-miR-10a and the second miRNA hsa-let 7d.

More particularly, the method for the in vitro diagnosis according to the invention measures the first hsa-miR-10a and the second miRNA hsa-miR-374.

More particularly, the method for the in vitro diagnosis according to the invention measures the first hsa-miR-10a and the second miRNA hsa-miR-409.

More particularly, the method for the in vitro diagnosis according to the invention measures the first hsa-miR-10a and the second miRNA hsa-miR-134.

More particularly, the method for the in vitro diagnosis according to the invention measures the first hsa-miR-10a and the second miRNA hsa-miR-339.

More particularly, the method for the in vitro diagnosis according to the invention measures the first hsa-miR-10a and the second miRNA hsa-miR-127.

More particularly, the method for the in vitro diagnosis according to the invention measures the first hsa-miR-10a and the second miRNA hsa-miR-151.

More particularly, the method for the in vitro diagnosis according to the invention measures the first hsa-miR-10a and the second miRNA hsa-miR-26b.

More particularly, the method for the in vitro diagnosis according to the invention measures the first hsa-miR-10a and the second miRNA hsa-miR-34b*.

More particularly, the method for the in vitro diagnosis according to the invention measures the first hsa-miR-10a and the second miRNA hsa-miR-210.

In an advantageous embodiment, the method for the in vitro diagnosis of a brain tumour belonging to the group constituted by 2 types of tumours: ODG and GBM, and identification of the type of the tumour according to the invention comprises the measurement:
of the first miRNA: hsa-miR-409; and
of the second miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-10a, hsa-miR-134, hsa-miR-339, hsa-miR-127, hsa-miR-151, hsa-miR-26b, hsa-miR-34b*, hsa-miR-210 or hsa-miR-155.

In a particularly advantageous embodiment, the method for the in vitro diagnosis according to the invention comprises the measurement:
of the first miRNA: hsa-miR-409; and
of the second miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-134, hsa-miR-127, hsa-miR-26b, hsa-miR-155, hsa-miR-210 or hsa-miR-10a.

More particularly, the method for the in vitro diagnosis according to the invention measures the first hsa-miR-409 and the second miRNA hsa-miR-126.

More particularly, the method for the in vitro diagnosis according to the invention measures the first hsa-miR-409 and the second miRNA hsa-miR-15b.

More particularly, the method for the in vitro diagnosis according to the invention measures the first hsa-miR-409 and the second miRNA hsa-miR-16.

More particularly, the method for the in vitro diagnosis according to the invention measures the first hsa-miR-409 and the second miRNA hsa-miR-17.

More particularly, the method for the in vitro diagnosis according to the invention measures the first hsa-miR-409 and the second miRNA hsa-miR-20a.

More particularly, the method for the in vitro diagnosis according to the invention measures the first hsa-miR-409 and the second miRNA hsa-let7a.

More particularly, the method for the in vitro diagnosis according to the invention measures the first hsa-miR-409 and the second miRNA hsa-let 7E

More particularly, the method for the in vitro diagnosis according to the invention measures the first hsa-miR-409 and the second miRNA hsa-let 7d.

More particularly, the method for the in vitro diagnosis according to the invention measures the first hsa-miR-409 and the second miRNA hsa-miR-374.

More particularly, the method for the in vitro diagnosis according to the invention measures the first hsa-miR-409 and the second miRNA hsa-miR-134.

More particularly, the method for the in vitro diagnosis according to the invention measures the first hsa-miR-409 and the second miRNA hsa-miR-127.

More particularly, the method for the in vitro diagnosis according to the invention measures the first hsa-miR-409 and the second miRNA hsa-miR-26b.

More particularly, the method for the in vitro diagnosis according to the invention measures the first hsa-miR-409 and the second miRNA hsa-miR-155.

More particularly, the method for the in vitro diagnosis according to the invention measures the first hsa-miR-409 and the second miRNA hsa-miR-210.

More particularly, the method for the in vitro diagnosis according to the invention measures the first hsa-miR-409 and the second miRNA hsa-miR-10a.

In an advantageous embodiment, the method for the in vitro diagnosis of a brain tumour belonging to the group constituted by 2 types of tumours: ODG and GBM, and identification of the type of the tumour according to the invention comprises the measurement:
of the first miRNA: hsa-miR-134;
of the second miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-339, hsa-miR-127, hsa-miR-151, hsa-miR-26b, hsa-miR-34b*, hsa-miR-155, hsa-miR-210 or hsa-miR-10a.

In a particularly advantageous embodiment, the method for the in vitro diagnosis of a brain tumour belonging to the group constituted by 2 types of tumours: ODG and GBM, and identification of the type of the tumour according to the invention comprises the measurement:
of the first miRNA: hsa-miR-134;
of the second miRNA chosen from hsa-miR-126, hsa-miR-15b, hsa-miR-17, hsa-miR-20a, hsa-let7a, hsa-let 7f, hsa-let 7d, hsa-miR-374, hsa-miR-409, hsa-miR-26b, hsa-miR-155, hsa-miR-210 or hsa-miR-10a.

More particularly, the method for the in vitro diagnosis according to the invention measures the first hsa-miR-134 and the second miRNA hsa-miR-126.

More particularly, the method for the in vitro diagnosis according to the invention measures the first hsa-miR-134 and the second miRNA hsa-miR-15b.

More particularly, the method for the in vitro diagnosis according to the invention measures the first hsa-miR-134 and the second miRNA hsa-miR-17.

More particularly, the method for the in vitro diagnosis according to the invention measures the first hsa-miR-134 and the second miRNA hsa-miR-20a.

More particularly, the method for the in vitro diagnosis according to the invention measures the first hsa-miR-134 and the second miRNA hsa-let7a.

More particularly, the method for the in vitro diagnosis according to the invention measures the first hsa-miR-134 and the second miRNA hsa-let 7E

More particularly, the method for the in vitro diagnosis according to the invention measures the first hsa-miR-134 and the second miRNA hsa-let 7d.

More particularly, the method for the in vitro diagnosis according to the invention measures the first hsa-miR-134 and the second miRNA hsa-miR-374.

More particularly, the method for the in vitro diagnosis according to the invention measures the first hsa-miR-134 and the second miRNA hsa-miR-409.

More particularly, the method for the in vitro diagnosis according to the invention measures the first hsa-miR-134 and the second miRNA hsa-miR-26b.

More particularly, the method for the in vitro diagnosis according to the invention measures the first hsa-miR-134 and the second miRNA hsa-miR-155.

More particularly, the method for the in vitro diagnosis according to the invention measures the first hsa-miR-134 and the second miRNA hsa-miR-210.

More particularly, the method for the in vitro diagnosis according to the invention measures the first hsa-miR-134 and the second hsa-miR-10a.

In another embodiment, the invention relates to a method for the in vitro diagnosis of a brain tumour belonging to the group constituted by 2 types of tumours: ODG and GBM, and identification of the type of the tumour, comprising:
(i) measurement of the expression level of at least two miRNA pairs in a biological sample originating from a patient with a suspected glioma,
   each abovementioned miRNA pair being formed by
      a first miRNA chosen from hsa-miR-155, hsa-miR-210, hsa-miR-10a, hsa-miR-409 or hsa-miR-134;
      a second miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b*, hsa-miR-155, hsa-miR-210 or hsa-miR-10a, said second chosen miRNA being different from the abovementioned first chosen miRNA, and
      said miRNA pairs being different from each other, said measurement making it possible to establish the ratios of the expression levels for the abovementioned miRNA pairs,
   (ii) comparison between:

the ratios of the expression levels of the abovementioned miRNA pairs, and

those represented in a pre-established chart for a healthy reference sample, a reference GBM sample and a reference ODG sample.

In an advantageous embodiment, the deduction of the presence of GBM in the sample originating from the patient with a suspected glioma is made when:
(i) the difference between the first ratio obtained in a sample originating from a patient with a suspected glioma and the ratio in a pre-established chart in a reference GBM sample is less than 20%, in particular 15%, more particularly 10%, with respect to the abovementioned first ratio in the pre-established chart, and
(ii) the difference between the second ratio obtained in a sample originating from a patient with a suspected glioma and the ratio in a pre-established chart in a reference GBM sample is less than 20%, in particular 15%, more particularly 10%, with respect to the abovementioned second ratio in the pre-established chart.

In another particular embodiment, the deduction of the presence of ODG in the sample originating from the patient with a suspected glioma is made when:

(i) the difference between the first ratio obtained in a sample originating from a patient with a suspected glioma and the ratio in a pre-established chart in a reference ODG sample is less than 20%, in particular 15%, more particularly 10%, with respect to the above-mentioned first ratio in the pre-established chart, and

(ii) the difference between the second ratio obtained in a sample originating from a patient with a suspected glioma and the ratio in a pre-established chart in a reference ODG sample is less than 20%, in particular 15%, more particularly 10%, with respect to the abovementioned second ratio in the pre-established chart.

According to a particularly advantageous embodiment, in the abovementioned method for the in vitro diagnosis of a brain tumour belonging to the group constituted by 2 types of tumours: ODG and GBM, and identification of the type of the tumour, the first miRNA pair is formed by a first miRNA: hsa-miR-155, and a second miRNA chosen from: hsa-miR-126, hsa-miR-15b, hsa-miR-16, hsa-miR-17, hsa-miR-20a, hsa-let 7f, hsa-miR-374, hsa-miR-409, hsa-miR-134, hsa-miR-339, hsa-miR-151, hsa-miR-26b, hsa-miR-34b* or hsa-miR-210.

According to a particularly advantageous embodiment, in the above-mentioned method, the first miRNA pair is formed by a first miRNA: hsa-miR-210, and a second miRNA chosen from: hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-26b, hsa-miR-34b*, hsa-miR-155, or hsa-miR-10 a.

According to a particularly advantageous embodiment, in the above-mentioned method, the first miRNA pair is formed by a first miRNA: hsa-miR-134, and a second miRNA chosen from: hsa-miR-126, hsa-miR-15b, hsa-miR-17, hsa-miR-20a, hsa-let7a, hsa-let 7f, hsa-let 7d, hsa-miR-374, hsa-miR-409, hsa-miR-26b, hsa-miR-155, hsa-miR-210 or hsa-miR-10a.

According to a particularly advantageous embodiment, in the above-mentioned method, the first miRNA pair is formed by a first miRNA: hsa-miR-409, and a second miRNA chosen from: hsa-miR-126, hsa-miR-15b, hsa-miR-16, hsa-miR-17, hsa-miR-20a, hsa-let7a, hsa-let 7f, hsa-let 7d, hsa-miR-374, hsa-miR-134, hsa-miR-127, hsa-miR-26b, hsa-miR-155, hsa-miR-210 or hsa-miR-10a.

According to a particularly advantageous embodiment, in the above-mentioned method, the first miRNA pair is formed by a first miRNA: hsa-miR-10a, and a second miRNA chosen from: hsa-miR-126, hsa-miR-15b, hsa-miR-16, hsa-miR-20a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b* or hsa-miR-210.

In a particularly advantageous embodiment, the first miRNA pair used in the abovementioned method is chosen from hsa-miR126/hsa-miR134, hsa-miR126/hsa-miR409, hsa-miR127/hsa-miR10a, hsa-miR134/hsa-let 7a, hsa-miR134/hsa-miR10a, hsa-miR151/hsa-miR10a, hsa-miR155/hsa-miR134, has-miR155/has-miR409, hsa-miR15b/hsa-miR409, hsa-miR16/hsa-miR-409, hsa-miR17/hsa-miR409, hsa-miR20a/hsa-miR409, hsa-miR210/hsa-let 7a, hsa-miR210/hsa-miR155, hsa-miR26b/hsa-miR134, hsa-miR26b/hsa-miR409, hsa-miR374/hsa-miR134, hsa-miR374/hsa-miR409, hsa-miR409/hsa-miR10a, hsa-miR10a/hsa let 7d, hsa-miR126/hsa-miR10a, hsa-miR126/hsa-miR155, hsa-miR134/hsa-miR17, hsa-miR134/hsa-miR409, hsa-miR155/hsa-miR339, hsa-miR15b/hsa-miR10a, hsa-miR15b/hsa-miR155, hsa-miR16/hsa-miR10a, hsa-miR16/hsa-miR155, hsa-miR20a/hsa-miR10a, hsa-miR210/hsa-miR127, hsa-miR210/hsa-miR134, hsa-miR210/hsa-miR339, hsa-miR210/hsa-miR409, hsa-miR26b/hsa-miR10a, hsa-miR26b/hsa-miR155, hsa-miR374/hsa-miR10a, hsa-miR10a/hsa-miR210, hsa-miR10a/hsa-miR339, hsa-miR10a/hsa-miR-34b*, hsa-miR155/hsa let 7f, hsa-miR16/hsa-miR210, hsa-miR210/hsa let 7d, hsa-miR210/hsa-miR126, hsa-miR210/hsa-miR15b, hsa-miR210/hsa-miR17, hsa-miR210/hsa-miR20a, hsa-miR210/hsa-miR374, hsa-miR26b/hsa-miR210, hsa-miR127/hsa-miR409, hsa-miR210/hsa-miR-34b*, hsa-let 7f/hsa-miR10a, hsa-miR155/hsa-miR17, hsa-miR155/hsa-miR374, hsa-miR20a/hsa-miR155, hsa-let 7a/hsa-miR 409, hsa-let 7d/hsa-miR409, hsa-miR134/hsa-let 7f, hsa-let 7f/hsa-miR409, hsa-miR134/hsa-let 7d, hsa-miR151/hsa-miR155, hsa-miR155/hsa-miR-34b*, hsa-miR15b/hsa-miR134, hsa-miR134/hsa-miR20a, hsa-miR210/hsa-let 7f.

In another particularly advantageous embodiment, the second miRNA pair used in the abovementioned method is chosen from: hsa-miR127/hsa-miR409, hsa-miR210/hsa-miR-34b*, hsa-let 7f/hsa-miR10a, hsa-miR155/hsa-miR17, hsa-miR155/hsa-miR374, hsa-let 7a/hsa-miR 409, hsa-let 7d/hsa-miR409, hsa-miR134/hsa-let 7f, hsa-let 7f/hsa-miR409, hsa-miR134/hsa-let 7d, hsa-miR151/hsa-miR155, hsa-miR155/hsa-miR-34b*, hsa-miR15b/hsa-miR134, hsa-miR134/hsa-miR20a, hsa-miR210/hsa-let 7f, hsa-miR20a/has-miR155.

According to a particularly advantageous embodiment, in the abovementioned method for the in vitro diagnosis of a brain tumour belonging to the group constituted by 2 types of tumours: ODG and GBM, and identification of the type of the tumour, the first miRNA pair is hsa-miR155/hsa-miR-34b*, the second miRNA pair is hsa-let 7a/hsa-miR 409.

According to a particularly advantageous embodiment, in the above-mentioned method, the first miRNA pair is hsa-miR151/hsa-miR155, the second miRNA pair is hsa-miR155/hsa-miR-34b*.

According to a particularly advantageous embodiment, in the above-mentioned method, the first miRNA pair is hsa-let 7d/hsa-miR409, the second miRNA pair is hsa-miR134/hsa-miR20a.

According to a particularly advantageous embodiment, in the above-mentioned method, the first miRNA pair is hsa-let 7a/hsa-miR 409, the second miRNA pair is hsa-miR134/hsa-let 7f.

An advantageous embodiment of the invention relates to an in vitro diagnosis method comprising measurement of three miRNA pairs in a reference healthy tissue, a reference ODG tissue and a reference GBM tissue respectively.

In a particular embodiment, the three miRNA pairs chosen in this method are miR155/miR-34b*, miR134/miR20 and miR26b/miR134.

The present invention is illustrated by the figures and the following examples.

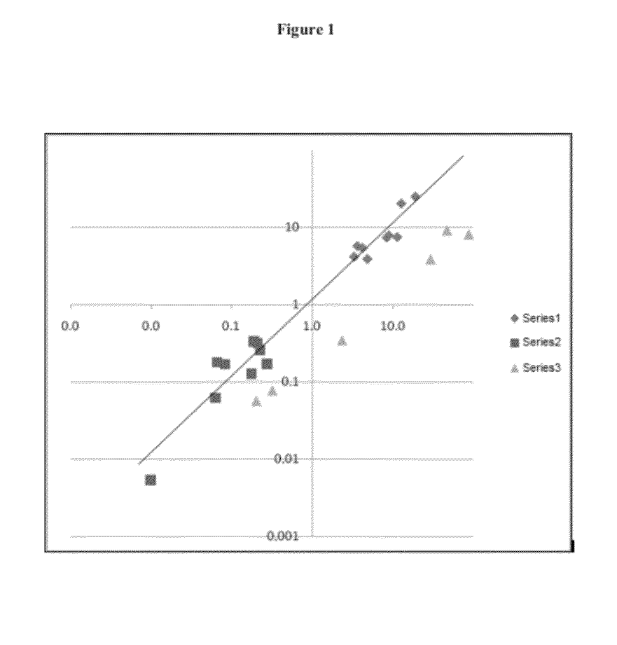

FIG. 1: FIG. 1 illustrates the categories of microRNA overexpressed in the gliomas with respect to the healthy tissue (diamond symbols); the microRNA underexpressed in the gliomas with respect to the healthy tissue (squares); and the microRNA overexpressed in the glioblastomas (GBM) compared with the oligodendrogliomas (ODG) (triangles). The y-axis represents the values of the ratios of the quantities of each miRNA in the oligodendrogliomas compared with the quantity of these miRNAs in the healthy tissue (ODG/N). The x-axis represents the values of the ratios of the quantities of each miRNA in the glioblastomas compared with the quantity of these miRNAs in the healthy tissue (GBM/N).

FIG. 2: FIG. 2 illustrates clustering making it possible to distinguish GBM, ODG and healthy tissues on the basis of the 12 ratios present in Tables 4, 5, 6, 7 respectively. The values of the ratios for 4 healthy tissue samples, 3 oligodendrogliomas and 4 glioblastomas make it possible to sort the tissues into three very distinct and coherent groups in terms of tissue identity (dendrogram at the top of the cluster-software MeV-Multiexperiment viewer v4.4-TM4 software suite MeV team—http://www.TM4.org).

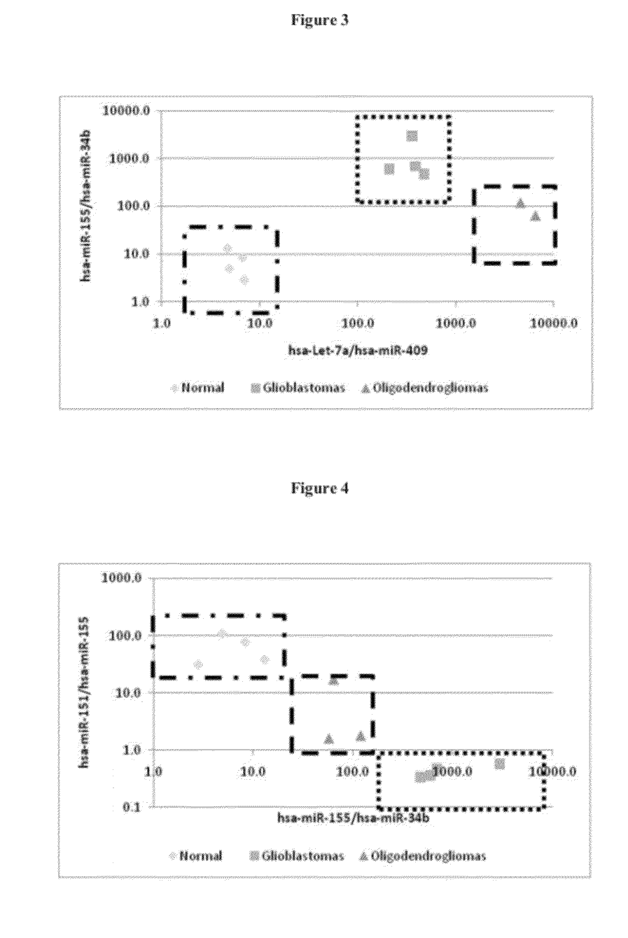

FIG. 3: FIG. 3 illustrates the identification of normal tissues (diamond symbols in the rectangle drawn with dashed-dotted lines), glioblastomas (square symbols in the rectangle drawn with dotted lines) and oligodendrogliomas (triangle symbols in the rectangle drawn with dashed lines), by assay of 4 miRNAs (let 7a, miR409, miR155 and miR-34b*), and on the basis of the values of the ratios let7a/miR409 and miR155/miR-34b*.

FIG. 4: FIG. 4 illustrates the identification of normal tissues (diamond symbols in the rectangle), glioblastomas (square symbols in the rectangle drawn with dotted lines) and oligodendrogliomas (triangle symbols in the rectangle drawn with dashed lines), by assay of 3 miRNAs (miR155, miR-34b* and miR151), and on the basis of the values of the ratios miR155/miR-34b* and miR151/miR155.

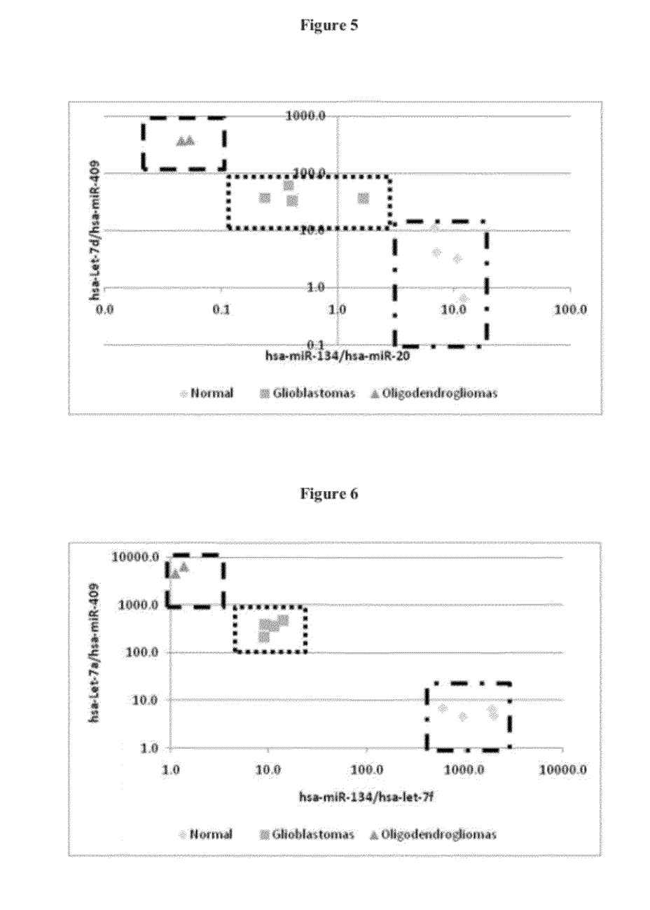

FIG. 5: FIG. 5 illustrates the identification of normal tissues (diamond symbols in the rectangle drawn with dashed-dotted lines), glioblastomas (square symbols in the rectangle drawn with dotted lines) and oligodendrogliomas (triangle symbols in the rectangle drawn with dashed lines), by assay of 4 miRNAs (let 7d, miR409, miR134 and miR20), and on the basis of the values of the ratios let7d/miR409 and miR134/miR20.

FIG. 6: FIG. 6 illustrates the identification of normal tissues (diamond symbols in the rectangle drawn with dashed-dotted lines), glioblastomas (square symbols in the rectangle drawn with dotted lines) and oligodendrogliomas (triangle symbols in the rectangle drawn with dashed lines), by assay of 4 miRNAs (let 7a, miR409, miR134 and let-7f), and on the basis of the values of the ratios let7a/miR409 and miR134/let-7f.

FIG. 7: FIG. 7 illustrates the values of the ratios miR155/miR-34b* (series 1), miR134/miR20 (series 2) and miR26b/miR134 (series 3), expressed as a percentage (stacked bars 100%). These values make it possible to visually distinguish the oligodendrogliomas (lines 9-11), normal tissues (lines 5-8), and glioblastomas (lines 1-4).

### EXAMPLES

### Example 1

### Materials and Methods

The Tissue Samples

The tumoral samples (8 glioblastomas and 4 oligodendrogliomas) as well as the healthy tissue samples (corticectomies) are obtained after excision by neurosurgeons in the operating theatre and are immediately frozen at −80° C. Tissue sections with a thickness of approximately 40 nm are then made using a cryotome, sufficient in number to obtain approximately 80 mg of tissue and stored at −80° C. until the RNA is extracted.

The Body Fluids

For the purification of the microRNAs circulating in the blood, blood samples are taken from patients using PAXGene Blood RNA-type collection tubes (PreAnalytix-Qiagen—BD company). Total lysis of the circulating cells is carried out and the RNAs are collected by centrifugation and purified according to the supplier's instructions.

As regards the fractions of microRNA contained in the microvesicles produced by the tumours and present in the blood, the method used is directly based on that described by Skog et al. (2008).

The microvesicles are purified from the serums by centrifugations and microfiltration. The serums are centrifuged for a first time for 10 min at 300 g, then the supernatants are centrifuged for 20 min at 17,000 g and filtered on 0.22 micron filters. The microvesicles are obtained by ultracentrifugation of the filtrate at 110,000 g for 70 min. The pellet is finally resuspended in phosphate tampon (PBS) and the RNAs are extracted according to the protocol described below.

The Extraction of the RNAs

The RNAs are extracted using the hsa-miRVana™ kit (Ambion, ABI) making it possible to separate the long RNAs (size>250 nt) from the short RNAs (size<250 nt) by following the supplier's recommendations. The tissue is firstly lysed, the RNAs are then precipitated after addition of sodium acetate and ethanol, extracted in the presence of a phenol/chloroform mixture, separated according to their size on a chromatography column, then eluted. The eluted RNAs are then quantified by measuring the OD at 260 nm using the Nanodrop ND-1000 spectrophotometer and quality control of these RNAs is carried out by electrophoretic migration in a polymer gel on the BioAnalyser 2100 using the RNA 6000 nano LabChip® (Agilent) kit.

The Assay of the miRNAs by Real-Time PCR

The expression of miRNAs is quantified by PCR quantitative technique using the kits distributed by Applied Biosystems, specific to the mature miRNAs. In a first phase, 80 ng of short RNAs are reverse-transcribed (into single-strand cDNA) in the presence of loop primers, which confer the specificity for the quantification of the expression of the mature miRNAs. Real-time PCR is then carried out using the primers supplied in the kits. One of the primers comprises fluorescent groups (so-called Taqman® probe) which makes it possible to carry out a quantitative measurement using a suitable fluorimeter such as the Stratagene Mx3005 system. The detection threshold is determined in a first phase by the user at the start of the exponential phase. The Ct value corresponds to the number of cycles from which the fluorescence exceeds this detection threshold. This Ct value is proportional to the quantity of cDNA initially present in the sample. In the absence of a set of reference standards specific to each cDNA, only a relative quantification between samples is possible. The assay values for each miRNA are normalized with respect to the data obtained for a non-coding RNA, RNU24.

Interpretation of the Results

A level of aberrant expression of an miRNA in a tested tissue can be a indicator of the tumoral character of said tissue. In order to determine whether a expression level of a tested miRNA is normal, a comparison can be made either between the suspected tissue and the reference tissues (inter-tissue comparison), or between the expression level of the abovementioned miRNA and the expression level of another miRNA in the same tissue (intra-tissue comparison).

The inter-tissue comparison of the expression level of an miRNA X in tissue A and tissue B is expressed by the ratio_{(sample A/sample B)}, calculated according to Formula (V): Ratio_{(sample A/sample B)}=Effectiveness^{-((Ct hsa-miRNAX-Ct RNU24)sample A-(Ct hsa-miRNAX-Ct RNU24)sample B)}.

The intra-tissue comparison between the expression level of an miRNA X and that of an miRNA Y is expressed by the ratio_{(hsa-miRNA X/hsa-miRNA Y)}, calculated according to Formula (VI): Ratio_{(hsa-miRNA X/hsa-miRNA Y)}=Effectiveness^{-(Ct hsa-miRNA X-Ct hsa-miRNA Y)}.

### Example 2

### Comparison of the Expression Levels of the miRNAs in the Tissues of Glial Tumours and in the Normal Reference Tissues

The nature of the tissues used in the present example is confirmed beforehand by histological analysis.

The expression levels of 282 miRNAs in glioblastoma tissues, oligodendroglioma tissues and healthy reference tissues are quantified respectively by real-time PCR by the method described in Example 1.

Among 282 miRNAs tested, the expression of 19 miRNAs is modified in the glioblastomas and in the oligodendrogliomas, compared with that in healthy tissue.

Table 3 below shows respectively: inter-tissue comparisons for the 19 miRNAs carried out between the reference glioblastomas (GBM) and the healthy reference tissues (N), expressed by the ratio_{(GMB/N)}; comparisons between the reference oligodendrogliomas (ODG) and the healthy reference tissues (N), expressed by the ratio_{(ODG/N)}; and comparisons between the reference glioblastomas (GBM) and the reference oligodendrogliomas (ODG), expressed by the ratio_{(GMB/ODG)}.

TABLE 3

| | GBM/N | ODG/N | GBM/ODG |
|---|---|---|---|
| 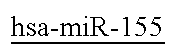 | 34.46 | 4.27 | 8.07 |
| hsa-miR-210 | 2.35 | 0.29 | 8.1 |
| 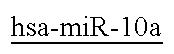 | 47.00 | 9.20 | 5.1 |
| hsa-miR-134 | 0.20 | 0.06 | 3.63 |
| hsa-miR-409 | 0.321 | 0.065 | 4.94 |
| 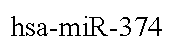 | 7.76 | 7.35 | 1.06 |
| 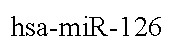 | 4.84 | 3.90 | 1.24 |
| 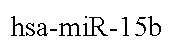 | 3.31 | 4.16 | 0.80 |
| 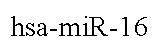 | 11.43 | 6.31 | 1.81 |
| 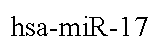 | 12.87 | 20.32 | 0.63 |
| 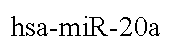 | 3.63 | 5.73 | 0.63 |
| 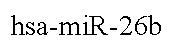 | 8.95 | 7.86 | 1.14 |
| 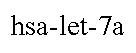 | 19.25 | 24.92 | 0.77 |
| 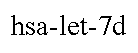 | 4.19 | 4.57 | 0.92 |
| 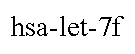 | 23.18 | 32.46 | 0.71 |
| hsa-miR-34b* | 0.21 | 0.32 | 0.67 |
| hsa-miR-127 | 0.06 | 0.05 | 1.21 |
| hsa-miR-151 | 0.23 | 0.26 | 0.89 |
| hsa-miR-339 | 0.07 | 0.18 | 0.39 |

12 miRNAs, highlighted in grey in Table 3, are overexpressed in the GBMs and the ODGs.

6 other miRNAs, without any highlighting in Table 3, are underexpressed in the GBMs and the ODGs.

An exception is hsa-miR-210, highlighted in bold in Table 3, which is overexpressed in the GBMs, but underexpressed in the ODGs.

Among these 19 miRNAs identified in the invention because of their modified expression profile in the tissues of gliomas compared with normal tissues, 5 miRNAs, namely hsa-miR-155, hsa-miR-210, hsa-miR-10a, hsa-miR-134, hsa-miR-409, also exhibit a distinct expression profile between the glioblastomas and the oligodendrogliomas. These 5 miRNAs are underlined in Table 3.

### Example 3

### Intra-Tissue Comparisons of the Expression Levels of the miRNAs

The nature of the tissues used in the present example is confirmed beforehand by histological analysis.

The comparison is carried out between the expression levels of 2 miRNAs (miRNA X and miRNA Y) originating from the same tissue. The result of this comparison is expressed in the form of a ratio, which is calculated according to Formula (VI). Tables 4, 5, 6, 7 below show the ratio_{(hsa-miRNA X/hsa-miRNA Y)} obtained in a reference glioblastoma tissue (GBM), a reference oligodendroglioma tissue (ODG), or a reference healthy tissue (N) respectively. The miRNA pairs are selected on the basis of p-values less than 0.05. (The p-value indicates the significance of each miRNA pair (miRNA X and miRNA Y) for distinctions between categories of tissues. A p-value less than 0.05 is significant).

TABLE 4

| miRNA pair | Ratio in N | Ratio in GBM | Ratio in ODG |
|---|---|---|---|
| hsa-let 7a/hsa-miR127 | 0.04 | 13.39 | 26.93 |
| hsa-let 7a/hsa-miR15b | 1.00 | 6.57 | 5.58 |
| hsa-let 7a/hsa-miR-34b* | 11.77 | 1108.71 | 5664.24 |
| hsa-let 7d/hsa-miR-34b* | 8.32 | 137.03 | 341.47 |
| hsa-miR126/hsa-let 7a | 7.02 | 2.30 | 2.08 |
| hsa-miR126/hsa-miR134 | 0.32 | 8.48 | 39.09 |
| hsa-miR126/hsa-miR339 | 2.37 | 948.81 | 283.44 |
| hsa-miR126/hsa-miR-34b* | 92.64 | 2446.73 | 1047.16 |
| hsa-miR126/hsa-miR409 | 38.66 | 699.88 | 6908.75 |
| hsa-miR127/hsa-let 7d | 68.45 | 1.09 | 0.99 |
| hsa-miR127/hsa-let 7f | 2065.79 | 9.19 | 6.29 |
| hsa-miR127/hsa-miR10a | 10839.87 | 28.13 | 72.27 |
| hsa-miR127/hsa-miR15b | 30.35 | 1.04 | 1.31 |
| hsa-miR127/hsa-miR-17 | 405.56 | 2.82 | 2.95 |
| hsa-miR134/hsa-let 7a | 21.26 | 0.21 | 0.08 |
| hsa-miR134/hsa-miR10a | 9255.37 | 31.37 | 31.47 |
| hsa-miR151/hsa-let 7a | 35.92 | 0.56 | 0.53 |
| hsa-miR151/hsa-let 7d | 181.76 | 5.35 | 4.57 |
| hsa-miR151/hsa-let 7f | 2941.11 | 25.08 | 14.37 |
| hsa-miR151/hsa-miR10a | 21981.20 | 78.57 | 333.08 |
| hsa-miR151/hsa-miR126 | 6.28 | 0.30 | 0.39 |
| hsa-miR151/hsa-miR15b | 42.05 | 2.42 | 2.62 |
| hsa-miR151/hsa-miR20a | 19.14 | 1.94 | 0.75 |
| hsa-miR151/hsa-miR374 | 73.06 | 2.11 | 1.72 |
| hsa-miR155/hsa-miR127 | 0.02 | 21.72 | 9.02 |
| hsa-miR155/hsa-miR134 | 0.03 | 4.95 | 4.62 |
| has-miR155/has-miR409 | 3.68 | 412.41 | 798.39 |
| hsa-miR15b/hsa-let 7f | 78.80 | 9.77 | 8.62 |
| hsa-miR15b/hsa-miR339 | 0.38 | 94.27 | 16.51 |
| hsa-miR15b/hsa-miR409 | 6.94 | 74.86 | 638.97 |
| hsa-miR16/hsa-miR127 | 1.24 | 409.04 | 529.94 |
| hsa-miR16/hsa-miR134 | 1.76 | 111.42 | 327.36 |
| hsa-miR16/hsa-miR151 | 1.31 | 67.29 | 33.17 |
| hsa-miR16/hsa-miR339 | 12.38 | 16977.61 | 1904.10 |
| hsa-miR16/hsa-miR-34b* | 489.53 | 34822.63 | 20260.67 |
| hsa-miR16/hsa-miR-409 | 211.30 | 9357.42 | 50575.30 |
| hsa-miR17/hsa-miR339 | 0.04 | 47.85 | 8.30 |
| hsa-miR17/hsa-miR-34b* | 1.40 | 106.08 | 185.81 |
| hsa-miR17/hsa-miR409 | 0.76 | 27.18 | 250.77 |
| hsa-miR20a/hsa-let 7a | 2.53 | 0.59 | 0.60 |
| hsa-miR20a/hsa-let 7f | 141.24 | 28.07 | 21.61 |
| hsa-miR20a/hsa-miR127 | 0.08 | 6.21 | 16.98 |
| hsa-miR20a/hsa-miR339 | 0.78 | 308.04 | 58.84 |
| hsa-miR20a/hsa-miR-34b* | 32.41 | 783.28 | 1528.75 |
| hsa-miR20a/hsa-miR409 | 13.92 | 188.77 | 1844.61 |
| hsa-miR210/hsa-let 7a | 14.30 | 2.24 | 0.31 |
| hsa-miR210/hsa-miR155 | 27.01 | 2.90 | 3.84 |
| hsa-miR26b/hsa-let 7f | 379.42 | 148.58 | 83.66 |
| hsa-miR26b/hsa-miR-127 | 0.20 | 54.39 | 103.49 |
| hsa-miR26b/hsa-miR134 | 0.31 | 13.96 | 59.85 |
| hsa-miR26b/hsa-miR151 | 0.23 | 8.54 | 5.76 |
| hsa-miR26b/hsa-miR-339 | 2.01 | 1777.46 | 375.39 |
| hsa-miR26b/hsa-miR-34b* | 73.80 | 3751.16 | 2921.07 |
| hsa-miR26b/hsa-miR409 | 36.68 | 1151.30 | 9627.57 |
| hsa-miR339/hsa-let 7a | 3.44 | 0.06 | 0.05 |
| hsa-miR339/hsa-let 7d | 8.08 | 0.41 | 0.25 |
| hsa-miR339/hsa-let 7f | 225.84 | 2.49 | 1.56 |
| hsa-miR-34b*/hsa-let 7f | 6.74 | 0.06 | 0.08 |
| hsa-miR374/hsa-let 7f | 41.18 | 15.54 | 8.72 |
| hsa-miR374/hsa-miR127 | 0.02 | 5.64 | 10.35 |
| hsa-miR374/hsa-miR134 | 0.04 | 1.37 | 6.35 |
| hsa-miR374/hsa-miR339 | 0.24 | 227.47 | 37.20 |
| hsa-miR374/hsa-miR-34b* | 9.42 | 374.55 | 387.50 |
| hsa-miR374/hsa-miR409 | 4.57 | 114.05 | 985.51 |
| hsa-miR409/hsa-miR10a | 78.10 | 0.48 | 0.40 |

The miRNA pairs in Table 4 make it possible to show that the suspected tissue is a tumoral tissue when the ratio of the expression level between the two miRNAs in a pair is different from the abovementioned ratio established in a reference healthy tissue.

TABLE 5

| miRNA pair | Ratio in N | Ratio in GBM | Ratio in ODG |
|---|---|---|---|
| hsa-let 7d/hsa let 7f | 39.38 | 7.44 | 5.17 |
| hsa-miR10a/hsa let 7d | 0.01 | 0.19 | 0.02 |
| hsa-miR126/hsa let 7f | 409.60 | 86.77 | 52.65 |
| hsa-miR126/hsa-miR10a | 3309.62 | 212.01 | 1322.35 |
| hsa-miR126/hsa-miR155 | 11.23 | 2.56 | 14.01 |
| hsa-miR127/hsa-miR126 | 6.28 | 0.18 | 0.25 |
| hsa-miR134/hsa-miR17 | 308.44 | 5.14 | 0.92 |
| hsa-miR134/hsa-miR409 | 117.50 | 76.90 | 105.39 |
| hsa-miR151/hsa-miR17 | 786.64 | 12.17 | 5.49 |
| hsa-miR155/hsa-miR339 | 0.23 | 658.78 | 33.40 |
| hsa-miR15b/hsa-miR10a | 480.59 | 28.27 | 216.27 |
| hsa-miR15b/hsa-miR155 | 2.49 | 0.26 | 12.60 |
| hsa-miR15b/hsa-miR-34b* | 17.58 | 237.79 | 813.26 |
| hsa-miR16/hsa-miR10a | 16307.76 | 2830.58 | 11326.64 |
| hsa-miR16/hsa-miR126 | 5.72 | 13.65 | 14.07 |
| hsa-miR16/hsa-miR155 | 63.55 | 27.68 | 301.21 |
| hsa-miR16/hsa-miR15b | 33.54 | 118.49 | 74.32 |
| hsa-miR16/hsa-miR20a | 15.54 | 66.32 | 21.88 |
| hsa-miR16/hsa-let 7f | 2208 | 1195 | 450 |
| hsa-miR16/hsa-miR374 | 54 | 80 | 52 |
| hsa-miR17/hsa let 7d | 0.18 | 0.66 | 0.74 |
| hsa-miR20a/hsa-miR10a | 973.95 | 63.63 | 520.31 |
| hsa-miR210/hsa-miR127 | 0.47 | 41.36 | 11.83 |
| hsa-miR210/hsa-miR134 | 0.76 | 11.49 | 6.43 |
| hsa-miR210/hsa-miR339 | 4.34 | 577.38 | 42.97 |
| hsa-miR210/hsa-miR409 | 85.51 | 825.50 | 1082.17 |
| hsa-miR26b/hsa let 7a | 6.38 | 3.46 | 3.02 |
| hsa-miR26b/hsa-miR10a | 2395.15 | 423.06 | 2043.29 |
| hsa-miR26b/hsa-miR155 | 11.10 | 3.44 | 42.63 |
| hsa-miR26b/hsa-miR15b | 5.92 | 14.88 | 14.85 |
| hsa-miR374/hsa-miR10a | 260.02 | 47.05 | 219.75 |
| hsa-miR10a/hsa-miR210 | 0.00 | 0.02 | 0.01 |
| hsa-miR10a/hsa-miR339 | 0.00 | 4.79 | 0.11 |
| hsa-miR10a/hsa-miR-34b* | 0.05 | 30.18 | 2.24 |
| hsa-miR155/hsa let 7f | 41.80 | 53.26 | 6.99 |
| hsa-miR16/hsa let 7a | 38.15 | 28.63 | 14.98 |
| hsa-miR16/hsa-miR210 | 3.45 | 41.60 | 60.43 |
| hsa-miR210/hsa let 7d | 40.01 | 20.29 | 3.03 |
| hsa-miR210/hsa-miR126 | 2.72 | 2.30 | 0.21 |
| hsa-miR210/hsa-miR15b | 14.39 | 13.77 | 1.53 |
| hsa-miR210/hsa-miR17 | 207.54 | 67.24 | 3.14 |
| hsa-miR210/hsa-miR20a | 6.74 | 10.76 | 0.43 |
| hsa-miR210/hsa-miR374 | 22.64 | 13.26 | 0.92 |
| hsa-miR26b/hsa-miR210 | 0.52 | 4.13 | 10.62 |

The miRNA pairs in Table 5 can show that the suspected tissue is one of the two types of tumoral tissue, when the ratio of the expression level between the two miRNAs in a pair is different from the abovementioned ratio established in a reference healthy tissue.

TABLE 6

| miRNA pair | Ratio in N | Ratio in GBM | Ratio in ODG |
|---|---|---|---|
| hsa-miR127/hsa-miR409 | 205.31 | 46.96 | 159.82 |
| hsa-miR210/hsa-miR-34b* | 147.47 | 1752.14 | 268.48 |
| hsa-let 7f/hsa-miR10a | 6.57 | 2.81 | 21.53 |
| hsa-miR155/hsa-miR17 | 10.56 | 26.58 | 2.85 |
| hsa-miR155/hsa-miR374 | 1.05 | 4.62 | 0.83 |
| Hsa-miR20a/hsa-miR155 | 4.34 | 0.74 | 23.47 |

The miRNA pairs in Table 6 make it possible to distinguish a glioblastoma from an oligodendroglioma when the tumoral character of a suspected tissue is already confirmed by a method described in the present invention, or a conventional method.

TABLE 7

| miRNA pair | Ratio in N | Ratio in GBM | Ratio in ODG |
|---|---|---|---|
| hsa-let 7a/hsa-miR 409 | 5.77 | 356.43 | 3726.97 |
| hsa-let 7d/hsa-miR409 | 4.75 | 41.99 | 275.42 |
| hsa-miR134/hsa-let 7f | 1067.08 | 10.55 | 1.58 |
| hsa-let 7f/hsa-miR409 | 0.11 | 7.47 | 81.66 |
| hsa-miR134/hsa-let 7d | 62.34 | 2.01 | 0.43 |
| hsa-miR151/hsa-miR155 | 62.89 | 0.44 | 6.93 |
| hsa-miR155/hsa-miR-34b* | 7.27 | 1186.37 | 80.50 |
| hsa-miR15b/hsa-miR134 | 0.06 | 0.93 | 5.98 |
| hsa-miR134/hsa-miR20a | 8.61 | 0.40 | 0.07 |
| hsa-miR210/hsa-let 7f | 944.34 | 129.36 | 8.61 |

The miRNA pairs in Table 7 above make it possible to directly specify the nature of a tissue suspected of having a tumoral character and distinguish whether it is a glioblastoma or an oligodendroglioma, without needing to carry out a stage of determination of the presence of gliomas in this suspected tissue.

FIGS. 3 to 6 illustrate that 3 groups of different kinds of samples, including healthy tissues, glioblastoma tissues, or oligodendroglioma tissues, are distinguished on a two-dimensional graph established using two miRNA pairs.

FIG. 7 shows that 3 groups of different kinds of samples, including healthy tissues, glioblastoma tissues, or oligodendroglioma tissues, are clearly differentiated on a three-dimensional graph established using three miRNA pairs.

Table 8 below shows the pairs of ratios of microRNAs which can be used for tumour diagnosis.

Based on Tables 5, 6 and 7—which list ratios between the 19 miRNAs forming part of the invention, which ratios have the potential to distinguish between the types of tissues—all of the pairs of ratios have been created and listed in Table 8. 1753 pairs of different ratios are obtained, identified according to the following representation: miRA/miRB|miRC/miRD (i.e. the pair associating the ratio of the miRA and miRB with the ratio of the miRC and miRD).

These pairs of ratios make it possible to produce a projection on a two-dimensional graph of the values measured in each tissue to be analyzed or each reference tissue according to the following principle, and by way of example:

The values of the ratios miRA/miRB are plotted on the x-axis of the graph and the values of the ratios miRC/miRD are plotted on the y-axis.

It is understood that for these pairs of ratios, their representations, and their diagnostic significance remain unchanged whether the ratios or their inverses are used (for example miRA/miRB or miRB/miRA) and whether one of the ratios is plotted on the x-axis and the second on the y-axis or vice versa.

Examples of these representations are shown in FIGS. 3 to 6.

Based on the complete listing (Table 8), it is possible to evaluate the performance of these different pairs of ratios for a diagnostic approach, proceeding as follows:

The ratios are calculated for a batch of glioblastoma tissue sample and the average of the value of each ratio is calculated for this sample batch.

The ratios are calculated for a batch of oligodendroglioma tissue sample and the average of the value of each ratio is calculated for this sample batch.

The ratios are calculated for a batch of healthy tissue sample and the average of the value of each ratio is calculated for this sample batch.

For the first ratio of microRNAs, the ratio (A) between the value of the ratio measured in each individual glioblastoma tissue sample and the average value of this ratio for the healthy samples is calculated.

The ratio (B) between the value of the ratio measured in each individual glioblastoma tissue sample and the average value of this ratio for the oligodendroglioma tissue samples is calculated.

The ratio (C) between the value of the ratio measured in each individual healthy tissue sample and the average value of this ratio for the oligodendroglioma tissue samples is calculated.

For the second ratio of microRNAs, the ratio (W) between the value of the ratio measured in each individual glioblastoma tissue sample and the average value of this ratio for the healthy samples is calculated.

The ratio (X) between the value of the ratio measured in each individual glioblastoma tissue sample and the average value of this ratio for the oligodendroglioma tissue samples is calculated.

The ratio (Y) between the value of the ratio measured in each individual healthy tissue sample and the average value of this ratio for the oligodendroglioma tissue samples is calculated.

Then the pairs of ratios are selected, for which the values of the ratios A, B, C, W, X and Y for all the samples are always greater than a threshold value, for example 40, or always less than a threshold value, for example 0.025. In this example, the pairs of ratios which correspond to these criteria are 11 in number. They are shown underlined in Table 8.

The pairs of ratios for which the values of the ratios A, B, C, W, X and Y are greater than the greatest possible threshold values or less than the lowest possible threshold values are best capable of allowing a graphic distinction between the healthy tissue samples, glioblastoma tissues and oligodendroglioma tissues.

TABLE 8

| | | |
|---|---|---|
| miR15b/miR134\|miR134/Let7f | miR26b/miR155\|miR210/Let7f | miR210/miR134\|miR210/miR127 |
| miR15b/miR134\|miR134/Let7d | miR210/Let7d\|miR151/miR17 | miR15b/miR34b\|Let7f/miR10a |
| miR15b/miR134\|miR134/miR20a | miR16/miR210\|miR16/miR20a | miR20a/miR155\|miR127/miR126 |
| miR134/miR20a\|Let7a/miR409 | miR26b/miR210\|miR26b/miR15b | miR210/miR339\|miR126/miR155 |
| miR134/miR17\|Let7a/miR409 | miR210/miR34b\|miR151/miR17 | miR210/miR409\|miR155/Let7f |
| miR134/miR20a\|Let7f/miR409 | miR20a/miR155\|miR16/miR15b | miR16/miR126\|miR15b/miR34b |
| miR134/Let7f\|Let7a/miR409 | miR20a/miR10a\|miR16/miR126 | miR155/Let7f\|miR134/miR409 |
| miR134/Let7d\|Let7f/miR409 | miR26b/miR155\|miR134/miR409 | miR210/miR339\|Let7f/miR10a |
| miR134/Let7f\|Let7d/miR409 | miR15b/miR134\|Let7d/miR409 | miR26b/miR155\|Let7a/miR409 |
| miR134/miR17\|Let7f/miR409 | miR26b/miR210\|miR210/miR20a | miR210/miR126\|miR127/miR126 |
| miR134/Let7f\|Let7f/miR409 | miR26b/Let7a\|miR127/miR409 | miR210/miR409\|miR127/miR409 |
| miR210/Let7f\|Let7a/miR409 | miR16/miR126\|miR155/Let7f | miR15b/miR34b\|Let7a/miR409 |
| miR210/Let7f\|Let7f/miR409 | miR16/miR155\|miR126/Let7f | miR210/miR409\|miR17/Let7d |
| miR15b/miR134\|miR126/miR10a | miR15b/miR34b\|miR134/miR409 | miR151/miR155\|miR127/miR409 |
| miR10a/miR339\|Let7d/miR10a | miR210/miR374\|miR134/miR17 | miR210/miR339\|Let7a/miR409 |
| miR17/Let7d\|miR16/miR126 | miR210/miR126\|miR16/miR15b | miR210/miR409\|Let7d/miR10a |
| miR15b/miR134\|miR151/miR17 | miR26b/Let7a\|miR17/Let7d | miR16/Let7a\|miR155/miR17 |
| miR26b/miR210\|miR16/miR126 | miR210/miR339\|miR210/Let7f | miR16/miR374\|miR155/Let7f |
| miR210/miR134\|miR16/miR126 | miR26b/miR210\|miR126/miR155 | miR210/miR17\|miR15b/miR10a |
| miR210/miR127\|miR16/miR126 | miR16/miR126\|miR127/miR409 | miR134/miR17\|miR126/Let7f |
| miR15b/miR134\|miR126/Let7f | miR210/miR134\|miR134/miR20a | miR26b/miR155\|miR210/miR339 |
| miR15b/miR134\|miR134/miR17 | miR210/miR339\|miR134/miR409 | miR26b/miR210\|miR155/miR339 |
| miR17/Let7d\|miR126/miR10a | miR210/Let7f\|miR16/miR126 | miR210/miR409\|miR151/miR155 |
| miR10a/miR339\|Let7d/Let7f | miR26b/Let7a\|Let7d/miR10a | miR210/miR374\|miR16/miR15b |
| miR15b/miR134\|miR15b/miR10a | miR16/miR155\|miR134/miR17 | miR26b/Let7a\|miR16/miR155 |
| miR20a/miR155\|miR16/miR126 | miR26b/miR210\|Let7f/miR10a | miR210/miR20a\|miR155/miR34b |
| miR210/miR126\|miR16/miR126 | miR374/miR10a\|miR126/miR10a | miR210/miR134\|miR15b/miR155 |
| miR26b/miR210\|miR126/miR10a | miR15b/miR155\|miR134/miR20a | miR16/miR374\|miR127/miR409 |
| miR17/Let7d\|miR16/Let7f | miR26b/Let7a\|miR151/miR155 | miR151/miR155\|Let7d/miR10a |
| miR155/miR339\|miR126/miR10a | miR20a/miR155\|miR155/miR17 | miR26b/miR15b\|miR155/miR34b |
| miR10a/miR339\|Let7f/miR10a | miR16/miR126\|Let7d/miR10a | miR26b/miR155\|miR15b/miR34b |
| miR10a/miR339\|Let7a/miR409 | miR134/miR409\|miR134/Let7f | miR210/miR15b\|miR16/miR210 |
| miR16/miR210\|miR16/miR126 | miR155/miR339\|miR126/miR155 | miR210/miR34b\|miR210/Let7f |
| miR26b/miR210\|miR26b/miR10a | Let7d/miR409\|Let7d/Let7f | miR210/miR134\|Let7d/miR409 |
| miR17/Let7d\|miR151/miR17 | miR210/Let7d\|miR134/Let7f | miR210/Let7d\|miR134/miR409 |
| miR26b/miR210\|miR16/Let7f | miR210/miR134\|Let7d/Let7f | miR26b/miR15b\|miR210/miR20a |
| miR210/miR134\|miR126/miR10a | miR17/Let7d\|miR16/miR155 | miR126/miR155\|Let7f/miR10a |
| miR15b/miR155\|miR126/miR10a | miR16/miR126\|miR151/miR155 | miR16/miR374\|Let7d/miR10a |
| miR17/Let7d\|miR134/Let7f | miR155/miR339\|Let7f/miR10a | miR210/miR34b\|miR134/miR409 |
| miR10a/miR34b\|Let7d/miR10a | miR210/miR34b\|miR134/Let7f | miR155/Let7f\|miR127/miR409 |
| miR210/miR127\|miR126/miR10a | miR26b/Let7a\|miR210/miR409 | miR210/miR20a\|miR126/miR155 |
| miR26b/miR210\|miR151/miR17 | miR26b/miR210\|Let7a/miR409 | miR210/miR126\|miR210/Let7d |
| miR155/miR339\|miR151/miR17 | miR210/miR126\|miR155/miR17 | miR16/miR210\|miR155/miR374 |
| miR26b/Let7a\|miR16/miR126 | miR16/Let7a\|miR15b/miR10a | miR210/miR339\|miR15b/miR34b |
| miR16/miR126\|miR16/miR126 | miR26b/miR155\|miR155/Let7f | miR15b/miR155\|Let7d/miR409 |
| miR210/miR134\|miR16/Let7f | miR15b/miR155\|Let7d/Let7f | miR16/miR374\|miR151/miR155 |
| miR26b/miR210\|miR134/Let7f | miR15b/miR34b\|miR155/Let7f | miR127/miR409\|Let7d/miR10a |
| miR155/miR339\|miR134/Let7f | miR20a/miR155\|miR16/Let7a | miR26b/miR15b\|miR126/miR155 |
| miR26b/miR155\|miR16/miR126 | miR210/miR409\|miR20a/miR155 | Let7f/miR10a\|Let7a/miR409 |
| miR210/miR339\|miR16/miR126 | miR26b/miR155\|miR127/miR409 | miR155/miR374\|miR127/miR126 |
| miR210/miR127\|miR16/Let7f | miR155/miR339\|Let7a/miR409 | miR210/miR374\|miR155/miR17 |
| miR210/miR134\|miR151/miR17 | miR15b/miR34b\|miR127/miR409 | miR210/miR20a\|Let7f/miR10a |
| miR15b/miR134\|miR134/miR409 | miR210/miR339\|miR155/Let7f | miR210/Let7f\|miR20a/miR155 |
| miR15b/miR155\|miR151/miR17 | miR210/miR126\|miR16/Let7a | miR155/miR34b\|miR126/miR155 |
| miR210/miR134\|miR134/Let7f | miR26b/miR155\|miR17/Let7d | miR134/miR20a\|Let7d/Let7f |
| miR210/miR20a\|miR16/miR126 | miR26b/miR210\|miR210/miR339 | miR26b/miR15b\|Let7f/miR10a |
| miR20a/miR155\|miR126/miR10a | miR210/miR127\|miR134/miR20a | miR126/miR155\|Let7a/miR409 |
| miR26b/miR210\|miR20a/miR155 | miR26b/miR155\|Let7d/miR10a | miR155/Let7f\|Let7d/miR10a |
| miR15b/miR134\|miR155/Let7f | miR210/miR339\|miR127/miR409 | miR155/miR34b\|Let7f/miR10a |
| miR15b/miR155\|miR134/Let7f | miR134/miR20a\|miR134/Let7d | miR16/miR210\|miR127/miR126 |
| miR26b/miR15b\|miR16/miR126 | miR210/miR20a\|miR210/Let7f | miR16/miR155\|miR155/miR17 |
| miR210/miR127\|miR151/miR17 | miR15b/miR34b\|Let7d/miR10a | miR26b/miR10a\|miR16/Let7f |
| miR210/miR126\|miR126/miR10a | miR26b/miR15b\|miR210/miR34b | miR155/Let7f\|miR151/miR155 |
| miR15b/miR134\|miR127/miR409 | miR26b/miR210\|miR15b/miR34b | miR210/miR20a\|Let7a/miR409 |
| miR17/Let7d\|miR126/Let7f | miR210/miR20a\|miR134/miR409 | miR210/miR374\|miR16/Let7a |
| miR15b/miR134\|Let7d/miR10a | miR26b/miR155\|miR151/miR155 | miR26b/miR155\|miR16/miR155 |
| miR15b/miR134\|miR151/miR155 | miR26b/miR15b\|miR210/Let7f | miR151/miR17\|miR134/Let7f |
| miR17/Let7d\|miR134/miR17 | miR210/miR339\|miR17/Let7d | miR26b/miR15b\|Let7a/miR409 |
| miR127/miR126\|miR126/miR10a | miR16/miR210\|miR16/miR15b | miR210/miR127\|miR15b/miR155 |
| miR210/miR127\|miR134/Let7f | miR26b/miR210\|miR26b/miR155 | miR155/miR34b\|Let7a/miR409 |
| miR155/miR374\|miR126/miR10a | miR210/miR374\|miR15b/miR10a | miR210/Let7d\|miR155/Let7f |
| miR16/miR210\|miR126/miR10a | miR15b/miR34b\|miR151/miR155 | miR210/miR34b\|miR155/Let7f |
| miR20a/miR155\|miR16/Let7f | miR15b/miR134\|miR155/miR339 | miR26b/miR155\|miR26b/Let7a |
| miR210/miR134\|miR20a/miR155 | miR26b/miR15b\|miR134/miR409 | miR16/miR155\|miR16/Let7a |
| miR210/miR126\|miR16/Let7f | miR16/miR15b\|miR126/Let7f | miR134/miR409\|miR127/miR409 |
| miR26b/miR210\|miR126/Let7f | miR210/miR339\|Let7d/miR10a | miR210/miR339\|miR16/miR155 |
| miR17/Let7d\|miR15b/miR10a | miR155/miR34b\|miR134/miR409 | miR210/miR127\|Let7d/miR409 |
| miR155/miR339\|miR126/Let7f | miR374/miR10a\|miR26b/miR10a | miR210/Let7d\|miR127/miR409 |
| miR26b/miR210\|miR134/miR17 | miR210/miR127\|Let7d/Let7f | miR210/miR34b\|miR127/miR409 |
| miR155/miR339\|miR134/miR17 | miR26b/miR155\|miR210/miR409 | miR16/Let7f\|miR151/miR17 |
| Let7f/miR409\|Let7d/miR10a | miR16/miR155\|miR15b/miR10a | miR26b/miR15b\|miR210/miR339 |
| miR210/miR127\|miR20a/miR155 | miR210/miR339\|miR151/miR155 | miR210/Let7d\|miR17/Let7d |
| miR20a/miR155\|miR151/miR17 | miR210/miR134\|miR155/miR34b | miR134/miR409\|Let7d/miR10a |
| miR210/miR126\|miR151/miR17 | miR155/miR374\|miR155/miR17 | miR210/miR34b\|miR17/Let7d |
| miR16/miR210\|miR16/Let7f | miR210/miR374\|miR210/miR17 | miR210/miR20a\|miR15b/miR34b |
| miR16/miR20a\|miR16/miR126 | miR16/miR15b\|miR134/miR17 | miR210/miR409\|miR16/miR20a |
| miR26b/Let7a\|miR126/miR10a | miR15b/miR155\|miR155/miR34b | miR210/Let7d\|Let7d/miR10a |
| miR210/miR15b\|miR16/miR126 | miR210/miR17\|miR126/miR10a | miR210/miR34b\|Let7d/miR10a |
| miR26b/miR210\|miR15b/miR10a | miR16/miR210\|miR155/miR17 | miR26b/miR15b\|miR15b/miR34b |
| miR20a/miR155\|miR134/Let7f | miR26b/Let7a\|miR16/miR20a | miR26b/miR210\|miR20a/miR10a |
| miR16/miR126\|miR126/miR10a | miR20a/miR155\|miR16/miR210 | miR210/Let7d\|miR151/miR155 |
| miR210/miR134\|miR126/Let7f | miR210/miR134\|miR126/miR155 | miR26b/miR15b\|miR26b/miR155 |
| miR210/miR126\|miR134/Let7f | miR26b/miR210\|miR16/miR155 | miR16/miR15b\|miR16/miR15b |
| miR26b/miR210\|miR210/miR17 | miR374/miR10a\|miR16/Let7f | miR210/miR34b\|miR151/miR155 |
| miR15b/miR155\|miR126/Let7f | miR210/miR20a\|miR155/Let7f | miR210/miR134\|miR155/miR339 |
| miR155/miR374\|miR151/miR17 | miR210/miR134\|Let7f/miR10a | miR15b/miR155\|miR155/miR339 |
| miR210/miR134\|miR134/miR17 | miR15b/miR155\|miR126/miR155 | miR26b/miR10a\|miR151/miR17 |
| miR10a/miR339\|Let7d/miR409 | miR15b/miR10a\|miR126/miR10a | miR374/miR10a\|miR134/Let7d |
| miR15b/miR134\|miR155/miR17 | miR26b/miR15b\|miR155/Let7f | miR134/miR20a\|miR126/miR155 |
| miR15b/miR155\|miR134/miR17 | miR210/miR126\|miR16/miR210 | miR210/miR374\|miR210/miR15b |
| miR16/miR210\|miR151/miR17 | Let7f/miR10a\|Let7d/miR10a | miR16/miR374\|miR16/miR20a |
| miR26b/miR155\|miR126/miR10a | Let7f/miR409\|Let7d/miR409 | miR210/miR374\|miR16/miR210 |
| miR15b/miR34b\|miR126/miR10a | miR155/miR34b\|miR155/Let7f | Let7d/Let7f\|Let7a/miR409 |
| miR10a/miR34b\|Let7d/Let7f | miR26b/miR210\|miR26b/Let7a | miR16/Let7f\|miR134/Let7f |
| miR210/miR339\|miR126/miR10a | miR16/miR210\|miR16/Let7a | miR16/miR20a\|miR134/miR20a |
| miR210/miR127\|miR126/Let7f | miR210/miR20a\|miR127/miR409 | miR210/miR15b\|miR134/miR20a |
| miR155/miR374\|miR134/Let7f | miR15b/miR155\|Let7f/miR10a | miR20a/miR10a\|miR126/Let7f |
| miR16/miR210\|miR134/Let7f | miR126/miR155\|Let7d/miR10a | miR134/miR20a\|Let7f/miR10a |
| miR210/miR127\|miR134/miR17 | miR26b/miR15b\|miR127/miR409 | miR16/miR15b\|miR155/miR17 |
| miR26b/Let7a\|miR16/Let7f | Let7d/miR409\|Let7a/miR409 | miR210/miR20a\|miR16/miR155 |
| miR210/miR374\|miR16/miR126 | miR210/miR20a\|miR17/Let7d | miR26b/Let7a\|miR16/miR374 |
| miR210/miR134\|miR15b/miR10a | miR155/miR34b\|miR127/miR409 | miR26b/miR15b\|miR16/miR155 |
| miR16/miR126\|miR16/Let7f | miR210/miR134\|Let7a/miR409 | miR20a/miR10a\|miR134/miR17 |
| miR15b/miR155\|miR15b/miR10a | miR26b/miR15b\|miR17/Let7d | miR210/Let7f\|miR126/Let7f |
| miR126/miR155\|miR126/miR10a | miR210/miR20a\|Let7d/miR10a | miR210/miR10a\|miR126/miR10a |
| miR20a/miR155\|miR20a/miR155 | miR210/Let7d\|miR20a/miR155 | miR16/miR20a\|Let7d/Let7f |
| miR16/miR155\|miR16/miR126 | miR210/miR127\|miR155/miR34b | miR26b/Let7a\|miR155/miR374 |
| miR26b/miR155\|miR26b/miR10a | miR210/miR34b\|miR20a/miR155 | miR210/miR15b\|Let7d/Let7f |
| miR17/Let7d\|miR134/Let7d | miR15b/miR155\|Let7a/miR409 | miR26b/miR15b\|miR26b/Let7a |
| miR210/miR20a\|miR126/miR10a | miR26b/miR15b\|Let7d/miR10a | miR16/miR15b\|miR16/Let7a |
| miR210/miR126\|miR20a/miR155 | miR210/miR20a\|miR151/miR155 | miR26b/miR10a\|miR134/Let7f |
| miR26b/miR15b\|miR126/miR10a | miR155/miR34b\|Let7d/miR10a | miR210/miR127\|miR155/miR339 |
| miR155/miR34b\|miR126/miR10a | miR210/miR409\|miR126/Let7f | miR16/miR126\|miR155/miR374 |
| miR10a/miR34b\|Let7f/miR10a | miR26b/miR15b\|miR151/miR155 | miR210/Let7f\|miR134/miR17 |
| miR26b/miR155\|miR16/Let7f | miR155/miR34b\|miR151/miR155 | miR26b/Let7a\|miR127/miR126 |
| miR210/miR127\|miR15b/miR10a | miR26b/miR155\|miR16/miR20a | miR134/Let7d\|miR127/miR409 |
| miR26b/Let7a\|miR151/miR17 | miR17/Let7d\|miR16/miR374 | miR210/miR409\|miR16/miR15b |
| miR10a/miR34b\|Let7a/miR409 | miR210/miR127\|miR126/miR155 | miR16/miR126\|miR127/miR126 |
| miR210/miR339\|miR16/Let7f | miR151/miR155\|miR126/Let7f | miR134/Let7d\|Let7d/miR10a |
| miR16/miR126\|miR151/miR17 | miR26b/miR15b\|miR210/miR409 | miR26b/miR155\|miR16/miR374 |
| miR26b/miR15b\|miR26b/miR10a | miR16/miR15b\|miR15b/miR10a | miR210/miR409\|miR210/miR374 |
| miR16/miR15b\|miR16/miR126 | miR210/miR409\|miR134/miR17 | miR210/Let7d\|miR16/miR20a |
| miR26b/Let7a\|miR134/Let7f | miR17/Let7d\|miR155/miR374 | miR210/miR34b\|miR16/miR20a |
| miR26b/miR210\|miR134/Let7d | miR210/miR134\|miR15b/miR34b | miR16/Let7a\|miR134/miR20a |
| miR26b/miR155\|miR151/miR17 | miR210/miR127\|Let7f/miR10a | miR26b/miR155\|miR155/miR374 |
| miR16/miR126\|miR134/Let7f | miR16/miR20a\|miR134/Let7d | miR15b/miR34b\|miR155/miR374 |
| miR15b/miR34b\|miR151/miR17 | miR210/miR15b\|miR134/Let7d | miR210/miR17\|miR134/Let7d |
| miR134/miR20a\|miR126/miR10a | miR210/miR339\|miR16/miR20a | miR210/miR134\|miR20a/miR10a |
| miR17/Let7d\|miR134/miR409 | miR374/miR10a\|miR151/miR17 | miR210/miR339\|miR16/miR374 |
| miR155/miR339\|miR134/Let7d | miR16/miR374\|miR126/Let7f | miR16/miR374\|miR16/miR15b |
| miR210/miR20a\|miR16/Let7f | miR151/miR155\|miR134/miR17 | miR26b/Let7a\|miR210/miR126 |
| miR20a/miR155\|miR126/Let7f | miR16/miR210\|miR16/miR210 | miR374/miR10a\|miR210/miR34b |
| miR210/miR339\|miR151/miR17 | miR210/miR127\|Let7a/miR409 | miR210/miR409\|miR155/miR17 |
| miR26b/miR15b\|miR16/Let7f | miR26b/Let7a\|miR16/miR15b | miR16/miR20a\|miR155/miR34b |
| miR210/miR126\|miR126/Let7f | miR127/miR409\|miR126/Let7f | miR210/miR15b\|miR155/miR34b |
| miR20a/miR155\|miR134/miR17 | miR17/Let7d\|miR127/miR126 | miR374/miR10a\|miR210/Let7f |
| miR210/miR126\|miR134/miR17 | miR134/miR17\|miR126/miR10a | miR155/miR17\|miR134/miR20a |
| miR26b/miR155\|miR134/Let7f | miR210/miR17\|miR16/Let7f | miR16/Let7a\|Let7d/Let7f |
| miR15b/miR134\|Let7d/Let7f | miR16/miR374\|miR134/miR17 | miR374/miR10a\|miR134/miR409 |
| miR15b/miR34b\|miR134/Let7f | miR155/Let7f\|miR126/Let7f | miR210/miR339\|miR155/miR374 |
| miR17/Let7d\|miR155/Let7f | miR26b/Let7a\|miR210/miR374 | miR26b/Let7a\|miR210/Let7d |
| miR210/miR339\|miR134/Let7f | miR134/miR20a\|miR127/miR409 | miR20a/miR10a\|miR15b/miR10a |
| miR210/miR409\|miR16/miR126 | miR210/miR134\|miR16/miR155 | miR20a/miR155\|miR15b/miR155 |
| miR127/miR126\|miR126/Let7f | miR20a/miR155\|miR134/miR20a | miR15b/miR134\|miR10a/miR34b |
| miR17/Let7d\|miR127/miR409 | miR155/Let7f\|miR134/miR17 | miR26b/miR155\|miR127/miR126 |
| miR17/Let7d\|miR17/Let7d | miR374/miR10a\|miR134/Let7f | miR15b/miR10a\|miR134/Let7d |
| miR17/Let7d\|Let7d/miR10a | miR26b/Let7a\|miR155/miR17 | miR15b/miR34b\|miR127/miR126 |
| miR210/miR20a\|miR151/miR17 | miR210/miR127\|miR15b/miR34b | miR210/miR409\|miR16/Let7a |
| miR155/miR374\|miR126/Let7f | miR210/miR126\|miR134/miR20a | miR16/miR20a\|miR126/miR155 |
| miR26b/miR210\|miR210/miR34b | miR134/miR20a\|Let7d/miR10a | miR210/miR15b\|miR126/miR155 |
| miR26b/miR15b\|miR151/miR17 | miR16/miR126\|miR155/miR17 | miR210/miR126\|miR15b/miR155 |
| miR26b/miR210\|miR210/Let7f | miR210/miR20a\|miR16/miR20a | miR210/miR374\|miR134/miR20a |
| miR17/Let7d\|miR151/miR155 | miR20a/miR155\|Let7d/Let7f | miR20a/miR155\|Let7d/miR409 |
| miR155/miR34b\|miR151/miR17 | miR16/Let7a\|miR134/Let7d | miR155/miR17\|Let7d/Let7f |
| miR16/miR374\|miR16/miR126 | miR26b/miR15b\|miR16/miR20a | miR210/miR339\|miR127/miR126 |
| miR26b/miR210\|miR134/miR409 | miR26b/miR10a\|miR16/miR126 | miR16/miR374\|miR155/miR17 |
| miR16/miR210\|miR126/Let7f | miR26b/miR155\|miR16/miR15b | miR16/miR20a\|Let7f/miR10a |
| miR210/miR134\|miR134/Let7d | miR26b/miR210\|miR16/miR374 | miR210/Let7f\|miR15b/miR10a |
| miR155/miR374\|miR134/miR17 | miR26b/Let7a\|miR16/Let7a | miR210/miR15b\|Let7f/miR10a |
| miR26b/Let7a\|miR20a/miR155 | miR210/miR409\|miR15b/miR10a | miR134/Let7f\|miR126/Let7f |
| miR20a/miR155\|miR15b/miR10a | miR134/miR409\|miR126/Let7f | miR16/miR155\|miR134/miR20a |
| miR15b/miR134\|miR155/miR34b | miR210/Let7d\|miR126/Let7f | miR210/miR126\|Let7d/miR409 |
| miR15b/miR155\|miR134/Let7d | miR210/miR126\|Let7d/Let7f | miR210/miR10a\|miR16/Let7f |
| miR155/miR339\|miR134/miR409 | miR210/miR34b\|miR126/Let7f | miR210/miR374\|Let7d/Let7f |
| miR16/miR210\|miR134/miR17 | miR16/miR126\|miR16/Let7a | miR16/miR20a\|Let7a/miR409 |
| miR16/miR20a\|miR126/miR10a | miR26b/miR210\|miR155/miR374 | miR16/miR374\|miR16/Let7a |
| miR210/miR126\|miR15b/miR10a | miR26b/miR155\|miR210/miR374 | miR210/miR15b\|Let7a/miR409 |
| miR210/miR15b\|miR126/miR10a | miR155/miR17\|miR134/Let7d | miR26b/miR155\|miR210/miR126 |
| miR210/miR20a\|miR134/Let7f | miR210/miR339\|miR16/miR15b | miR374/miR10a\|miR155/Let7f |
| miR15b/miR134\|miR126/miR155 | miR134/miR409\|miR134/miR17 | miR210/miR127\|miR20a/miR10a |
| miR26b/miR15b\|miR134/Let7f | miR210/miR409\|miR210/miR17 | miR210/miR20a\|miR16/miR374 |
| miR155/miR34b\|miR134/Let7f | miR210/miR17\|miR151/miR17 | miR16/miR155\|Let7d/Let7f |
| miR15b/miR134\|Let7f/miR10a | miR210/miR15b\|miR210/Let7f | miR374/miR10a\|miR127/miR409 |
| miR26b/miR210\|miR155/Let7f | miR210/Let7d\|miR134/miR17 | miR26b/miR10a\|miR20a/miR155 |
| miR26b/miR210\|miR127/miR409 | miR210/miR127\|miR16/miR155 | miR26b/miR155\|miR210/Let7d |
| miR155/miR339\|miR155/Let7f | miR210/miR34b\|miR134/miR17 | miR26b/miR15b\|miR16/miR374 |
| miR210/miR127\|miR134/Let7d | miR16/miR20a\|miR134/miR409 | miR210/Let7d\|miR16/miR15b |
| miR15b/miR134\|Let7a/miR409 | miR210/miR15b\|miR134/miR409 | miR16/Let7a\|miR155/miR34b |
| miR26b/miR210\|miR17/Let7d | miR26b/miR210\|miR127/miR126 | miR210/miR339\|miR210/miR126 |
| miR26b/miR155\|miR20a/miR155 | miR26b/miR155\|miR155/miR17 | miR210/miR34b\|miR16/miR15b |
| miR210/Let7d\|miR16/miR126 | miR16/miR374\|miR15b/miR10a | miR374/miR10a\|miR17/Let7d |
| miR210/miR34b\|miR16/miR126 | miR15b/miR34b\|miR155/miR17 | miR210/miR20a\|miR155/miR374 |
| miR26b/miR210\|Let7d/miR10a | miR210/miR374\|miR134/Let7d | miR151/miR17\|miR126/Let7f |
| miR155/miR339\|miR127/miR409 | miR15b/miR10a\|miR151/miR17 | miR127/miR126\|Let7d/miR409 |
| miR26b/miR210\|miR151/miR155 | miR155/miR374\|miR134/miR20a | miR26b/miR15b\|miR155/miR374 |
| Let7f/miR409\|Let7d/Let7f | miR127/miR126\|Let7d/Let7f | miR374/miR10a\|Let7d/miR10a |
| miR210/miR339\|miR20a/miR155 | miR155/miR339\|miR127/miR126 | miR210/miR339\|miR210/Let7d |
| miR17/Let7d\|miR16/miR20a | miR210/miR339\|miR155/miR17 | miR16/miR20a\|miR15b/miR34b |
| miR155/miR339\|Let7d/miR10a | miR16/miR155\|miR134/Let7d | miR210/miR409\|miR210/miR15b |
| miR16/Let7a\|miR126/miR10a | miR26b/miR155\|miR16/Let7a | miR374/miR10a\|miR151/miR155 |
| miR26b/miR210\|miR210/miR409 | miR20a/miR155\|miR155/miR34b | miR210/miR15b\|miR15b/miR34b |
| miR16/miR210\|miR15b/miR10a | miR16/miR210\|miR134/miR20a | miR210/miR409\|miR16/miR210 |
| miR155/miR339\|miR151/miR155 | miR26b/Let7a\|miR210/miR15b | miR16/Let7a\|miR126/miR155 |
| miR210/miR134\|miR210/Let7f | miR210/miR17\|miR134/Let7f | miR134/miR17\|miR134/Let7d |
| miR210/miR134\|miR134/miR409 | miR155/miR374\|Let7d/Let7f | miR210/miR17\|miR210/Let7f |
| miR155/miR17\|miR126/miR10a | miR26b/Let7a\|miR16/miR210 | miR210/miR20a\|miR127/miR126 |
| miR15b/miR155\|miR134/miR409 | miR10a/miR34b\|Let7f/miR409 | miR151/miR17\|miR134/miR17 |
| miR134/miR20a\|miR134/Let7f | miR210/miR126\|miR155/miR34b | miR16/miR210\|miR15b/miR155 |
| miR16/miR20a\|miR16/Let7f | miR210/miR339\|miR16/Let7a | miR210/miR17\|miR134/miR409 |
| miR26b/Let7a\|miR126/Let7f | miR26b/miR210\|miR210/miR126 | miR155/miR374\|Let7d/miR409 |
| miR210/miR15b\|miR16/Let7f | miR16/miR20a\|miR155/Let7f | miR26b/miR15b\|miR127/miR126 |
| miR210/miR374\|miR126/miR10a | miR210/miR15b\|miR155/Let7f | miR16/Let7a\|Let7f/miR10a |
| miR16/miR126\|miR126/Let7f | miR210/miR20a\|miR16/miR15b | miR210/Let7d\|miR155/miR17 |
| miR26b/Let7a\|miR134/miR17 | miR20a/miR10a\|miR126/miR10a | miR374/miR10a\|miR210/miR409 |
| miR210/miR20a\|miR20a/miR155 | miR20a/miR155\|miR126/miR155 | miR155/miR34b\|miR127/miR126 |
| miR16/miR155\|miR126/miR10a | miR16/miR210\|Let7d/Let7f | miR210/miR34b\|miR155/miR17 |
| miR26b/miR15b\|miR20a/miR155 | miR26b/miR210\|miR210/Let7d | miR210/miR10a\|miR151/miR17 |
| miR210/miR134\|miR155/Let7f | miR16/miR20a\|miR127/miR409 | miR210/miR374\|miR155/miR34b |
| miR16/miR126\|miR134/miR17 | miR15b/miR10a\|miR134/Let7f | miR20a/miR155\|miR155/miR339 |
| miR210/miR127\|miR210/Let7f | miR26b/miR15b\|miR16/miR15b | miR16/miR210\|Let7d/miR409 |
| miR15b/miR155\|miR155/Let7f | miR210/miR15b\|miR127/miR409 | miR155/miR17\|miR126/miR155 |
| miR210/miR134\|miR127/miR409 | miR20a/miR155\|Let7f/miR10a | miR15b/miR10a\|miR134/miR409 |
| miR210/miR127\|miR134/miR409 | miR374/miR10a\|miR20a/miR155 | miR16/Let7a\|Let7a/miR409 |
| miR210/miR134\|miR17/Let7d | miR210/miR126\|miR126/miR155 | miR210/miR374\|miR210/miR20a |
| miR26b/miR210\|miR16/miR20a | miR210/miR15b\|miR17/Let7d | miR16/miR374\|miR16/miR210 |
| miR15b/miR155\|miR127/miR409 | miR16/Let7a\|miR134/miR409 | miR155/miR17\|Let7f/miR10a |
| miR17/Let7d\|miR16/miR15b | miR26b/miR15b\|miR210/miR374 | miR210/Let7d\|miR16/Let7a |
| Let7d/miR409\|Let7d/miR10a | miR210/miR126\|Let7f/miR10a | miR16/miR155\|miR155/miR34b |
| Let7f/miR409\|Let7f/miR10a | miR210/Let7f\|miR126/miR10a | miR210/miR126\|miR155/miR339 |
| miR26b/miR155\|miR126/Let7f | miR16/miR20a\|Let7d/miR10a | miR210/miR34b\|miR16/Let7a |
| miR210/miR134\|Let7d/miR10a | miR210/Let7d\|miR15b/miR10a | miR16/miR15b\|miR134/miR20a |
| miR15b/miR34b\|miR126/Let7f | miR210/miR15b\|Let7d/miR10a | miR16/miR20a\|miR16/miR155 |
| miR210/miR134\|miR151/miR155 | miR134/Let7d\|miR126/Let7f | miR210/miR20a\|miR210/miR126 |
| miR15b/miR155\|Let7d/miR10a | miR210/miR34b\|miR15b/miR10a | miR210/miR374\|miR126/miR155 |
| miR16/miR20a\|miR151/miR17 | miR210/miR134\|miR16/miR374 | miR210/miR15b\|miR16/miR155 |
| Let7f/miR409\|Let7a/miR409 | miR20a/miR155\|Let7a/miR409 | miR26b/miR15b\|miR210/miR126 |
| miR210/miR15b\|miR151/miR17 | miR16/miR20a\|miR151/miR155 | miR155/miR17\|Let7a/miR409 |
| miR15b/miR155\|miR151/miR155 | miR210/miR15b\|miR151/miR155 | miR210/miR374\|Let7f/miR10a |
| miR210/miR339\|miR126/Let7f | miR210/miR20a\|miR155/miR17 | miR210/miR17\|miR155/Let7f |
| miR26b/miR155\|miR134/miR17 | miR155/miR17\|miR134/miR409 | miR210/miR20a\|miR210/Let7d |
| miR15b/miR34b\|miR134/miR17 | miR26b/miR15b\|miR155/miR17 | miR16/Let7f\|miR126/Let7f |
| miR17/Let7d\|miR155/miR17 | miR210/miR134\|miR155/miR374 | miR16/miR10a\|miR126/miR10a |
| miR210/miR127\|miR155/Let7f | miR210/miR126\|Let7a/miR409 | miR16/miR155\|miR126/miR155 |
| miR210/miR339\|miR134/miR17 | miR26b/miR155\|miR210/miR15b | miR16/miR15b\|Let7d/Let7f |
| miR210/miR127\|miR127/miR409 | miR26b/miR155\|miR16/miR210 | miR26b/miR15b\|miR210/Let7d |
| miR26b/Let7a\|miR15b/miR10a | miR155/miR34b\|miR155/miR17 | miR17/Let7d\|Let7f/miR409 |
| miR20a/miR155\|miR134/Let7d | miR210/miR34b\|miR210/miR17 | miR210/miR10a\|miR134/Let7f |
| miR17/Let7d\|miR16/Let7a | miR15b/miR155\|miR155/miR374 | miR16/miR155\|Let7f/miR10a |
| miR210/miR127\|miR17/Let7d | miR210/miR374\|miR210/miR34b | miR210/miR17\|miR127/miR409 |
| miR16/miR126\|miR15b/miR10a | miR155/miR374\|miR155/miR34b | miR16/Let7a\|miR15b/miR34b |
| miR16/miR15b\|miR126/miR10a | miR127/miR126\|miR126/miR155 | miR210/miR374\|Let7a/miR409 |
| miR210/miR374\|miR16/Let7f | miR210/miR374\|miR210/Let7f | miR15b/miR10a\|miR155/Let7f |
| miR210/miR127\|Let7d/miR10a | miR210/miR20a\|miR16/Let7a | miR210/miR17\|miR17/Let7d |
| miR210/miR126\|miR134/Let7d | miR16/miR15b\|miR134/Let7d | miR16/Let7f\|miR134/miR17 |
| miR16/miR20a\|miR134/Let7f | miR210/miR339\|miR210/miR15b | miR210/miR17\|Let7d/miR10a |
| miR26b/Let7a\|miR210/miR17 | miR210/miR374\|miR134/miR409 | miR15b/miR10a\|miR127/miR409 |
| miR210/miR15b\|miR134/Let7f | miR26b/miR15b\|miR16/Let7a | miR26b/Let7a\|miR210/miR127 |
| miR210/miR127\|miR151/miR155 | miR210/miR339\|miR16/miR210 | miR16/miR155\|Let7a/miR409 |
| miR126/miR155\|miR126/Let7f | miR127/miR126\|Let7f/miR10a | miR210/miR17\|miR151/miR155 |
| miR16/miR155\|miR16/Let7f | miR210/miR134\|miR127/miR126 | miR26b/miR10a\|miR126/Let7f |
| miR10a/miR339\|Let7f/miR409 | miR16/Let7a\|miR155/Let7f | miR374/miR10a\|miR16/miR20a |
| miR26b/miR210\|miR16/miR15b | miR16/miR210\|miR155/miR34b | miR210/miR374\|miR210/miR339 |
| miR210/miR20a\|miR126/Let7f | miR20a/miR155\|miR15b/miR34b | miR155/miR374\|miR155/miR339 |
| miR16/Let7a\|miR151/miR17 | miR15b/miR155\|miR127/miR126 | miR134/miR20a\|miR127/miR126 |
| miR26b/miR15b\|miR126/Let7f | miR16/miR155\|miR134/miR409 | miR15b/miR10a\|Let7d/miR10a |
| miR374/miR10a\|miR16/miR126 | miR155/miR374\|miR126/miR155 | miR210/Let7d\|miR16/miR210 |
| miR155/miR34b\|miR126/Let7f | miR16/Let7a\|miR127/miR409 | miR210/miR34b\|miR210/miR15b |
| miR26b/miR210\|miR210/miR374 | miR210/miR126\|miR15b/miR34b | miR210/miR34b\|miR16/miR210 |
| miR26b/miR155\|miR15b/miR10a | miR127/miR126\|Let7a/miR409 | miR16/miR210\|miR155/miR339 |
| miR210/miR20a\|miR134/miR17 | miR155/miR374\|Let7f/miR10a | miR26b/miR10a\|miR134/miR17 |
| miR15b/miR34b\|miR15b/miR10a | miR134/miR17\|miR134/Let7f | miR210/miR374\|miR15b/miR34b |
| miR210/miR134\|miR16/miR20a | miR155/miR17\|miR155/Let7f | miR15b/miR10a\|miR151/miR155 |
| miR26b/miR15b\|miR134/miR17 | miR210/miR127\|miR16/miR374 | miR210/miR409\|miR134/miR20a |
| miR155/miR17\|miR151/miR17 | miR16/miR210\|miR126/miR155 | miR16/miR15b\|miR155/miR34b |
| miR155/miR34b\|miR134/miR17 | miR16/Let7a\|Let7d/miR10a | miR16/miR155\|miR15b/miR34b |
| miR210/miR339\|miR15b/miR10a | miR16/miR210\|Let7f/miR10a | miR20a/miR155\|miR20a/miR10a |
| miR26b/miR210\|miR155/miR17 | miR155/miR17\|miR127/miR409 | miR151/miR155\|miR134/miR20a |
| miR26b/miR155\|miR210/miR17 | miR210/miR127\|miR155/miR374 | miR26b/Let7a\|miR15b/miR155 |
| miR15b/miR134\|miR155/miR374 | miR16/Let7a\|miR151/miR155 | miR20a/miR10a\|miR134/Let7d |
| miR17/Let7d\|miR16/miR210 | miR210/miR134\|miR210/miR126 | miR210/miR409\|Let7d/Let7f |
| miR155/miR374\|miR134/Let7d | miR155/miR374\|Let7a/miR409 | miR26b/miR155\|miR210/miR127 |
| miR210/miR374\|miR151/miR17 | miR26b/Let7a\|miR134/miR20a | miR210/miR126\|miR20a/miR10a |
| miR16/Let7a\|miR134/Let7f | miR20a/miR10a\|miR16/Let7f | miR26b/Let7a\|miR210/miR134 |
| miR155/miR339\|miR155/miR17 | miR210/miR374\|miR155/Let7f | miR16/miR126\|miR15b/miR155 |
| miR16/miR210\|miR134/Let7d | miR210/miR17\|miR20a/miR155 | miR16/miR15b\|miR126/miR155 |
| miR210/miR339\|miR210/miR17 | miR20a/miR155\|miR16/miR155 | miR16/miR374\|miR134/miR20a |
| miR210/miR409\|miR126/miR10a | miR155/miR17\|Let7d/miR10a | miR26b/Let7a\|Let7d/miR409 |
| miR26b/miR210\|miR16/Let7a | miR210/miR134\|miR210/Let7d | miR26b/miR210\|Let7f/miR409 |
| miR15b/miR134\|miR127/miR126 | miR16/miR126\|miR134/miR20a | miR151/miR155\|Let7d/Let7f |
| miR16/miR155\|miR151/miR17 | miR16/miR210\|Let7a/miR409 | miR16/Let7f\|miR15b/miR10a |
| miR151/miR155\|miR126/miR10a | miR210/miR374\|miR127/miR409 | miR16/miR15b\|Let7f/miR10a |
| miR20a/miR155\|miR134/miR409 | miR16/miR155\|miR155/Let7f | miR210/miR374\|miR16/miR155 |
| miR155/miR17\|miR134/Let7f | miR134/Let7f\|miR126/miR10a | miR210/miR339\|miR210/miR127 |
| miR210/miR126\|miR210/Let7f | miR210/miR127\|miR127/miR126 | miR210/Let7f\|miR134/Let7d |
| miR16/miR15b\|miR16/Let7f | miR155/miR17\|miR151/miR155 | miR16/miR126\|Let7d/miR409 |
| miR210/miR127\|miR16/miR20a | miR16/miR20a\|miR16/miR20a | miR126/miR10a\|miR126/Let7f |
| miR210/miR126\|miR134/miR409 | miR210/miR20a\|miR210/miR15b | miR16/miR10a\|miR16/Let7f |
| miR16/miR374\|miR126/miR10a | miR210/miR374\|miR17/Let7d | Let7d/miR10a\|Let7d/Let7f |
| miR210/miR374\|miR134/Let7f | miR210/miR15b\|miR16/miR20a | miR210/miR10a\|miR210/miR10a |
| miR127/miR409\|miR126/miR10a | miR210/miR20a\|miR16/miR210 | miR134/miR17\|miR127/miR409 |
| miR210/miR20a\|miR15b/miR10a | miR210/miR126\|miR16/miR155 | miR155/Let7f\|miR134/miR20a |
| miR210/miR15b\|miR20a/miR155 | miR210/Let7f\|miR16/Let7f | miR155/miR339\|Let7f/miR409 |
| miR134/miR20a\|miR126/Let7f | miR210/miR10a\|miR16/miR126 | miR16/miR155\|miR16/miR155 |
| miR210/miR17\|miR16/miR126 | miR26b/Let7a\|Let7d/Let7f | miR16/miR374\|Let7d/Let7f |
| miR16/miR155\|miR134/Let7f | miR26b/miR15b\|miR210/miR15b | miR16/miR15b\|Let7a/miR409 |
| miR155/Let7f\|miR126/miR10a | miR16/miR155\|miR127/miR409 | miR127/miR409\|Let7d/Let7f |
| miR26b/miR15b\|miR15b/miR10a | miR374/miR10a\|miR126/Let7f | miR134/miR17\|Let7d/miR10a |
| miR210/miR134\|miR16/miR15b | miR17/Let7d\|miR15b/miR155 | miR374/miR10a\|miR16/miR15b |
| miR20a/miR155\|miR155/Let7f | miR26b/miR15b\|miR16/miR210 | miR210/miR10a\|miR20a/miR155 |
| miR210/miR20a\|miR210/miR17 | miR210/miR374\|Let7d/miR10a | miR210/miR15b\|miR16/miR374 |
| miR134/miR20a\|miR134/miR17 | miR210/miR409\|miR134/Let7d | miR210/miR17\|miR16/miR20a |
| miR26b/miR15b\|miR210/miR17 | miR16/miR126\|Let7d/Let7f | miR26b/miR10a\|miR15b/miR10a |
| miR10a/miR34b\|Let7d/miR409 | miR210/miR374\|miR151/miR155 | miR26b/miR155\|miR15b/miR155 |
| miR26b/miR210\|miR210/miR15b | miR17/Let7d\|Let7d/miR409 | miR155/Let7f\|Let7d/Let7f |
| miR20a/miR155\|miR127/miR409 | miR16/miR155\|Let7d/miR10a | miR15b/miR34b\|miR15b/miR155 |
| miR26b/miR210\|miR16/miR210 | miR374/miR10a\|miR134/miR17 | miR374/miR10a\|miR210/miR374 |
| miR210/miR126\|miR155/Let7f | miR151/miR155\|miR134/Let7d | miR16/miR20a\|miR155/miR374 |
| miR20a/miR155\|miR17/Let7d | miR16/miR210\|miR15b/miR34b | miR210/miR15b\|miR155/miR374 |
| miR210/miR126\|miR127/miR409 | miR16/miR155\|miR151/miR155 | miR26b/miR155\|miR210/miR134 |
| miR155/miR374\|miR134/miR409 | miR26b/miR155\|miR134/miR20a | miR17/Let7d\|miR15b/miR134 |
| miR20a/miR155\|Let7d/miR10a | miR210/miR127\|miR210/miR126 | miR126/Let7f\|Let7d/miR10a |
| miR210/miR134\|miR155/miR17 | miR16/miR15b\|miR134/miR409 | miR210/miR409\|miR155/miR34b |
| miR210/miR126\|miR17/Let7d | miR15b/miR34b\|miR134/miR20a | miR26b/miR155\|Let7d/miR409 |
| miR16/miR15b\|miR151/miR17 | miR151/miR17\|miR126/miR10a | miR210/miR339\|miR15b/miR155 |
| miR134/miR409\|miR126/miR10a | miR16/miR374\|miR134/Let7d | miR26b/miR10a\|miR210/miR17 |
| miR20a/miR155\|miR151/miR155 | miR26b/miR210\|miR210/miR127 | miR15b/miR34b\|Let7d/miR409 |
| miR17/Let7d\|miR134/miR20a | miR210/miR127\|miR210/Let7d | miR16/miR15b\|miR15b/miR34b |
| miR15b/miR155\|miR155/miR17 | miR20a/miR10a\|miR151/miR17 | miR134/miR409\|miR134/miR20a |
| miR16/miR210\|miR134/miR409 | miR210/miR339\|miR134/miR20a | miR210/miR409\|miR210/miR20a |
| miR210/Let7d\|miR126/miR10a | miR26b/miR155\|Let7d/Let7f | miR210/miR339\|miR210/miR134 |
| miR210/miR126\|Let7d/miR10a | miR15b/miR34b\|Let7d/Let7f | miR374/miR10a\|miR155/miR17 |
| miR210/miR409\|miR16/Let7f | miR155/Let7f\|miR134/Let7d | miR16/miR20a\|miR127/miR126 |
| miR210/miR34b\|miR126/miR10a | miR26b/Let7a\|miR155/miR34b | miR210/miR15b\|miR127/miR126 |
| miR210/miR126\|miR151/miR155 | miR210/Let7f\|miR151/miR17 | miR210/Let7d\|miR134/miR20a |
| miR210/miR134\|miR16/Let7a | miR210/miR339\|Let7d/Let7f | miR210/miR34b\|miR134/miR20a |
| miR210/miR127\|miR16/miR15b | miR16/miR210\|miR16/miR155 | miR210/miR339\|Let7d/miR409 |
| miR17/Let7d\|Let7d/Let7f | miR26b/Let7a\|miR210/miR20a | miR210/miR20a\|miR210/miR127 |
| miR26b/Let7a\|miR134/Let7d | miR16/miR126\|miR155/miR34b | miR210/miR409\|miR126/miR155 |
| miR155/miR374\|miR155/Let7f | miR15b/miR134\|Let7f/miR409 | miR26b/miR15b\|miR210/miR127 |
| miR16/miR374\|miR16/Let7f | miR16/miR15b\|miR155/Let7f | miR16/miR10a\|miR151/miR17 |
| miR16/miR126\|miR134/Let7d | miR16/miR20a\|miR16/miR15b | miR16/miR374\|miR155/miR34b |
| miR16/miR15b\|miR134/Let7f | miR26b/Let7a\|miR126/miR155 | miR210/miR409\|Let7f/miR10a |
| miR127/miR126\|Let7d/miR10a | miR210/miR15b\|miR16/miR15b | miR26b/Let7a\|miR155/miR339 |
| miR155/miR374\|miR127/miR409 | miR26b/miR210\|miR15b/miR155 | miR134/miR409\|Let7d/Let7f |
| miR16/miR210\|miR155/Let7f | miR16/miR15b\|miR127/miR409 | miR374/miR10a\|miR16/Let7a |
| miR210/miR127\|miR155/miR17 | miR20a/miR10a\|miR134/Let7f | miR151/miR155\|miR126/miR155 |
| miR210/miR374\|miR20a/miR155 | miR26b/Let7a\|Let7f/miR10a | miR20a/miR10a\|miR134/miR409 |
| miR16/miR210\|miR127/miR409 | miR210/miR17\|miR126/Let7f | miR210/Let7d\|Let7d/Let7f |
| miR16/miR20a\|miR126/Let7f | miR16/miR126\|miR126/miR155 | miR210/miR34b\|Let7d/Let7f |
| miR210/miR15b\|miR126/Let7f | miR374/miR10a\|miR15b/miR10a | miR16/miR126\|miR155/miR339 |
| miR155/miR374\|Let7d/miR10a | miR26b/miR210\|miR210/miR134 | miR151/miR155\|Let7f/miR10a |
| miR210/miR127\|miR16/Let7a | miR17/Let7d\|miR155/miR339 | miR210/miR409\|Let7a/miR409 |
| miR155/miR374\|miR151/miR155 | miR210/miR409\|miR210/miR34b | miR134/Let7f\|miR134/Let7d |
| miR210/miR409\|miR151/miR17 | miR26b/miR210\|Let7d/miR409 | miR210/Let7f\|miR210/Let7f |
| miR16/miR210\|Let7d/miR10a | miR16/Let7f\|miR126/miR10a | miR16/miR374\|miR126/miR155 |
| miR16/miR20a\|miR134/miR17 | miR16/miR126\|Let7f/miR10a | miR210/miR15b\|miR210/miR126 |
| miR26b/miR155\|miR134/Let7d | miR134/miR409\|miR134/Let7d | miR16/miR15b\|miR16/miR155 |
| miR210/miR15b\|miR134/miR17 | miR210/miR409\|miR210/Let7f | miR210/miR134\|Let7f/miR409 |
| miR210/miR134\|miR16/miR210 | miR210/miR374\|miR16/miR20a | miR210/Let7f\|miR134/miR409 |
| miR15b/miR34b\|miR134/Let7d | miR16/miR15b\|Let7d/miR10a | Let7f/miR10a\|Let7d/miR409 |
| miR16/miR210\|miR151/miR155 | miR210/Let7d\|miR134/Let7d | miR16/miR374\|Let7f/miR10a |
| miR17/Let7d\|miR155/miR34b | miR210/miR20a\|miR134/miR20a | miR127/miR409\|miR126/miR155 |
| miR26b/miR210\|miR134/miR20a | miR210/Let7f\|miR134/Let7f | miR16/Let7a\|miR155/miR374 |
| miR20a/miR155\|miR16/miR20a | miR210/miR17\|miR134/miR17 | miR151/miR155\|Let7a/miR409 |
| miR210/miR339\|miR134/Let7d | miR210/miR409\|miR134/miR409 | miR210/miR20a\|miR15b/miR155 |
| miR134/Let7d\|miR126/miR10a | miR15b/miR10a\|miR126/Let7f | miR15b/miR155\|Let7f/miR409 |
| miR210/miR126\|miR16/miR20a | miR26b/Let7a\|Let7a/miR409 | miR210/miR15b\|miR210/Let7d |
| miR155/miR339\|miR134/miR20a | Let7f/miR10a\|Let7d/Let7f | miR126/miR155\|Let7d/miR409 |
| miR16/miR374\|miR151/miR17 | miR210/miR34b\|miR134/Let7d | miR127/miR409\|Let7f/miR10a |
| miR210/Let7d\|miR16/Let7f | miR16/miR15b\|miR151/miR155 | miR210/miR17\|miR16/miR15b |
| miR210/miR34b\|miR16/Let7f | miR26b/miR155\|miR155/miR34b | Let7d/miR10a\|Let7a/miR409 |
| miR17/Let7d\|miR126/miR155 | miR16/miR20a\|miR155/miR17 | miR16/miR10a\|miR134/Let7f |
| miR26b/miR210\|Let7d/Let7f | miR26b/miR15b\|miR134/miR20a | miR155/Let7f\|miR126/miR155 |
| miR17/Let7d\|Let7f/miR10a | miR210/miR15b\|miR155/miR17 | miR210/miR409\|miR210/miR339 |
| miR210/miR409\|miR134/Let7f | miR15b/miR34b\|miR155/miR34b | miR26b/miR15b\|miR15b/miR155 |
| miR26b/Let7a\|miR210/miR34b | miR155/miR34b\|miR134/miR20a | miR210/miR20a\|miR210/miR134 |
| miR26b/Let7a\|miR210/Let7f | miR20a/miR155\|miR16/miR374 | miR16/miR374\|Let7a/miR409 |
| miR155/Let7f\|miR151/miR17 | miR155/miR339\|Let7d/miR409 | miR155/Let7f\|Let7f/miR10a |
| miR26b/Let7a\|miR134/miR409 | miR126/miR155\|Let7d/Let7f | miR210/miR20a\|Let7d/miR409 |
| miR155/miR339\|Let7d/Let7f | miR16/miR126\|Let7a/miR409 | miR26b/miR15b\|miR210/miR134 |
| miR16/Let7a\|miR126/Let7f | miR151/miR155\|miR134/miR409 | miR26b/miR210\|miR15b/miR134 |
| miR151/miR155\|miR134/Let7f | miR26b/miR155\|miR210/miR20a | miR20a/miR10a\|miR155/Let7f |
| miR17/Let7d\|Let7a/miR409 | miR15b/miR10a\|miR134/miR17 | miR16/Let7a\|miR127/miR126 |
| miR210/miR127\|miR16/miR210 | miR210/miR339\|miR155/miR34b | miR26b/miR155\|miR155/miR339 |
| miR16/miR126\|miR134/miR409 | miR210/miR126\|miR16/miR374 | miR210/miR409\|miR15b/miR34b |
| miR16/Let7a\|miR134/miR17 | miR210/miR20a\|Let7d/Let7f | miR26b/miR15b\|Let7d/miR409 |
| miR16/miR374\|miR134/Let7f | miR20a/miR155\|miR155/miR374 | miR127/miR409\|Let7a/miR409 |
| miR155/miR17\|miR126/Let7f | miR26b/Let7a\|miR210/miR339 | miR15b/miR34b\|miR155/miR339 |
| miR16/miR20a\|miR15b/miR10a | miR16/miR20a\|miR16/Let7a | miR210/miR374\|miR16/miR374 |
| miR210/miR15b\|miR15b/miR10a | miR26b/miR10a\|miR126/miR10a | miR155/miR34b\|Let7d/miR409 |
| miR210/miR20a\|miR134/Let7d | miR26b/miR155\|miR126/miR155 | miR20a/miR10a\|miR127/miR409 |
| miR26b/miR15b\|miR134/Let7d | miR210/miR15b\|miR16/Let7a | miR210/miR10a\|miR126/Let7f |
| miR155/Let7f\|miR134/Let7f | miR26b/miR15b\|Let7d/Let7f | miR151/miR17\|miR134/Let7d |
| miR155/miR17\|miR134/miR17 | miR16/miR374\|miR134/miR409 | miR155/Let7f\|Let7a/miR409 |
| miR155/miR34b\|miR134/Let7d | miR15b/miR34b\|miR126/miR155 | miR210/Let7d\|miR155/miR34b |
| miR210/miR374\|miR126/Let7f | miR210/miR339\|miR210/miR20a | miR374/miR10a\|miR210/miR15b |
| miR26b/Let7a\|miR155/Let7f | miR155/miR34b\|Let7d/Let7f | miR20a/miR10a\|miR17/Let7d |
| miR26b/miR210\|miR155/miR34b | miR26b/miR155\|Let7f/miR10a | miR374/miR10a\|miR16/miR210 |
| miR26b/miR155\|miR210/miR34b | miR210/miR126\|miR155/miR374 | miR210/Let7f\|miR155/Let7f |
| miR17/Let7d\|miR15b/miR34b | miR26b/Let7a\|miR15b/miR34b | miR210/miR17\|miR155/miR17 |
| miR210/Let7d\|Let7f/miR409 | miR16/Let7f\|miR155/miR339 | miR210/Let7f\|miR10a/miR34b |
| miR210/Let7f\|Let7d/miR409 | miR15b/miR10a\|Let7f/miR409 | miR210/miR409\|miR10a/miR339 |
| miR210/miR10a\|miR16/miR155 | miR126/miR10a\|Let7d/miR409 | miR26b/miR10a\|miR15b/miR134 |
| miR210/miR34b\|Let7f/miR409 | miR26b/miR10a\|miR155/miR339 | miR151/miR155\|miR10a/miR339 |
| miR26b/miR10a\|miR210/miR126 | miR26b/miR155\|miR10a/miR339 | miR16/miR374\|miR10a/miR339 |
| miR16/miR10a\|Let7d/Let7f | miR15b/miR34b\|miR10a/miR339 | miR127/miR409\|miR10a/miR339 |
| miR26b/miR10a\|miR210/Let7d | miR374/miR10a\|miR15b/miR134 | miR155/Let7f\|miR10a/miR339 |
| miR16/Let7a\|miR10a/miR34b | miR134/miR409\|miR10a/miR34b | miR134/Let7f\|miR10a/miR34b |
| miR210/miR409\|miR15b/miR134 | miR210/Let7d\|miR10a/miR34b | miR210/miR10a\|Let7f/miR409 |
| miR155/miR17\|miR10a/miR34b | miR210/miR34b\|miR10a/miR34b | miR134/miR409\|miR10a/miR339 |
| miR16/miR374\|miR15b/miR134 | miR210/miR339\|miR10a/miR339 | miR210/Let7d\|miR10a/miR339 |
| miR210/miR374\|miR10a/miR34b | miR16/miR10a\|miR155/miR374 | miR210/miR34b\|miR10a/miR339 |
| miR20a/miR10a\|miR155/miR339 | miR16/miR10a\|miR127/miR126 | miR151/miR17\|miR10a/miR34b |
| miR20a/miR155\|miR10a/miR339 | miR126/miR155\|miR10a/miR339 | miR16/Let7f\|miR10a/miR34b |
| miR16/miR10a\|miR155/miR34b | miR126/Let7f\|Let7f/miR409 | miR134/Let7d\|miR10a/miR339 |
| miR16/miR155\|miR10a/miR34b | miR210/miR20a\|miR10a/miR339 | miR210/miR10a\|miR15b/miR134 |
| miR210/miR126\|miR10a/miR339 | miR26b/miR15b\|miR10a/miR339 | miR26b/miR10a\|miR10a/miR34b |
| miR210/Let7f\|miR155/miR339 | miR155/miR34b\|miR10a/miR339 | miR126/miR10a\|miR10a/miR34b |
| miR16/miR10a\|miR126/miR155 | miR210/miR17\|miR15b/miR134 | miR16/miR10a\|Let7f/miR409 |
| miR16/miR10a\|Let7f/miR10a | miR26b/miR10a\|miR20a/miR10a | miR374/miR10a\|miR10a/miR339 |
| miR127/miR126\|miR10a/miR339 | miR210/miR10a\|miR15b/miR155 | miR210/miR17\|miR10a/miR339 |
| miR16/miR10a\|Let7a/miR409 | miR134/Let7d\|miR10a/miR34b | miR15b/miR10a\|miR10a/miR339 |
| miR210/Let7d\|miR15b/miR134 | miR210/miR10a\|Let7d/miR409 | miR16/miR10a\|miR15b/miR134 |
| miR210/miR34b\|miR15b/miR134 | miR134/miR20a\|miR10a/miR339 | miR210/miR10a\|miR10a/miR34b |
| miR210/miR10a\|miR16/miR374 | miR20a/miR10a\|Let7f/miR409 | miR134/miR17\|miR10a/miR339 |
| miR155/miR374\|miR10a/miR339 | miR210/miR10a\|miR155/miR339 | miR126/Let7f\|miR10a/miR339 |
| miR151/miR17\|Let7d/miR409 | miR374/miR10a\|miR10a/miR34b | miR20a/miR10a\|miR10a/miR339 |
| miR210/miR10a\|miR155/miR374 | miR16/miR20a\|miR10a/miR339 | miR16/miR10a\|miR10a/miR34b |
| miR16/miR210\|miR10a/miR339 | miR210/miR15b\|miR10a/miR339 | miR210/Let7f\|miR10a/miR339 |
| miR16/miR10a\|miR15b/miR34b | miR210/miR17\|miR10a/miR34b | miR134/Let7f\|miR10a/miR339 |
| miR16/miR15b\|miR10a/miR34b | miR210/miR10a\|miR20a/miR10a | miR151/miR17\|miR10a/miR339 |
| miR20a/miR10a\|miR20a/miR10a | miR16/miR10a\|miR15b/miR155 | miR16/Let7f\|miR10a/miR339 |
| miR210/miR10a\|miR127/miR126 | miR20a/miR10a\|miR15b/miR134 | miR26b/miR10a\|miR10a/miR339 |
| miR26b/miR10a\|miR210/miR127 | miR15b/miR10a\|miR10a/miR34b | miR126/miR10a\|miR10a/miR339 |
| miR210/Let7f\|miR20a/miR10a | miR16/miR10a\|Let7d/miR409 | miR210/miR10a\|miR10a/miR339 |
| miR16/Let7f\|miR15b/miR155 | miR210/Let7f\|miR15b/miR134 | miR16/miR10a\|miR10a/miR339 |
| miR374/miR10a\|Let7f/miR409 | miR151/miR17\|Let7f/miR409 | miR210/miR126\|miR210/miR10a |
| miR16/Let7f\|Let7d/miR409 | miR16/Let7a\|miR10a/miR339 | miR210/miR127\|miR210/miR10a |
| miR210/miR10a\|miR210/Let7d | miR155/miR17\|miR10a/miR339 | miR210/miR134\|miR210/miR10a |
| miR26b/miR10a\|miR15b/miR155 | miR210/miR374\|miR10a/miR339 | miR210/miR15b\|miR210/miR10a |
| miR26b/miR10a\|miR210/miR134 | miR134/miR17\|miR10a/miR34b | miR210/miR17\|miR210/miR10a |
| miR210/miR409\|miR10a/miR34b | miR16/miR10a\|miR155/miR339 | miR210/miR20a\|miR210/miR10a |
| miR26b/miR10a\|Let7d/miR409 | miR16/miR155\|miR10a/miR339 | miR210/miR339\|miR210/miR10a |
| miR151/miR155\|miR10a/miR34b | miR126/Let7f\|miR10a/miR34b | miR210/miR34b\|miR210/miR10a |
| miR16/miR374\|miR10a/miR34b | miR16/Let7f\|Let7f/miR409 | miR210/miR374\|miR210/miR10a |
| miR26b/Let7a\|miR10a/miR339 | miR26b/miR10a\|Let7f/miR409 | miR210/miR409\|miR210/miR10a |
| miR127/miR409\|miR10a/miR34b | miR16/miR15b\|miR10a/miR339 | miR26b/Let7a\|miR210/miR10a |
| miR16/miR126\|miR10a/miR339 | miR126/miR10a\|Let7f/miR409 | miR26b/miR10a\|miR210/miR10a |
| miR210/miR17\|Let7f/miR409 | miR20a/miR10a\|miR10a/miR34b | miR26b/miR155\|miR210/miR10a |
| miR155/Let7f\|miR10a/miR34b | miR16/Let7f\|miR15b/miR134 | miR26b/miR15b\|miR210/miR10a |
| miR155/miR17\|miR127/miR126 | miR374/miR10a\|miR210/miR339 | miR210/miR339\|miR15b/miR134 |
| miR210/miR374\|miR155/miR374 | miR16/miR20a\|miR155/miR339 | miR15b/miR10a\|miR155/miR374 |
| miR210/miR339\|miR155/miR339 | miR210/miR15b\|miR155/miR339 | miR155/miR374\|miR10a/miR34b |
| miR210/miR34b\|miR155/miR34b | miR155/miR17\|Let7d/miR409 | miR210/miR17\|miR127/miR126 |
| miR20a/miR10a\|Let7d/miR10a | miR26b/miR10a\|miR151/miR155 | miR151/miR17\|miR134/miR20a |
| miR210/miR10a\|miR134/miR17 | miR210/Let7d\|miR155/miR374 | miR16/miR374\|miR155/miR339 |
| miR210/miR34b\|miR210/miR20a | miR210/miR34b\|miR155/miR374 | miR16/miR210\|miR10a/miR34b |
| miR210/miR127\|Let7f/miR409 | miR210/miR374\|miR15b/miR155 | miR20a/miR10a\|miR15b/miR34b |
| miR210/Let7f\|miR127/miR409 | miR15b/miR134\|miR10a/miR339 | miR15b/miR10a\|miR127/miR126 |
| miR16/miR155\|miR155/miR374 | miR374/miR10a\|miR15b/miR34b | miR16/miR10a\|miR134/miR409 |
| miR16/miR374\|miR15b/miR34b | miR210/miR17\|miR155/miR34b | miR151/miR17\|Let7d/Let7f |
| miR134/miR409\|miR126/miR155 | miR374/miR10a\|miR26b/miR155 | miR210/Let7f\|miR15b/miR34b |
| miR20a/miR10a\|miR151/miR155 | miR210/miR374\|miR210/miR134 | miR210/miR17\|miR210/miR126 |
| miR15b/miR10a\|miR155/miR17 | miR26b/miR10a\|miR210/miR409 | miR210/miR17\|miR210/Let7d |
| miR210/Let7f\|miR17/Let7d | miR134/miR409\|miR127/miR126 | miR20a/miR10a\|miR16/miR155 |
| miR210/Let7d\|miR126/miR155 | miR16/miR10a\|miR15b/miR10a | miR210/miR20a\|miR15b/miR134 |
| miR210/miR17\|miR16/Let7a | miR16/miR155\|miR15b/miR155 | miR16/miR10a\|miR155/Let7f |
| miR210/miR374\|miR127/miR126 | miR210/miR374\|Let7d/miR409 | miR134/Let7f\|miR126/miR155 |
| miR134/miR409\|Let7f/miR10a | miR210/miR134\|miR10a/miR34b | miR26b/miR15b\|miR15b/miR134 |
| miR210/miR34b\|miR126/miR155 | miR210/Let7d\|miR127/miR126 | miR16/Let7f\|miR134/miR20a |
| miR210/Let7d\|Let7f/miR10a | miR210/miR10a\|miR134/Let7d | miR210/Let7d\|miR155/miR339 |
| miR210/Let7f\|Let7d/miR10a | miR210/miR34b\|miR127/miR126 | miR210/miR10a\|miR16/miR15b |
| miR210/miR409\|miR16/miR155 | miR20a/miR155\|miR15b/miR134 | miR134/Let7f\|Let7f/miR10a |
| miR134/Let7d\|Let7d/Let7f | miR15b/miR155\|miR10a/miR34b | miR210/miR34b\|miR155/miR339 |
| miR210/miR34b\|Let7f/miR10a | miR15b/miR10a\|miR155/miR34b | miR210/miR409\|miR20a/miR10a |
| miR26b/Let7a\|miR20a/miR10a | miR16/miR155\|Let7d/miR409 | miR16/miR10a\|miR127/miR409 |
| miR16/miR155\|miR127/miR126 | miR210/miR17\|miR126/miR155 | miR210/Let7f\|miR16/miR155 |
| miR210/Let7f\|miR151/miR155 | miR20a/miR10a\|miR16/miR210 | miR134/Let7d\|Let7d/miR409 |
| miR134/miR409\|Let7a/miR409 | miR210/miR126\|miR15b/miR134 | miR16/miR10a\|Let7d/miR10a |
| miR210/Let7d\|Let7a/miR409 | miR210/miR17\|Let7f/miR10a | miR16/Let7f\|Let7d/Let7f |
| miR210/miR34b\|Let7a/miR409 | miR134/miR17\|Let7d/Let7f | miR134/miR17\|miR127/miR126 |
| miR210/miR374\|miR210/miR126 | miR15b/miR10a\|miR126/miR155 | miR16/miR10a\|miR151/miR155 |
| miR16/miR374\|miR16/miR155 | miR374/miR10a\|miR16/miR155 | miR26b/miR10a\|miR134/miR20a |
| miR16/Let7f\|miR134/Let7d | miR15b/miR10a\|Let7f/miR10a | miR210/miR10a\|miR155/miR17 |
| miR210/miR20a\|miR155/miR339 | miR210/miR17\|Let7a/miR409 | miR151/miR17\|miR126/miR155 |
| miR26b/miR15b\|miR155/miR339 | miR210/Let7f\|miR16/miR210 | miR151/miR17\|Let7f/miR10a |
| miR210/miR374\|miR210/Let7d | miR126/miR10a\|Let7d/miR10a | miR374/miR10a\|miR210/miR127 |
| miR155/miR34b\|miR155/miR339 | miR126/Let7f\|Let7d/Let7f | miR210/miR10a\|miR16/Let7a |
| miR210/miR34b\|miR210/miR339 | miR16/Let7a\|miR155/miR339 | miR26b/miR10a\|Let7d/Let7f |
| miR10a/miR34b\|miR10a/miR339 | miR210/miR34b\|miR210/miR126 | miR26b/Let7a\|miR10a/miR34b |
| miR134/miR20a\|Let7d/miR409 | miR374/miR10a\|miR26b/Let7a | miR16/miR20a\|Let7f/miR409 |
| miR210/Let7d\|miR15b/miR34b | miR210/Let7d\|miR210/Let7d | miR151/miR17\|Let7a/miR409 |
| miR26b/miR155\|miR20a/miR10a | miR210/miR127\|miR10a/miR34b | miR210/miR15b\|Let7f/miR409 |
| miR210/miR34b\|miR15b/miR34b | miR210/miR34b\|miR210/Let7d | miR16/miR126\|miR10a/miR34b |
| miR210/miR134\|miR15b/miR134 | miR15b/miR10a\|Let7a/miR409 | miR16/Let7f\|miR155/miR34b |
| miR210/miR10a\|miR15b/miR10a | miR26b/miR10a\|miR16/miR20a | miR374/miR10a\|miR15b/miR155 |
| miR210/miR17\|miR210/miR15b | miR210/miR17\|miR15b/miR34b | miR210/Let7d\|miR20a/miR10a |
| miR210/miR17\|miR16/miR210 | miR210/miR15b\|miR20a/miR10a | miR17/Let7d\|miR10a/miR339 |
| miR151/miR17\|miR134/miR409 | miR210/miR374\|miR155/miR339 | miR210/miR34b\|miR20a/miR10a |
| miR15b/miR155\|miR15b/miR134 | miR16/miR15b\|miR15b/miR155 | miR16/Let7f\|miR126/miR155 |
| miR26b/miR10a\|miR134/Let7d | miR26b/Let7a\|Let7f/miR409 | miR374/miR10a\|miR210/miR134 |
| miR16/miR15b\|miR155/miR374 | miR16/miR210\|miR15b/miR134 | miR374/miR10a\|Let7d/miR409 |
| miR17/Let7d\|miR10a/miR34b | miR16/miR126\|Let7f/miR409 | miR16/Let7f\|Let7f/miR10a |
| miR210/miR339\|miR20a/miR10a | miR134/Let7d\|miR127/miR126 | miR26b/miR10a\|miR155/miR34b |
| miR134/Let7f\|miR127/miR409 | miR16/miR155\|miR155/miR339 | miR26b/miR155\|miR10a/miR34b |
| miR20a/miR10a\|miR16/miR20a | miR210/miR10a\|miR210/Let7f | miR15b/miR34b\|miR10a/miR34b |
| miR374/miR10a\|miR134/miR20a | miR16/miR15b\|Let7d/miR409 | miR20a/miR10a\|miR16/miR374 |
| miR134/Let7d\|miR126/miR155 | miR210/miR10a\|miR134/miR409 | miR210/miR10a\|miR16/miR210 |
| miR16/miR15b\|miR127/miR126 | miR134/miR17\|miR126/miR155 | miR126/miR10a\|Let7d/Let7f |
| miR134/Let7f\|Let7d/miR10a | miR210/miR409\|miR210/miR127 | miR26b/miR10a\|miR210/miR20a |
| miR134/Let7d\|Let7f/miR10a | miR134/miR17\|Let7f/miR10a | miR16/Let7f\|Let7a/miR409 |
| miR210/miR15b\|miR210/miR127 | miR210/miR17\|miR16/miR155 | miR16/Let7a\|Let7f/miR409 |
| miR210/Let7f\|miR16/miR20a | miR20a/miR10a\|miR134/miR20a | miR210/miR339\|miR10a/miR34b |
| miR210/Let7d\|miR16/miR155 | miR126/Let7f\|Let7f/miR10a | miR20a/miR10a\|miR155/miR374 |
| miR210/miR34b\|miR16/miR155 | miR26b/miR155\|Let7f/miR409 | miR26b/miR10a\|miR126/miR155 |
| miR374/miR10a\|Let7d/Let7f | miR15b/miR34b\|Let7f/miR409 | miR210/miR17\|miR210/miR127 |
| miR210/miR127\|miR15b/miR134 | miR210/miR10a\|miR155/Let7f | miR210/Let7f\|miR16/miR374 |
| miR134/Let7d\|Let7a/miR409 | miR210/Let7f\|miR134/miR20a | miR26b/miR10a\|Let7f/miR10a |
| miR151/miR17\|miR127/miR409 | miR126/Let7f\|Let7a/miR409 | miR155/miR17\|Let7f/miR409 |
| miR16/Let7f\|miR134/miR409 | miR20a/miR10a\|Let7d/Let7f | miR20a/miR10a\|miR127/miR126 |
| miR210/miR409\|miR16/miR374 | miR210/miR339\|Let7f/miR409 | miR210/Let7f\|miR155/miR374 |
| miR151/miR17\|Let7d/miR10a | miR16/Let7f\|miR155/miR17 | miR26b/miR10a\|Let7a/miR409 |
| miR210/miR20a\|miR20a/miR10a | miR26b/miR10a\|miR16/miR15b | miR16/Let7f\|miR15b/miR34b |
| miR16/miR20a\|miR15b/miR155 | miR210/miR10a\|miR127/miR409 | miR210/miR374\|Let7f/miR409 |
| miR26b/miR15b\|miR20a/miR10a | miR210/miR409\|miR15b/miR155 | miR210/Let7f\|miR127/miR126 |
| miR20a/miR155\|Let7f/miR409 | miR374/miR10a\|miR16/miR374 | miR126/miR155\|miR10a/miR34b |
| miR210/miR15b\|miR15b/miR155 | miR210/miR10a\|miR17/Let7d | miR16/miR155\|Let7f/miR409 |
| miR151/miR17\|miR151/miR155 | miR210/miR409\|miR210/miR134 | miR210/miR17\|miR15b/miR155 |
| miR210/miR409\|miR155/miR374 | miR26b/miR10a\|miR210/miR374 | miR26b/miR10a\|miR210/miR339 |
| miR210/miR15b\|miR210/miR134 | miR210/Let7f\|Let7d/Let7f | miR26b/miR210\|miR10a/miR339 |
| miR210/miR126\|Let7f/miR409 | miR210/miR409\|Let7d/miR409 | miR16/miR20a\|miR15b/miR134 |
| miR16/miR20a\|Let7d/miR409 | miR210/miR10a\|Let7d/miR10a | miR210/miR15b\|miR15b/miR134 |
| miR210/miR15b\|Let7d/miR409 | miR16/Let7f\|miR16/Let7a | miR210/miR20a\|miR10a/miR34b |
| miR26b/miR10a\|miR210/miR34b | miR374/miR10a\|miR155/miR374 | miR210/miR17\|miR210/miR134 |
| miR26b/miR210\|miR10a/miR34b | miR16/miR15b\|miR155/miR339 | miR374/miR10a\|miR155/miR339 |
| miR26b/miR10a\|miR210/Let7f | miR210/miR10a\|miR151/miR155 | miR26b/miR10a\|miR15b/miR34b |
| miR20a/miR10a\|miR16/miR15b | miR210/miR374\|miR20a/miR10a | miR26b/miR15b\|miR10a/miR34b |
| miR16/miR374\|miR16/miR374 | miR151/miR155\|Let7d/miR409 | miR210/miR17\|Let7d/miR409 |
| miR26b/miR10a\|miR134/miR409 | miR26b/miR10a\|miR155/miR17 | miR155/miR34b\|miR10a/miR34b |
| miR374/miR10a\|miR155/miR34b | miR16/miR374\|miR15b/miR155 | miR155/miR339\|miR10a/miR339 |
| miR210/miR409\|miR127/miR126 | miR374/miR10a\|miR127/miR126 | miR126/miR10a\|Let7f/miR10a |
| miR16/miR10a\|miR126/Let7f | miR126/miR155\|Let7f/miR409 | miR374/miR10a\|miR26b/miR210 |
| miR374/miR10a\|miR26b/miR15b | miR16/miR374\|Let7d/miR409 | miR15b/miR10a\|Let7d/miR409 |
| miR210/miR17\|miR134/miR20a | miR16/miR10a\|miR134/Let7d | miR210/Let7f\|miR210/Let7d |
| miR155/miR339\|miR10a/miR34b | miR26b/miR10a\|miR16/Let7a | miR126/miR10a\|Let7a/miR409 |
| miR16/Let7f\|miR155/Let7f | miR127/miR409\|Let7d/miR409 | miR210/miR10a\|miR134/miR20a |
| miR16/miR374\|miR155/miR374 | miR26b/Let7a\|miR15b/miR134 | miR16/miR10a\|miR155/miR17 |
| miR151/miR155\|miR127/miR126 | miR20a/miR155\|miR10a/miR34b | miR26b/miR10a\|miR16/miR155 |
| miR210/Let7f\|miR16/miR15b | miR20a/miR10a\|miR155/miR34b | miR210/miR10a\|Let7d/Let7f |
| miR16/miR10a\|miR134/miR17 | miR210/miR34b\|miR210/miR127 | miR26b/miR10a\|miR26b/Let7a |
| miR16/Let7f\|miR127/miR409 | miR210/miR20a\|Let7f/miR409 | miR16/miR10a\|miR16/Let7a |
| miR374/miR10a\|miR126/miR155 | miR26b/miR15b\|Let7f/miR409 | miR16/Let7a\|miR15b/miR134 |
| miR15b/miR10a\|miR134/miR20a | miR155/Let7f\|Let7d/miR409 | miR134/Let7f\|miR127/miR126 |
| miR210/miR17\|Let7d/Let7f | miR16/miR126\|miR15b/miR134 | miR16/miR15b\|Let7f/miR409 |
| miR127/miR126\|Let7f/miR409 | miR155/miR34b\|Let7f/miR409 | miR210/miR17\|miR155/miR339 |
| miR20a/miR10a\|miR155/miR17 | miR210/miR126\|miR10a/miR34b | miR134/miR20a\|miR10a/miR34b |
| miR374/miR10a\|Let7f/miR10a | miR210/Let7f\|miR155/miR34b | miR210/miR134\|miR10a/miR339 |
| miR16/miR374\|miR127/miR126 | miR374/miR10a\|miR210/miR126 | miR134/miR17\|Let7d/miR409 |
| miR210/miR374\|miR210/miR127 | miR20a/miR10a\|miR126/miR155 | miR374/miR10a\|miR20a/miR10a |
| miR16/Let7f\|Let7d/miR10a | miR20a/miR10a\|Let7f/miR10a | miR210/miR374\|miR15b/miR134 |
| miR127/miR409\|miR127/miR126 | miR374/miR10a\|miR210/Let7d | miR15b/miR10a\|miR155/miR339 |
| miR210/miR409\|miR210/miR126 | miR210/miR17\|miR16/miR374 | miR15b/miR155\|miR10a/miR339 |
| miR16/Let7a\|miR15b/miR155 | miR210/Let7f\|miR126/miR155 | miR151/miR17\|miR127/miR126 |
| miR26b/miR10a\|miR155/Let7f | miR210/miR409\|miR155/miR339 | miR126/Let7f\|Let7d/miR409 |
| miR15b/miR10a\|Let7d/Let7f | miR210/Let7d\|miR15b/miR155 | miR16/miR155\|miR15b/miR134 |
| miR16/Let7f\|miR151/miR155 | miR210/miR34b\|miR15b/miR155 | miR210/miR10a\|miR155/miR34b |
| miR155/miR374\|Let7f/miR409 | miR20a/miR10a\|Let7a/miR409 | miR210/miR10a\|miR126/miR155 |
| miR374/miR10a\|Let7a/miR409 | miR127/miR126\|miR10a/miR34b | miR210/miR409\|Let7f/miR409 |
| miR20a/miR10a\|miR16/Let7a | miR210/Let7f\|Let7f/miR10a | miR210/miR10a\|Let7f/miR10a |
| miR210/Let7f\|miR155/miR17 | miR26b/miR155\|miR15b/miR134 | miR210/miR127\|miR10a/miR339 |
| miR155/Let7f\|miR127/miR126 | miR210/miR17\|miR155/miR374 | miR16/Let7f\|miR155/miR374 |
| miR210/miR409\|miR210/Let7d | miR134/miR409\|Let7d/miR409 | miR151/miR155\|Let7f/miR409 |
| miR26b/miR10a\|miR127/miR409 | miR134/Let7f\|Let7d/Let7f | miR210/miR10a\|Let7a/miR409 |
| miR16/Let7a\|Let7d/miR409 | miR210/miR34b\|miR210/miR134 | miR16/miR374\|Let7f/miR409 |
| miR16/miR210\|Let7f/miR409 | miR15b/miR34b\|miR15b/miR134 | miR16/Let7f\|miR127/miR126 |
| miR26b/miR10a\|miR17/Let7d | miR210/miR10a\|miR16/miR20a | miR26b/miR10a\|miR16/miR374 |
| miR210/Let7d\|miR16/miR374 | miR210/Let7d\|Let7d/miR409 | miR127/miR409\|Let7f/miR409 |
| miR210/miR34b\|miR16/miR374 | miR210/miR34b\|Let7d/miR409 | miR210/miR17\|miR20a/miR10a |
| miR210/Let7f\|miR16/Let7a | miR26b/miR10a\|miR210/miR15b | miR26b/miR10a\|miR155/miR374 |
| miR26b/miR10a\|Let7d/miR10a | miR26b/miR10a\|miR16/miR210 | miR155/Let7f\|Let7f/miR409 |
| miR16/miR10a\|miR134/miR20aa | miR20a/miR10a\|miR15b/miR155 | miR16/miR15b\|miR15b/miR134 |
| miR134/miR409\|Let7f/miR409 | miR26b/miR10a\|miR127/miR126 | miR16/miR20a\|miR10a/miR34b |
| miR26b/miR210\|miR210/miR10a | miR20a/miR10a\|Let7d/miR409 | miR210/miR15b\|miR10a/miR34b |
| miR374/miR10a\|miR210/miR10a | miR210/Let7f\|miR15b/miR155 | miR210/miR10a\|miR15b/miR34b |
| miR374/miR10a\|miR210/miR20a | | |

1. (canceled)

2. Method for the in vitro diagnosis of a brain tumour belonging to the group constituted by 2 types of tumours: ODG and GBM, and identification of the type of the tumour, comprising:
(i) measurement of the expression level of at least two miRNAs in a biological sample originating from a patient with a suspected glioma, in which:
a first miRNA is chosen from hsa-miR-155, hsa-miR-210, hsa-miR-10a, hsa-miR-409 or hsa-miR-134;
a second miRNA is chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b*, hsa-miR-155, hsa-miR-210 or hsa-miR-10a, said second chosen miRNA being different from the above-mentioned first chosen miRNA;
(ii) comparison:
between the expression levels of the above-mentioned miRNAs in the abovementioned sample and the expression levels of the abovementioned miRNA in a healthy reference sample, a reference GBM sample and a reference ODG sample, or
between the expression level of at least one first abovementioned miRNA in the sample originating from a patient with a suspected glioma and the expression level of at least one second abovementioned miRNA in the same sample originating from the patient with a suspected glioma.

3. Method for in vitro diagnosis according to claim 2, comprising:
(i) measurement of the expression level in a biological sample originating from a patient with a suspected glioma,
of a first miRNA chosen from hsa-miR-155, hsa-miR-210, hsa-miR-10a, hsa-miR-409 or hsa-miR-134, and
of a second miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b*, hsa-miR-155, hsa-miR-210 or hsa-miR-10a, said second chosen miRNA being different from the abovementioned first chosen miRNA,
(ii) comparison between the expression levels of the abovementioned miRNAs in the abovementioned sample and the expression levels of the abovementioned miRNA in a healthy reference sample, a reference GBM sample and a reference ODG sample.

4. Method for in vitro diagnosis according to claim 3, in which the deduction of the presence of GBM in the sample originating from the patient with a suspected glioma is made when:
(i) the expression level of the first miRNA measured in said sample is at least 3 times greater than or less than the expression level of the abovementioned miRNA measured in the healthy reference sample, and
(ii) the expression level of the first miRNA measured in said sample is at least 3 times greater than the expression level of the abovementioned miRNA measured in the reference ODG sample, and
(iii) the expression level of the second miRNA measured in said sample is at least 3 times greater than or less than the expression level of the abovementioned miRNA measured in the healthy reference sample, and
(iv) the expression level of the second miRNA measured in said sample is equal, within a limit of 20% more or 20% less, to the expression level of the abovementioned miRNA in the reference GBM sample.

5. Method for in vitro diagnosis according to claim 3, in which the deduction of the presence of ODG in the sample originating from the patient with a suspected glioma is made when:
(i) the expression level of the first miRNA measured in said sample is at least 3 times greater than or less than the expression level of the abovementioned miRNA measured in the healthy reference sample, and
(ii) the expression level of the first miRNA measured in said sample is at least 3 times less than the expression level of the abovementioned miRNA measured in the reference GBM sample, and
(iii) the expression level of the second miRNA measured in said sample is at least 3 times greater than or less than the expression level of the abovementioned miRNA measured in the healthy reference sample, and
(iv) the expression level of the second miRNA measured in said sample is equal, within a limit of 20% more or 20% less, to the expression level of the abovementioned miRNA in the reference ODG sample.

6. Method for in vitro diagnosis according to claim 2, comprising:
(i) measurement of the expression level of at least two miRNA pairs in a biological sample originating from a patient with a suspected glioma,
each abovementioned miRNA pair being formed by
a first miRNA chosen from hsa-miR-155, hsa-miR-210, hsa-miR-10a, hsa-miR-409 or hsa-miR-134;
a second miRNA chosen from hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b*, hsa-miR-155, hsa-miR-210 or hsa-miR-10a, said second chosen miRNA being different from the abovementioned first chosen miRNA, and
said miRNA pairs being different from each other, said measurement making it possible to establish the ratios of the expression levels for the abovementioned miRNA pairs,
(ii) comparison between:
the ratios of the expression levels of the abovementioned miRNA pairs, and
those represented in a pre-established chart for a healthy reference sample, a reference GBM sample and a reference ODG sample.

7. Method for in vitro diagnosis according to claim 6, in which the deduction of the presence of GBM in the sample originating from the patient with a suspected glioma is made when:
(i) the difference between the first ratio obtained in a sample originating from a patient with a suspected glioma and the ratio in a pre-established chart in a reference GBM sample is less than 20%, in particular 15%, more particularly 10%, with respect to the above-mentioned first ratio in the pre-established chart, and
(ii) the difference between the second ratio obtained in a sample originating from a patient with a suspected glioma and the ratio in a pre-established chart in a reference GBM sample is less than 20%, in particular 15%, more particularly 10%, with respect to the above-mentioned second ratio in the pre-established chart.

8. Method for in vitro diagnosis according to claim 6, in which the deduction of the presence of ODG in the sample originating from the patient with a suspected glioma is made when:
(i) the difference between the first ratio obtained in a sample originating from a patient with a suspected glioma and the ratio in a pre-established chart in a reference ODG sample is less than 20%, in particular 15%, more particularly 10%, with respect to the above-mentioned first ratio in the pre-established chart, and
(ii) the difference between the second ratio obtained in a sample originating from a patient with a suspected glioma and the ratio in a pre-established chart in a reference ODG sample is less than 20%, in particular 15%, more particularly 10%, with respect to the above-mentioned second ratio in the pre-established chart.

9. Method for in vitro diagnosis according to claim 6, in which the first miRNA pair is formed by a first miRNA: hsa-miR-155, and a second miRNA chosen from: hsa-miR-126, hsa-miR-15b, hsa-miR-16, hsa-miR-17, hsa-miR-20a, hsa-let 7f, hsa-miR-374, hsa-miR-409, hsa-miR-134, hsa-miR-339, hsa-miR-151, hsa-miR-26b, hsa-miR-34b* or hsa-miR-210.

10. Method for in vitro diagnosis according to claim 6, in which the first miRNA pair is formed by a first miRNA: hsa-miR-210, and a second miRNA chosen from: hsa-miR-126, hsa-miR-15b, hsa-miR-16, hsa-miR-17, hsa-miR-20a, hsa-let7a, hsa-let 7f, hsa-let 7d, hsa-miR-374, hsa-miR-409, hsa-miR-134, hsa-miR-339, hsa-miR-127, hsa-miR-26b, hsa-miR-34b*, hsa-miR-155, or hsa-miR-10a.

11. Method for in vitro diagnosis according to claim 6, in which the first miRNA pair is formed by a first miRNA: hsa-miR-134, and a second miRNA chosen from: hsa-miR-126, hsa-miR-15b, hsa-miR-17, hsa-miR-20a, hsa-let7a, hsa-let 7f, hsa-let 7d, hsa-miR-374, hsa-miR-409, hsa-miR-26b, hsa-miR-155, hsa-miR-210 or hsa-miR-10a.

12. Method for in vitro diagnosis according to claim 6, in which the first miRNA pair is formed by a first miRNA: hsa-miR-409, and a second miRNA chosen from: hsa-miR-126, hsa-miR-15b, hsa-miR-16, hsa-miR-17, hsa-miR-20a, hsa-let7a, hsa-let 7f, hsa-let 7d, hsa-miR-374, hsa-miR-134, hsa-miR-127, hsa-miR-26b, hsa-miR-155, hsa-miR-210 or hsa-miR-10a.

13. Method for in vitro diagnosis according to claim 6, in which the first miRNA pair is formed by a first miRNA: hsa-miR-10a, and a second miRNA chosen from: hsa-miR-126, hsa-miR-15b, hsa-miR-16, hsa-miR-20a, hsa-let 7f, hsa-let 7d, hsa-miR-374, hsa-miR-409, hsa-miR-134, hsa-miR-339, hsa-miR-127, hsa-miR-151, hsa-miR-26b, hsa-miR-34b* or hsa-miR-210.

14. Method for in vitro diagnosis according to claim 6, in which the second miRNA pair is chosen from the following pairs: hsa-miR127/hsa-miR409, hsa-miR210/hsa-miR-34b*, hsa-let 7f/hsa-miR10a, hsa-miR155/hsa-miR17, hsa-miR155/hsa-miR374, hsa-let 7a/hsa-miR 409, hsa-let 7d/hsa-miR409, hsa-miR134/hsa-let 7f, hsa-let 7f/hsa-miR409, hsa-miR134/hsa-let 7d, hsa-miR151/hsa-miR155, hsa-miR155/hsa-miR-34b*, hsa-miR15b/hsa-miR134, hsa-miR134/hsa-miR20a, hsa-miR210/hsa-let 7f, hsa-miR20a/has-miR155. (Tables 6+7).


SEQUENCE LISTING (19 sequences)

SEQ ID NO: 1 - RNA, 22 nt, Homo sapiens
  misc_RNA (1)..(22)
ucguaccgugaguaauaaugcg

SEQ ID NO: 2 - RNA, 22 nt, Homo sapiens
  misc_RNA (1)..(22)
uagcagcacguaaauauuggcg

SEQ ID NO: 3 - RNA, 23 nt, Homo sapiens
uaaagugcuuauagugcagguag

SEQ ID NO: 4 - RNA, 22 nt, Homo sapiens
ugagguaguagguuguauaguu

SEQ ID NO: 5 - RNA, 22 nt, Homo sapiens
ugagguaguagauuguauaguu

SEQ ID NO: 6 - RNA, 22 nt, Homo sapiens
agagguaguagguugcauaguu

SEQ ID NO: 7 - RNA, 22 nt, Homo sapiens
uuauaauacaaccugauaagug

SEQ ID NO: 8 - RNA, 22 nt, Homo sapiens
uagcagcacaucaugguuuaca

SEQ ID NO: 9 - RNA, 22 nt, Homo sapiens
ucggauccgucugagcuuggcu

SEQ ID NO: 10 - RNA, 23 nt, Homo sapiens
ucccuguccuccaggagcucacg

SEQ ID NO: 11 - RNA, 22 nt, Homo sapiens
agguuacccgagcaacuuugca

SEQ ID NO: 12 - RNA, 22 nt, Homo sapiens
ugugacugguugaccagagggg

SEQ ID NO: 13 - RNA, 23 nt, Homo sapiens
uuaaugcuaaucgugauaggggu

SEQ ID NO: 14 - RNA, 22 nt, Homo sapiens
cugugcgugugacagcggcuga

SEQ ID NO: 15 - RNA, 23 nt, Homo sapiens
uacccuguagauccgaauuugug

SEQ ID NO: 16 - RNA, 21 nt, Homo sapiens
uucaaguaauucaggauaggu

SEQ ID NO: 17 - RNA, 22 nt, Homo sapiens
caaucacuaacuccacugccau

SEQ ID NO: 18 - RNA, 23 nt, Homo sapiens
caaagugcuuacagugcagguag

SEQ ID NO: 19 - RNA, 21 nt, Homo sapiens
cuagacugaagcuccuugagg